(19) United States
(12) Patent Application Publication
(10) Pub. No.: US 2012/0262451 A1
(43) Pub. Date: Oct. 18, 2012

(54) VIEW-SWITCHING GLASSES, DISPLAY CONTROL DEVICE, DISPLAY CONTROL SYSTEM, AND COMPUTER-READABLE STORAGE MEDIUM

(75) Inventors: Teruhisa Kotani, Osaka (JP); Hideharu Tajima, Osaka (JP); Go Mori, Osaka (JP); Yoshihisa Adachi, Osaka (JP); Yasuhiro Harada, Osaka (JP); Tazuko Kitazawa, Osaka (JP); Hideki Etoh, Osaka (JP)

(73) Assignee: Sharp Kabushiki Kaisha, Osaka (JP)

(21) Appl. No.: 13/444,217

(22) Filed: Apr. 11, 2012

(30) Foreign Application Priority Data
Apr. 12, 2011 (JP) 2011-088494
Apr. 12, 2011 (JP) 2011-088495

(51) Int. Cl. G06T 15/00; G02B 27/22

(52) U.S. Cl. 345/419; 359/466

(57) ABSTRACT

View-switching glasses of the present invention are liquid crystal shutter glasses for switching how a viewer views through a left eye and a right eye, including an inclination sensor for detecting an amount of inclination of the liquid crystal shutter glasses when a face of a viewer wearing the liquid crystal shutter glasses is inclined.

This Nonprovisional application claims priority under 35 U.S.C. §119 on Patent Application No. 2011-088494 filed in Japan on Apr. 12, 2011 and Patent Application No. 2011-088495 filed in Japan on Apr. 12, 2011, the entire contents of which are hereby incorporated by reference.

### TECHNICAL FIELD

The present invention relates to view-switching glasses, a display control device, a display control system, and a computer-readable storage medium, each enabling a viewer to view a three-dimensional (3D) image etc.

### BACKGROUND ART

Recently, researches have been intensively made to a method etc. for viewing a three-dimensional image other than a two-dimensional (2D) image. In order to view a three-dimensional image etc., for example, it is necessary to alternately display a left-eye image and a right-eye image for a three-dimensional image and to view the two images by the left eye and the right eye, respectively, by means of polarized glasses, shutter glasses etc.

In the case of shutter glasses, it is necessary to control opening/closing of the right-eye shutter and the left-eye shutter of the glasses in accordance with timing for alternately outputting a right-eye image and a left-eye image from a display device (see Patent Literature 1 for example). When the shutter glasses receive a right-eye image, the shutter glasses are controlled to open the right-eye shutter and close the left-eye shutter. This enables a viewer to view a right-eye image only by the right eye and a left-eye image only by the left eye, so that the viewer can perceive a stereoscopic sensation intended by a creator of a three-dimensional image.

The “3DC Safety Guidelines for Dissemination of Human-friendly 3D (revised on Apr. 20, 2010)” made by 3D Consortium (3DC) Safety/Guidelines Section reads “(w)hen 3D (stereoscopic) images look doubled or if there is any difficulty in recognizing stereoscopic images, immediately stop viewing, and check and adjust the display equipment and software configuration. If images are still doubled or if there is any discomfort which leads to difficulty in experiencing stereopsis, the use of stereoscopic images should be stopped immediately”.

According to the guidelines, the reason is as follows: “(e)quipment which uses binocular disparity enables recognition of stereoscopic images only when users can fuse two images in their brain from different viewpoints which are input from their right eye and left eye. If adjustment of the system is inadequate (inconsistency in the left and right optical axes, differences in size, color and brightness or vertical misalignment of the left and right images, or mixture of light between images on the left eye and the right eye (=crosstalk) is too large), it is difficult for users to fuse two images. In such a case, they may be recognized as a double image which may cause eye strain”.

In particular, as for the appropriate posture when viewing stereoscopic images, the guidelines read “(c)oncerning images based on binocular disparity, it is advisable to view them in a posture where the surface of the display and both eyes are on the same level” because “(i)f both eyes are on a slant to the surface of the display, differences in upper and lower images recognized by the left eye and the right eye become larger which makes fusion of images difficult and causes eye strain. When viewing stereoscopic images by using glasses based on linear polarization, slanting makes crosstalk greater which easily causes eye strain”.

Further, there is proposed a technique in which such a three-dimensional image viewing system is applied to viewing of a two-dimensional image (Patent Literatures 2 and 3).

Patent Literature 2 discloses an image display device which displays a plurality of images on a full screen without reducing each image so that a plurality of viewers view different images simultaneously. The image display device employs shutter glasses which open/close the right-eye perspective and the left-eye perspective in accordance with an image signal indicative of an image displayed on the screen. N images indicated by N image signals are displayed periodically on the same screen in a time-dividing manner, and when one of the N image signals indicative of images displayed on the screen is selected, shutter glasses are opened and closed in accordance with the cycle of the selected image signal.

Patent Literature 3 discloses an eyeglass device which is stereoscopic glasses for viewing a stereoscopic image, configured not only to enable a viewer to view only one of two image displays but also to enable the viewer to select an image to be displayed with audio output of the selected image. The eyeglass device enables the stereoscopic glasses to view images indicated by two different image signals instead of a stereoscopic image for the right and left eyes, and when a viewer select one of two different image signals for programs, the viewer can view the selected one program with audio output of the program from a headphone.

### CITATION LIST

### Patent Literatures

### [Patent Literature 1]

Japanese Patent Application Publication, Tokukaisho, No. 62-174793 (published on Jul. 31, 1987)

### [Patent Literature 2]

Japanese Patent Application Publication, Tokukaihei, No. 10-240212 (published on Sep. 11, 1998)

### [Patent Literature 3]

Japanese Patent Application Publication, Tokukaihei, No. 10-243420 (published on Sep. 11, 1998)

### SUMMARY OF INVENTION

### Technical Problem

In order to reduce health damage derived from a viewer's posture when viewing stereoscopic images, it is important for the viewer to be capable of knowing whether the viewer's posture is appropriate for viewing stereoscopic images or not.

However, Patent Literature 1 neither discloses nor suggests a configuration which allows a viewer to know the viewer's posture when viewing stereoscopic images is appropriate or not.

The techniques of Patent Literatures 2 and 3 are applications of three-dimensional image viewing techniques to two-dimensional image viewing. Two-dimensional images have a disadvantage that they have smaller realistic sensations than three-dimensional images since the two-dimensional images are only displayed on a screen. Accordingly, in order to enhance realistic sensations of a two-dimensional image, there is requested a technique for achieving more free expression of a two-dimensional image (i.e., technique for changing how a two-dimensional image is viewed according to the posture of a viewer's face). In Patent Literatures 2 and 3, the direction of an image does not change in accordance with the posture of the viewer's face. Consequently, when the posture of the viewer's face changes (e.g. when the face is inclined sidewise), the viewer views the image in an inclined state, dropping the viewer's visibility. It is considered that this problem can be solved by applying the above technique for achieving more free expression of images.

The present invention was made in view of the foregoing problem, and its object is to provide view-switching glasses, a display control device, a display control system, and a computer-readable storage medium, each capable of reducing health hazard to a viewer when viewing stereoscopic images.

Another object of the present invention is to provide view-switching glasses, a display control device, and a display control system, each capable of improving flexibility in two-dimensional image expression.

### Solution to Problem

In order to solve the foregoing problem, view-switching glasses of the present invention are view-switching glasses for switching how a viewer views through a left eye and a right eye, comprising inclination detection means for detecting an amount of inclination of the view-switching glasses when a face of a viewer wearing the view-switching glasses is inclined.

The “3DC Safety Guidelines for Dissemination of Human-friendly 3D (revised on Apr. 20, 2010)” made by 3D Consortium (3DC) Safety/Guidelines Section read “(c)oncerning images based on binocular disparity, it is advisable to view them in a posture where the surface of the display and both eyes are on the same level”

With the arrangement, the view-switching glasses are worn by the viewer's face, and when the viewer's face is inclined with respect to a horizontal direction or relatively inclined with respect to a display device, the view-switching glasses are inclined accordingly. The inclination detection means detects the amount of inclination of the view-switching glasses. The amount is an index indicative of the posture of the viewer.

A display control system of the present invention includes: a pair of or plural pairs of view-switching glasses for switching how a viewer views through a left eye and a right eye, including inclination detection means for detecting an amount of inclination of the view-switching glasses when a face of a viewer wearing the view-switching glasses is inclined; and a display device for displaying an image, the view-switching glasses further including first output means for outputting, as an inclination signal, a result of detection by the inclination detection means to the display device, the display device including: a display section for displaying the image; first reception means for receiving the inclination signal; and inclination changing means for changing inclination of the image in accordance with the inclination signal received by the first reception means.

With the arrangement, the view-switching glasses are worn by the viewer's face, and when inclination of the viewer's face (direction of the face and/or inclination of the face) is changed, inclination of the view-switching glasses is changed accordingly, and the inclination of the view-switching glasses thus changed is detected by the inclination detection means. That is, the inclination detection means detects inclination of the viewer's face. The result of detection by the inclination detection means is outputted as a posture signal from the first output means to the display device.

On the other hand, in the display device, the first reception means receives the posture signal, and the inclination changing means changes the posture of the image in accordance with the posture signal received by the first reception means. That is, in the display device, the posture of the image is changed in accordance with the posture of the view-switching glasses (i.e. posture of the viewer's face).

With the arrangement, the posture of the image is changed in accordance with the posture signal received by the first reception means. This enables the viewer to view the image differently depending on the posture of the viewer's face. This enables more free expression of an image.

### Advantageous Effects of Invention

As described above, the view-switching glasses of the present invention are view-switching glasses for switching how a viewer views through a left eye and a right eye, comprising inclination detection means for detecting an amount of inclination of the view-switching glasses when a face of a viewer wearing the view-switching glasses is inclined.

Consequently, it is possible to subdue health damage to a viewer while viewing a stereoscopic image.

### BRIEF DESCRIPTION OF DRAWINGS

FIG. 1 is a block diagram showing a configuration of a main part of view-switching glasses in accordance with one embodiment of the present invention.

FIG. 2A is a schematic view for explaining the inclination of a viewer's posture when the viewer's face is not inclined.

FIG. 2B is a schematic view for explaining the inclination of a viewer's posture when the viewer's face is inclined.

FIG. 3 is a timing chart showing an example of switching between an open state and closed state of a left-eye liquid crystal shutter and a right-eye liquid crystal shutter.

FIG. 4 is a timing chart showing an example of switching between an open state and closed state of a left-eye liquid crystal shutter and a right-eye liquid crystal shutter.

FIG. 5 is a timing chart showing an example of switching between an open state and closed state of a left-eye liquid crystal shutter and a right-eye liquid crystal shutter.

FIG. 6 is a block diagram showing a configuration of a main part of a display control device in accordance with another embodiment of the present invention.

FIG. 7 is a block diagram showing a configuration of a main part of view-switching glasses in accordance with another embodiment of the present invention.

FIG. 8 is a schematic view showing an example of a display mode.

FIG. 9 is a schematic view showing an example of a display mode.

FIG. 10 is a schematic view showing an example of a display mode.

FIG. 11 is a schematic view showing an example of a display mode.

FIG. 12 is a schematic view showing an example of a display mode.

FIG. 13 is a schematic view showing an example of a display mode.

FIG. 14 is a schematic view showing an example of a display mode.

FIG. 15 is a schematic view showing an example of a display mode.

FIG. 16A is a schematic view for explaining how to detect an inclination amount by using an acceleration sensor, showing a coordinate system.

FIG. 16B is a schematic view for explaining how to detect an inclination amount by using an acceleration sensor, showing a basic posture when using a uniaxial acceleration sensor.

FIG. 16C is a schematic view for explaining how to detect an inclination amount by using an acceleration sensor, showing rotation of a lens surface when using a uniaxial acceleration sensor.

FIG. 16D is a schematic view for explaining how to detect an inclination amount by using an acceleration sensor, showing tilt of a lens surface when using a uniaxial acceleration sensor.

FIG. 16E is a schematic view for explaining how to detect an inclination amount by using an acceleration sensor, showing a basic posture when using a biaxial acceleration sensor.

FIG. 16F is a schematic view for explaining how to detect an inclination amount by using an acceleration sensor, showing rotation of a lens surface when using a biaxial acceleration sensor.

FIG. 16G is a schematic view for explaining how to detect an inclination amount by using an acceleration sensor, showing tilt of a lens surface when using a biaxial acceleration sensor.

FIG. 17 is a schematic view showing an example of a display mode.

FIG. 18 is a schematic view showing a configuration of a 3D image viewing system including view-switching glasses and a display control device of the present invention.

FIG. 19 is a schematic view showing a configuration of a display control system in accordance with Embodiment 3 of the present invention.

FIG. 20 is a view explaining a configuration of view-switching glasses.

FIG. 21A is a view explaining a relationship between the posture of view-switching glasses and the posture of a viewer's face in a case where the viewer's face is not inclined around an axis Q1 extending in a front and back direction of the viewer's face.

FIG. 21B is a view explaining a relationship between the posture of view-switching glasses and the posture of a viewer's face in a case where the viewer's face is inclined around the axis Q1.

FIG. 22A is a view explaining the posture of an image displayed by a display section, showing a state where the image is not inclined with respect to a display screen.

FIG. 22B is a view explaining the posture of an image displayed by a display section, showing a state where the image is inclined with respect to a display screen in such a manner that the image is inclined around the center of an image surface.

FIG. 23 is a view showing a state where the image in FIG. 22B is displayed while downsized.

FIG. 24 is a view showing a display section having a square display screen.

FIG. 25 is a view showing a display section having a circular display section.

FIG. 26A is a view explaining a relationship between the posture of view-switching glasses and the posture of a viewer's face in a case where the viewer's face is not inclined around an axis Q2 extending in a left and right direction of the viewer's face.

FIG. 26B is a view explaining a relationship between the posture of view-switching glasses and the posture of a viewer's face in a case where the viewer's face is inclined around the axis Q2.

FIG. 27 is a view showing a state where an image displayed by a display section is inclined around an axis Q5 extending in a left and right direction of a surface of the image.

FIG. 28A is a view explaining a relationship between the posture of view-switching glasses and the posture of a viewer's face in a case where the viewer's face does not waggle around an axis Q3 extending in an up and down direction of the viewer's face.

FIG. 28B is a view explaining a relationship between the posture of view-switching glasses and the posture of a viewer's face in a case where the viewer's face waggles around the axis Q3.

FIG. 29 is a view showing a state where an image displayed by a display section is inclined around an axis Q6 extending in an up and down direction of a surface of the image.

FIG. 30 is a schematic view showing a configuration of a display control system in accordance with Embodiment 4 of the present invention.

FIG. 31A is a view showing a state where a display section is not inclined around an axis Q7 extending in a front and back direction of the display section.

FIG. 31B is a view showing a state where a display section is inclined around the axis Q7.

FIG. 32 is a view explaining a relationship between the inclination of a viewer's face around an axis Q2 extending in a left and right direction of the viewer's face and the inclination of a display section around an axis Q9 extending in a left and right direction of the display section.

FIG. 33 is a view explaining a relationship between the waggle of a viewer's face around an axis Q3 extending in an up and down direction of the viewer's face and the waggle of a display section around an axis Q10 extending in an up and down direction of the display section.

FIG. 34 is a schematic view showing a configuration of a display control system in accordance with Embodiment 5 of the present invention.

FIG. 35 is a schematic view showing a configuration of a display control system in accordance with a modification example of Embodiment 5 of the present invention.

FIG. 36 is a schematic view showing a configuration of a display control system in accordance with Embodiment 6 of the present invention.

FIG. 37 is a view explaining an operation of the display control system in accordance with Embodiment 6 of the present invention.

FIG. 38 is a schematic view showing a configuration of a display control system in accordance with a modification example of Embodiment 6 of the present invention.

FIG. 39A is a schematic view for explaining how to detect an inclination amount by using an acceleration sensor, showing a coordinate system.

FIG. 39B is a schematic view for explaining how to detect an inclination amount by using an acceleration sensor, showing a basic posture when using a uniaxial acceleration sensor.

FIG. 39C is a schematic view for explaining how to detect an inclination amount by using an acceleration sensor, showing rotation of view-switching glasses around an axis extending in a front and back direction of the view-switching glasses when using a uniaxial acceleration sensor.

FIG. 39D is a schematic view for explaining how to detect an inclination amount by using an acceleration sensor, showing rotation of view-switching glasses around an axis extending in a left and right direction of the view-switching glasses when using a uniaxial acceleration sensor.

FIG. 39E is a schematic view for explaining how to detect an inclination amount by using an acceleration sensor, showing rotation of view-switching glasses in a basic posture when using a biaxial acceleration sensor.

FIG. 39F is a schematic view for explaining how to detect an inclination amount by using an acceleration sensor, showing rotation of view-switching glasses around an axis extending in a front and back direction of the view-switching glasses when using a biaxial acceleration sensor.

FIG. 39G is a schematic view for explaining how to detect an inclination amount by using an acceleration sensor, showing rotation of view-switching glasses around an axis extending in a left and right direction of the view-switching glasses when using a biaxial acceleration sensor.

### DESCRIPTION OF EMBODIMENTS

### Embodiment 1

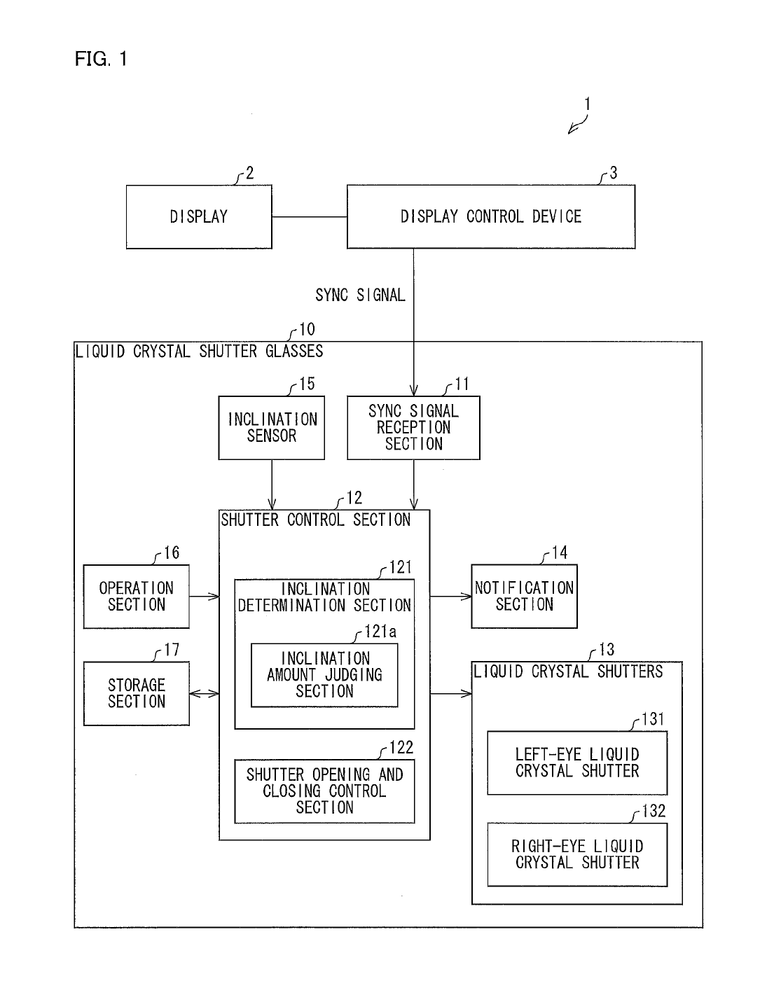

The following explains Embodiment 1 of the present invention with reference to FIGS. 1-5. For convenience of explanation, members having the same functions as those shown in the drawings are given the same reference signs and explanations thereof are omitted here.

### (Configuration of Liquid Crystal Shutter Glasses 10)

With reference to FIG. 1, the following explains a configuration of a main part of a liquid crystal shutter glasses (view-switching glasses) 10 in accordance with Embodiment 1 of the present invention. FIG. 1 is a block diagram showing an example of the configuration of the main part of the liquid crystal shutter glasses 10.

The liquid crystal shutter glasses 10 include liquid crystal shutters 13 for alternately enabling the right and left eyes of a viewer to view. Specifically, the liquid crystal shutters 13 include a left-eye liquid crystal shutter 131 capable of opening and closing in sync with timing for displaying a left-eye image and a right-eye liquid crystal shutter 132 capable of opening and closing in sync with timing for displaying a right-eye image. This enables a viewer to view the parallax image as a stereoscopic image.

Further, the liquid crystal shutter glasses 10 mainly include, in addition, a sync signal reception section 11, a shutter control section 12, a notification section 14, an inclination sensor (inclination detection means) 15, an operation section 16, and a storage section 17.

The sync signal reception section 11 receives a sync signal (shutter sync signal) from a display control device 3. The sync signal reception section 11 includes, for example, an infrared receiving element capable of receiving infrared or a light receiving element capable of receiving an optical signal from LED etc., and converts an optical signal serving as a sync signal into a signal processable by the shutter control section 12 (e.g. digital signal) and transmits the converted signal to the shutter control section 12. Consequently, a shutter opening/closing control section 122 of the shutter control section 12 can control opening and closing of the liquid crystal shutter 13 in accordance with timing for displaying a parallax image on the display (display device) 2. Thus, it is possible to provide a viewer wearing the liquid crystal shutter glasses 10 with stereoscopic sensations intended by the creator of the 3D image.

The shutter control section 12 mainly includes, an inclination determination section (determination means) 121 and a shutter opening/closing control section 122, and controls members constituting the liquid crystal shutter glasses 10 by executing a control program for example. The shutter control section 12 reads out a program stored in the storage section 17 to a first storage section (not shown) constituted by a RAM etc. and executes the program, thereby carrying out various processes such as control of opening/closing of a shutter.

The inclination determination section 121 acquires the amount of inclination of the liquid crystal shutter glasses 10 which is detected by the inclination sensor 15, and determines, based on the amount, whether the viewer's posture when viewing stereoscopic images is appropriate or not.

The liquid crystal shutter glasses 10 are worn by a viewer's face. When the viewer's face is inclined with respect to the display 2, the liquid crystal shutter glasses 10 is inclined accordingly. As mentioned later, the inclination sensor 15 detects the amount of inclination of the liquid crystal shutter glasses 10. The amount of inclination is an index indicative of the viewer's posture.

As for the appropriate posture when viewing stereoscopic images, The “3DC Safety Guidelines for Dissemination of Human-friendly 3D (revised on Apr. 20, 2010)” made by 3D Consortium (3DC) Safety/Guidelines Section read “(c)oncerning images based on binocular disparity, it is advisable to view them in a posture where the surface of the display and both eyes are on the same level”.

The inclination determination section 121 determines whether the viewer's posture when viewing stereoscopic images is appropriate or not in terms of the “3DC Safety Guidelines for Dissemination of Human-friendly 3D (revised on Apr. 20, 2010)”.

When a viewer views stereoscopic images, the shutter opening/closing control section 122 of the shutter control section 12 is in an image viewing mode in which only a left-eye image is perceived by the viewer's left eye and only a right-eye image is perceived by the viewer's right eye (initial image viewing mode).

Determination by the inclination determination section 121 that the viewer's posture is not appropriate indicates that if the viewer's posture is maintained, the initial image viewing mode must be stopped. Therefore, it can be said that the inclination determination section 121 determines whether to stop the initial image viewing mode in which only a left-eye image is perceived by the viewer's left eye and only a right-eye image is perceived by the viewer's right eye.

The inclination sensor 15 detects the amount of inclination of the liquid crystal shutter glasses 10. As described above, the amount of inclination detected by the inclination sensor 15 is an index indicative of the viewer's posture. The inclination sensor 15 may include an acceleration sensor or a gyro sensor for example.

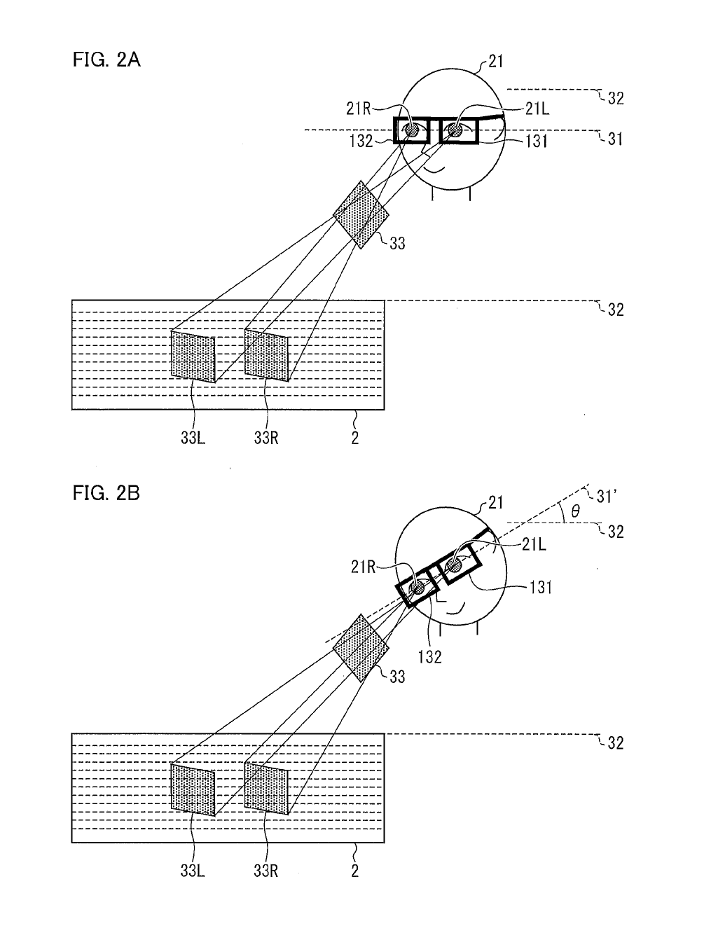

The following explains the amount of inclination detected by the inclination sensor 15. FIGS. 2A and 2B are schematic views for explaining inclination of the viewer's posture. FIG. 2A shows a case where the viewer's face is not inclined, and FIG. 2B shows a case where the viewer's face is inclined.

Initially, in FIG. 2A, a viewer 21 wears the liquid crystal shutter glasses 10. The display 2 alternately displays a left-eye image 33L and a right-eye image 33R. The left-eye image 33L is perceived by a left eye 21L of the viewer 21 via the left eye liquid crystal shutter 131 of the liquid crystal shutter glasses 10. On the other hand, the right-eye image 33R is perceived by a right eye 21R of the viewer 21 via the right eye liquid crystal shutter 132 of the liquid crystal shutter glasses 10.

Here, the face of the viewer 21 is not inclined with respect to the display 2. Specifically, a direction 31 aligning the left eye 21L and the right eye 21R of the viewer 21 is not inclined with respect to a horizontal direction 32 of the display 2. Therefore, the viewer 21's posture is such that the horizontal direction 32 of the display 2 and the direction 31 aligning the left eye 21L and the right eye 21R of the viewer 21 are horizontal with respect to each other.

The viewer 21 can view a stereoscopic image 33 resulting from the left-eye image 33L and the right-eye image 33R.

In contrast thereto, in FIG. 2B, the face of the viewer 21 is inclined with respect to the display 2. Specifically, a direction 31′ aligning the left eye 21L and the right eye 21R of the viewer 21 is inclined by an angle θ (inclination amount) with respect to the horizontal direction 32 of the display 2. In this case, the viewer 21's posture is not such that the horizontal direction 32 of the display 2 and the direction 31 aligning the left eye 21L and the right eye 21R of the viewer 21 are horizontal with respect to each other. That is, the viewer 21's posture in this case is not desirable.

The inclination sensor 15 detects an angle between the direction 31 or 31′ aligning the left eye 21L and the right eye 21R of the viewer 21 and the horizontal direction of the display 2. The angle is 0° in the case of FIG. 2A. The inclination sensor 15 outputs, as an inclination amount, the angle thus detected to the shutter control section 12.

The shutter opening/closing control section 122 controls opening and closing of the left-eye liquid crystal shutter 131 and the right-eye liquid crystal shutter 132 in accordance with a sync signal received by the sync signal reception section 11. This realizes control of the opening and closing motions in accordance with display timing. That is, the shutter opening/closing control section 122 carries out, in accordance with the sync signal, an initial image viewing mode in which the left eye of the viewer perceives only the left-eye image and the right eye of the viewer perceives only the right-eye image.

On the other hand, when the inclination determination section 121 determines that the posture of the viewer is not appropriate, the shutter opening/closing control section 122 controls opening and closing of the left-eye liquid crystal shutter 131 and the right-eye liquid crystal shutter 132 so as to carry out a predetermined image viewing mode (second image viewing mode) instead of the initial image viewing mode in accordance with the sync signal. The second image viewing mode will be mentioned later.

When the inclination determination section 121 determines that the posture of the viewer is not appropriate, the notification section 14 notifies the viewer. The notification may be made by a sound (beep) or may be made in such a manner that an image is displayed on one or both of the left-eye liquid crystal shutter 131 and the right-eye liquid crystal shutter 132 or one or both of the left-eye liquid crystal shutter 131 and the right-eye liquid crystal shutter 132 is lightened.

The operation section 16 receives inputs of the viewer, such as instructions for switching on/off the power.

The storage section 17 stores control programs for individual sections, an OS program, and an application program which are executed by the shutter control section 12, and various data which are read out when these programs are executed. The storage section 17 includes a non-volatile storage device such as a ROM and a flash memory.

Further, the storage section 17 stores how the shutter opening/closing control section 122 controls opening and closing of the left-eye liquid crystal shutter 131 and the right-eye liquid crystal shutter 132 when the second image viewing mode is carried out instead of the initial image viewing mode.

### (Threshold of Amount of Inclination Detected by Inclination Sensor 15)

As described above, the inclination determination section 121 determines whether the posture of the viewer is appropriate or not based on the amount of inclination detected by the inclination sensor 15. The determination requires a threshold of the amount of inclination based on which it is determined whether the posture of the viewer is appropriate or not. The inclination determination section 121 can make the above determination by comparing the threshold with the amount of inclination detected by the inclination sensor 15.

For example, the items <GL-3> and <GL-4> of 3DC Safety Guidelines for Dissemination of Human-friendly 3D (revised on Apr. 20, 2010) read (a) and (b) below, which clearly indicate that an inclined (slant) posture when viewing stereoscopic images causes fatigue.

(a) If both eyes are on a slant to the surface of the display, differences in upper and lower images recognized by the left eye and the right eye become larger which makes fusion of images difficult and causes eye strain.

(b) Diagonally viewing a screen makes the trapezoidal distortion bigger. It makes formation of appropriate stereoscopic images difficult which may lead to fatigue or sickness.

In the present embodiment, when an angle θ in FIG. 2B which is the amount of inclination detected by the inclination sensor 15 is within a range of −5° to 5° for example, it is determined that the posture of a viewer is appropriate, and when the angle θ is not within the range, it is determined that the posture of the viewer is not appropriate. In this case, the inclination determination section 121 makes the above determination based on the result of comparing the amount of inclination detected by the inclination sensor 15 with values of −5° and 5°.

It should be noted that the range of −5° to 5° is merely an example, and the optimum range for the amount of inclination varies with respect to each viewer. How a viewer feels fatigue varies with respect to each viewer. Accordingly, the threshold of the amount of inclination may be set in a narrower range for a viewer who is more likely to feel fatigue, thereby preventing the viewer from viewing stereoscopic images in an undesirable posture.

(Inclination Amount Judging Section 121a)

A viewer's habit varies with respect to each viewer. For example, some viewers make sudden facial motions (e.g. nod), and some viewers constantly move their faces when viewing stereoscopic images. In such cases, if the angle θ is frequently out of the range and the inclination determination section 121 determines that the posture of the viewer is not appropriate accordingly, the second image viewing mode is carried out unnecessarily. This is very troublesome for the viewer.

For this reason, it is preferable that the inclination determination section 121 includes an inclination amount judging section (judging means) 121a for determining whether the amount of inclination detected by the inclination sensor 15 is to be used for determining the viewer's posture is appropriate or not. For example, in a case where the inclination sensor 15 is an acceleration sensor, the inclination amount judging section 121a determines whether acceleration detected by the inclination sensor 15 which is an acceleration sensor is to be used in the determination by the inclination determination section 121. Specifically, the inclination amount judging section 121a determines as follows.

(a) Viewer with Sudden Facial Motion (e.g. Nod)
Acceleration is monitored for a certain period (e.g. 0.5 sec), and when there is no change in acceleration during the period, it is determined that the viewer is in a still state. At that time, the inclination amount judging section 121a judges that the acceleration is not to be used in the determination by the inclination determination section 121.
In a case of using a triaxial acceleration sensor, the absolute value of an acceleration vector is obtained based on outputs in x-, y-, and z-directions. When the absolute value is approximately 1G (G: gravitational acceleration), it is determined that the viewer is in a still state. At that time, the inclination amount judging section 121a judges that the acceleration is not to be used in the determination by the inclination determination section 121.
   (b) Viewer Whose Face Constantly Moves when Viewing Display 2
Accelerations are integrated for a certain period (e.g. 0.5 sec), and when the integrated value is approximately 1G, it is determined that the viewer is in a normal viewing state. At that time, the inclination amount judging section 121a judges that the acceleration is not to be used in the determination by the inclination determination section 121.
Difference in accelerations in z-direction is monitored for a certain period (e.g. 0.5 sec), and when the sign (positive or negative) of the difference changes two times or more during the certain period, it is determined that the viewer is in a normal viewing state. At that time, the inclination amount judging section 121a judges that the acceleration is not to be used in the determination by the inclination determination section 121.

It should be noted that the judgment mentioned above is merely an example, and the judgment may vary with respect to each viewer. How a viewer feels fatigue varies with respect to each viewer. Accordingly, the control may be made in such a manner that the above result of the determination is more likely to be outputted for a viewer who is more likely to feel fatigue, thereby preventing the viewer from viewing stereoscopic images in an undesirable posture.

### (Content of Second Image Viewing Mode)

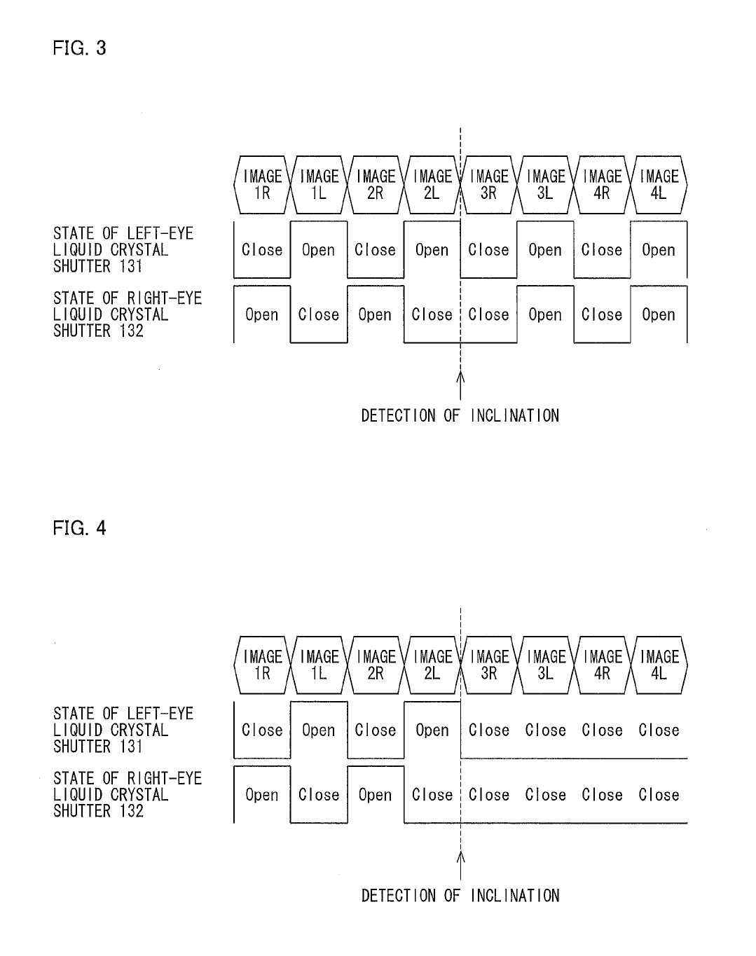

As described above, when the inclination determination section 121 determines that the posture of the viewer is not appropriate, the second image viewing mode is carried out instead of the initial image viewing mode. FIGS. 3-5 are timing charts for explaining in what manner the shutter opening/closing control section 122 controls opening and closing of the left-eye liquid crystal shutter 131 and the right-eye liquid crystal shutter 132.

In FIG. 3, when the eyes of the viewer is not inclined with respect to a horizontal line, the liquid crystal shutter glasses 10 worn by the viewer is not inclined, too. Accordingly, the inclination sensor 15 does not detect that the liquid crystal shutter glasses 10 is inclined.

In accordance with the detection result, when the display 2 displays an image 1R which is a right-eye image, the shutter opening/closing control section 122 closes the left-eye liquid crystal shutter 131 and opens the right-eye liquid crystal shutter 132. Subsequently, when the display 2 displays an image 1L which is a left-eye image, the shutter opening/closing control section 122 opens the left-eye liquid crystal shutter 131 and closes the right-eye liquid crystal shutter 132. Opening and closing of the left-eye liquid crystal shutter 131 and the right-eye liquid crystal shutter 132 are carried out similarly with respect to an image 2R which is a right-eye image and an image 2L which is a left-eye image.

In this manner, the left-eye liquid crystal shutter 131 transmits light only when the display 2 displays the images 1L and 2L which are left-eye images. Consequently, the left eye of the viewer perceives only the images 1L and 2L. Similarly, the right-eye liquid crystal shutter 132 transmits light only when the display 2 displays the images 1R and 2R which are right-eye images. Consequently, the right eye of the viewer perceives only the images 1R and 2R. Thus, the viewer views a stereoscopic image.

On the other hand, when the eyes of the viewer are inclined at more than a predetermined angle (e.g. 5°) with respect to a horizontal line, the liquid crystal shutter glasses 10 worn by the viewer are inclined, too. Accordingly, the inclination sensor 15 detects that the liquid crystal shutter glasses 10 are inclined (at timing labeled as “detection of inclination” in FIG. 3), and the inclination determination section 121 determines that the posture of the viewer is not appropriate.

In accordance with the detection result, when the display 2 displays an image 3R which is a right-eye image, the shutter opening/closing control section 122 closes both of the left-eye liquid crystal shutter 131 and the right-eye liquid crystal shutter 132. Subsequently, when the display 2 displays an image 3L which is a left-eye image, the shutter opening/closing control section 122 opens both of the left-eye liquid crystal shutter 131 and the right-eye liquid crystal shutter 132. Opening and closing of the left-eye liquid crystal shutter 131 and the right-eye liquid crystal shutter 132 are carried out similarly with respect to an image 4R which is a right-eye image and an image 4L which is a left-eye image.

As described above, the left-eye liquid crystal shutter 131 and the right-eye liquid crystal shutter 132 transmit light only when the display 2 displays the images 3L and 4L which are left-eye images. Consequently, the eyes of the viewer perceive only the images 3L and 4L, so that the viewer does not view a stereoscopic image.

That is, the timing chart in FIG. 3 indicates that the second image viewing mode is such that one of the left-eye image and the right-eye image is perceived by both eyes of the viewer. Needless to say, the second image viewing mode may be arranged such that only the images 3R and 4R are perceived by both eyes of the viewer.

In FIG. 4, when the inclination determination section 121 determines that the posture of the viewer is not appropriate (at timing labeled as “detection of inclination” in FIG. 4), that is, when the eyes of the viewer are inclined at more than a predetermined angle (e.g. 5°) with respect to a horizontal line, the liquid crystal shutter glasses 10 are inclined, too. Accordingly, the inclination sensor 15 detects that the liquid crystal shutter glasses 10 are inclined.

In accordance with the detection result, when the display 2 displays an image 3R which is a right-eye image, the shutter opening/closing control section 122 closes both of the left-eye liquid crystal shutter 131 and the right-eye liquid crystal shutter 132. Subsequently, when the display 2 displays an image 3L which is a left-eye image, the shutter opening/closing control section 122 continues to close both the left-eye liquid crystal shutter 131 and the right-eye liquid crystal shutter 132. Subsequently, when the display 2 displays an image 4R which is a right-eye image and when the display 2 displays an image 4L which is a left-eye image, the shutter opening/closing control section 122 continues to close both the left-eye liquid crystal shutter 131 and the right-eye liquid crystal shutter 132.

As described above, the left-eye liquid crystal shutter 131 and the right-eye liquid crystal shutter 132 do not transmit light when the display 2 displays any of the images 3L and 4L which are left-eye images and the images 3R and 4R which are right-eye images, so that both eyes of the viewer do not perceive any of the images 3L, 4L, 3R, and 4R. Consequently, the viewer cannot view an image at all.

That is, the timing chart in FIG. 4 indicates that the second image viewing mode is such that neither of the left-eye image and the right-eye image is perceived by the eyes of the viewer.

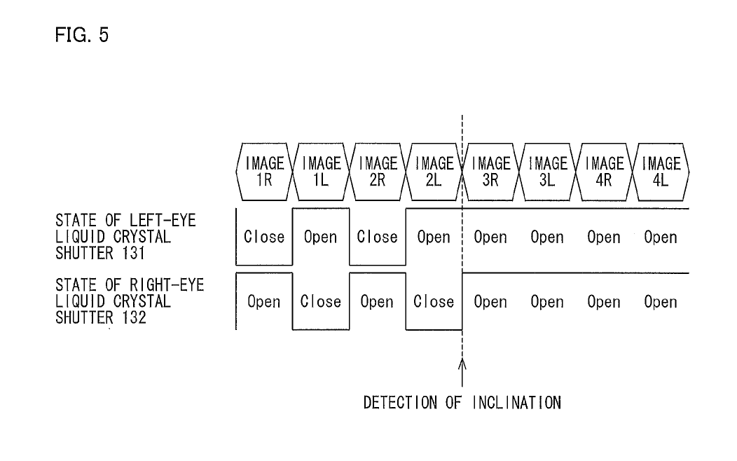

In FIG. 5, when the inclination determination section 121 determines that the posture of the viewer is not appropriate (at timing labeled as “detection of inclination” in FIG. 5), that is, when the eyes of the viewer are inclined at more than a predetermined angle (e.g. 5°) with respect to a horizontal line, the liquid crystal shutter glasses 10 are inclined, too. Accordingly, the inclination sensor 15 detects that the liquid crystal shutter glasses 10 are inclined.

In accordance with the detection result, when the display 2 displays an image 3R which is a right-eye image, the shutter opening/closing control section 122 opens both of the left-eye liquid crystal shutter 131 and the right-eye liquid crystal shutter 132. Subsequently, when the display 2 displays an image 3L which is a left-eye image, the shutter opening/closing control section 122 continues to open both the left-eye liquid crystal shutter 131 and the right-eye liquid crystal shutter 132. Subsequently, when the display 2 displays an image 4R which is a right-eye image and when the display 2 displays an image 4L which is a left-eye image, the shutter opening/closing control section 122 continues to open both the left-eye liquid crystal shutter 131 and the right-eye liquid crystal shutter 132.

As described above, the left-eye liquid crystal shutter 131 and the right-eye liquid crystal shutter 132 transmit light when the display 2 displays any of the images 3L and 4L which are left-eye images and the images 3R and 4R which are right-eye images, so that both eyes of the viewer perceive any of the images 3L, 4L, 3R, and 4R. Consequently, the viewer cannot view a stereoscopic image.

That is, the timing chart in FIG. 5 indicates that the second image viewing mode is such that both of the left-eye image and the right-eye image are perceived by the eyes of the viewer.

### (Effect Yielded by Liquid Crystal Shutter Glasses 10)

As described above, the inclination determination section 121 determines whether the posture of the viewer viewing stereoscopic images is appropriate or not based on the amount of inclination of the liquid crystal shutter glasses 10 detected by the inclination sensor 15. Using the determination result, for example, the viewer can know whether the posture of the viewer is appropriate or not for viewing stereoscopic images.

When it is determined that the posture of the viewer is not appropriate, the shutter opening/closing control section 122 carries out the second image viewing mode different from the initial image viewing mode having carried out so far, thereby changing images perceived by the eyes of the viewer.

As a result of this change, the viewer can surely know that the posture of the viewer is determined as not appropriate.

Therefore, it is possible to reduce health damage deriving from inappropriate posture of the viewer when viewing stereoscopic images.

### Embodiment 2

Embodiment 2 is arranged such that when it is determined that the posture of a viewer is not appropriate, the determination result is output from liquid crystal shutter glasses to a display control device, and the display control device changes a display mode in accordance with the output.

### (Configuration of Display Control Device 50)

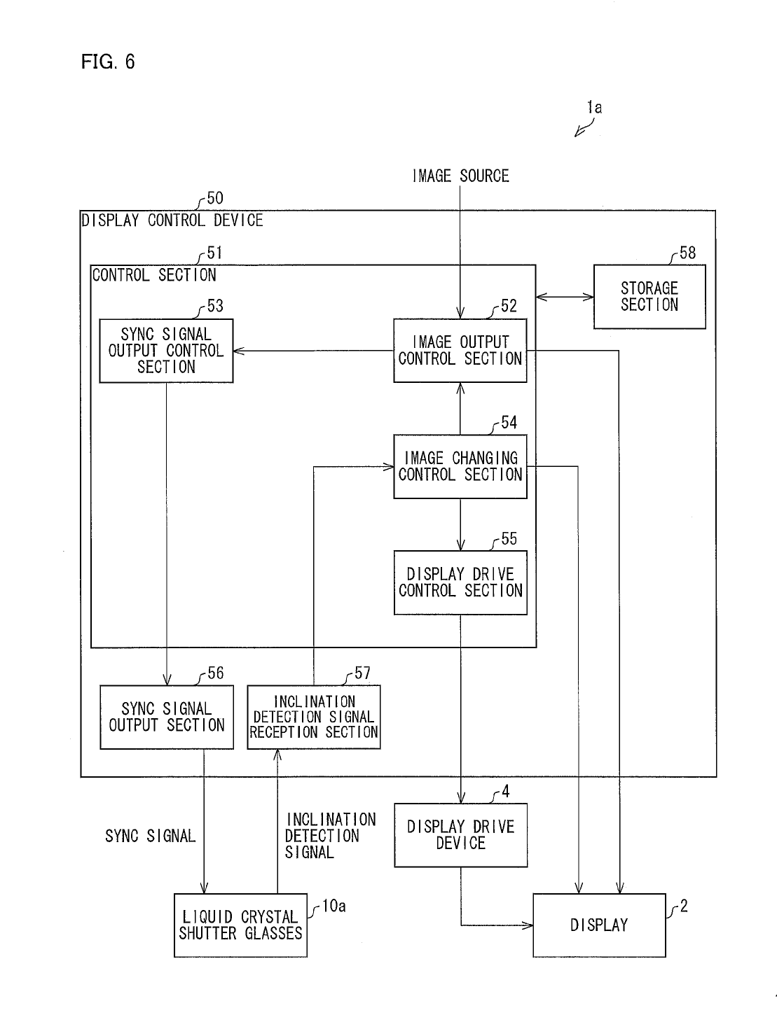

With reference to FIG. 6, the following explains a configuration of a main part of a display control device 50 in accordance with Embodiment 2 of the present invention. FIG. 6 is a block diagram showing an example of the configuration of the main part of the display control device 50.

The display control device 50 causes the display 2 to display parallax images, enabling a viewer to view stereoscopic images via liquid crystal shutter glasses 10a. For this purpose, the display control device 50 mainly includes a control section 51, a sync signal output section 56, an inclination detection signal reception section 57, and a storage section 58.

The control section 51 mainly includes an image output control section 52, a sync signal output control section 53, an image changing control section (changing means) 54, and a display drive control section 55. The control section 51 controls members constituting the display control device 50 by executing a control program for example. The control section 51 reads out a program stored in the storage section 58 to a primary storage section (not shown) including a RAM (Random Access Memory) etc. and executes the program, thereby carrying out various processes such as image changing control, display driving control, and output control of a shutter sync signal.

The image output control section 52 receives, as an image source, parallax images reproduced by a record reproducing device 5 (mentioned later) in FIG. 18, and alternately outputs, to the display 2, a left-eye image and a right-eye image which are the parallax images. That is, as a result of the output, the image output control section 52 causes the display 2 to alternately display the left-eye image and the right-eye image. A viewer views the parallax images on the display 2 via the liquid crystal shutter glasses 10a, thereby viewing the parallax images as stereoscopic images.

Further, the image output control section 52 transmits, to the sync signal output control section 53, display timing signals indicative of timings at which the left-eye image and the right-eye image are to be displayed on the display 2 (timing for alternating the left-eye image and the right-eye image).

The image changing control section 54 changes a display mode when the left-eye image and the right-eye image from the image output control section 52 are displayed by the display 2 (display mode of display). When a viewer wears the liquid crystal shutter glasses 10a and views stereoscopic images, the image changing control section 54 causes the display 2 to alternately display the left-eye image and the right-eye image in sync with timing for the liquid crystal shutter glasses 10a to alternately enable the left eye and the right eye of the viewer to view. The display mode of the display 2 at that time is referred to as “stereoscopic image display mode”.

On the other hand, when the image changing control section 54 receives an inclination detection signal (determination signal) from the liquid crystal shutter glasses 10a via the inclination detection signal reception section 57, the image changing control section 54 changes the display mode of the display 2 from the stereoscopic image display mode to a predetermined second image display mode.

The image changing control section 54 may directly output a predetermined image to the display 2 without intermediation of the image output control section 52. The predetermined image is, for example, “warning message” which will be mentioned later. It should be noted that the stereoscopic image display mode with addition of the predetermined image which the image changing control section 54 directly outputs to the display 2 and causes the display 2 to display is also referred to as the second image display mode.

Further, the image changing control section 54 may control, by means of the display drive control section 55, a display drive device 4 for rotating the display 2 in a predetermined manner. The rotation in a predetermined manner is, for example, rotation of the display 2 around its central axis, which will be explained later. It should be noted that such a display mode in which the image changing control section 54 rotates the display 2 in a predetermined manner by means of the display drive control section 55 is also referred to as the second image display mode.

Upon reception of the display timing signal from the image output control section 52, the sync signal output control section 53 controls the sync signal output section 56 so as to output the display timing signal as a shutter sync signal in accordance with which the liquid crystal shutter glasses 10a are synchronized with parallax images displayed by the display 2.

The sync signal output section 56 outputs the shutter sync signal received from the sync signal output control section 53. The sync signal output section 56 includes, for example, an infrared emitting element capable of outputting infrared or a semiconductor light emitting element such as a light emitting diode (LED) and a semiconductor laser (LD), and converts the shutter sync signal into an optical signal such as infrared and outputs the optical signal.

As described above, the display control device 50 outputs the shutter sync signal and the liquid crystal shutter glasses 10a receive the shutter sync signal. Thus, the liquid crystal shutter glasses 10a can synchronize opening and closing of the liquid crystal shutter 13 with parallax images displayed by the display 2, thereby enabling a viewer to experience a stereoscopic effect intended by a creator of 3D images.

The inclination detection signal reception section 57 receives an inclination detection signal from the liquid crystal shutter glasses 10a. The inclination detection signal reception section 57 includes, for example, an infrared receiving element capable of receiving infrared or a laser light receiving element capable of receiving laser light from an LED etc., and converts an optical signal serving as an inclination detection signal into a signal processable by the image changing control section 54 (e.g. digital signal) and transmits the signal to the image changing control section 54. It is preferable that the sync signal and the inclination detection signal are on different frequency bands in order to avoid crosstalk of the two signals.

The display drive control section 55 rotates the display 2 by means of a display drive device for rotating the display 2. The rotation of the display 2 may be rotation centering on the center of a display surface viewed by a viewer or may be rotation centering on the center of any of side surfaces of the display 2 which side surfaces are orthogonal to the display surface. The display drive device 4 has a mechanism for realizing such rotation.

The storage section 58 stores control programs for individual sections, an OS program, and an application program which are executed by the control section 51, and various data which are read out when these programs are executed. The storage section 58 includes a non-volatile storage device such as a ROM (Read Only Memory) and a flash memory.

Further, the storage section 58 stores the content of the second image display mode to which the image changing control section 54 changes a display mode.

(Configuration of Liquid Crystal Shutter Glasses 10a)

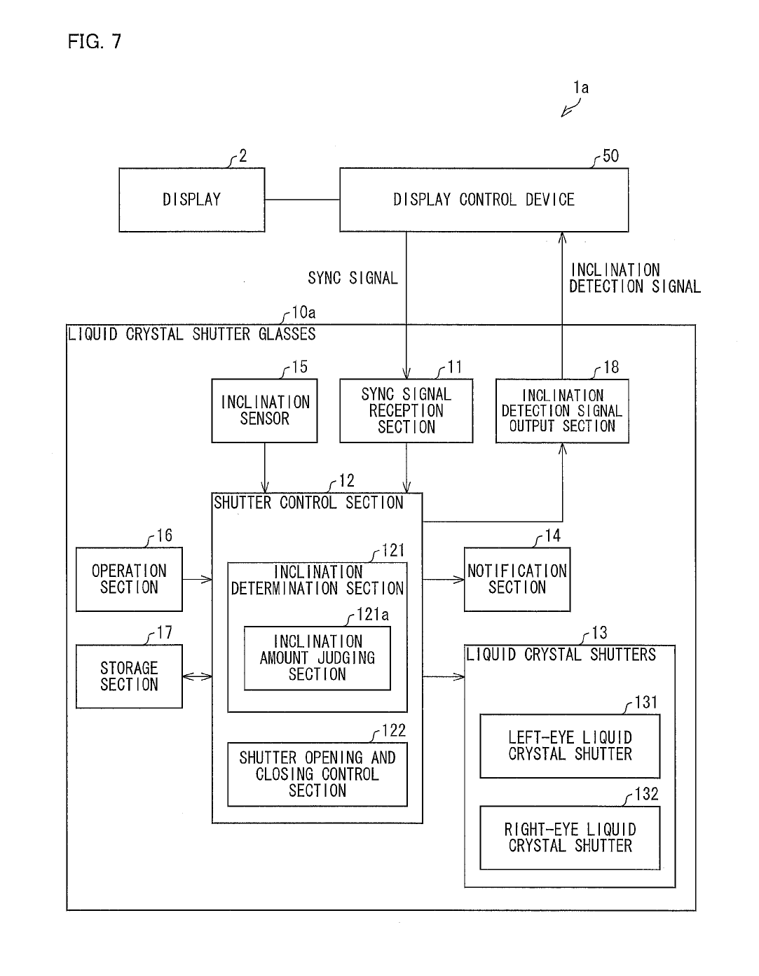

With reference to FIG. 7, the following explains a configuration of a main part of the liquid crystal shutter glasses (view-switching glasses) 10a in accordance with Embodiment 2 of the present invention. FIG. 7 is a block diagram showing an example of the configuration of the main part of the liquid crystal shutter glasses 10a.

The liquid crystal shutter glasses 10a are different from the liquid crystal shutter glasses 10 in accordance with Embodiment 1 in that the liquid crystal shutter glasses 10a further include an inclination detection signal output section 18. In the following description, members which are the same as those in Embodiment 1 are given the same reference signs and detailed explanations thereof are omitted here.

As described above, the inclination determination section 121 determines whether the posture of a viewer viewing stereoscopic images is appropriate or not. When the inclination determination section 121 determines that the posture of the viewer is not appropriate, the inclination detection signal output section 18 outputs, to the display control device 50, an inclination detection signal (determination signal) indicative of the detection result. As described above, the inclination detection signal indicates that the inclination determination section 121 has determined that the posture of the viewer is not appropriate. Further, the inclination detection signal may include an inclination amount signal indicative of the amount of inclination detected by the inclination sensor 15.

The inclination detection signal output section 18 includes, for example, an infrared emitting element capable of outputting infrared or a semiconductor light emitting element such as a light emitting diode (LED) and a semiconductor laser (LD), and converts the shutter sync signal into an optical signal such as infrared and outputs the optical signal.

As described above, the liquid crystal shutter glasses 10a output the inclination detection signal and the display control device 50 receives the inclination detection signal. Thus, when the inclination determination section 121 of the liquid crystal shutter glasses 10a determines that the posture of the viewer is not appropriate, the display control device 50 can change the display mode of the display 2 from a stereoscopic image display mode to a second image display mode.

### (Content of Second Image Display Mode)

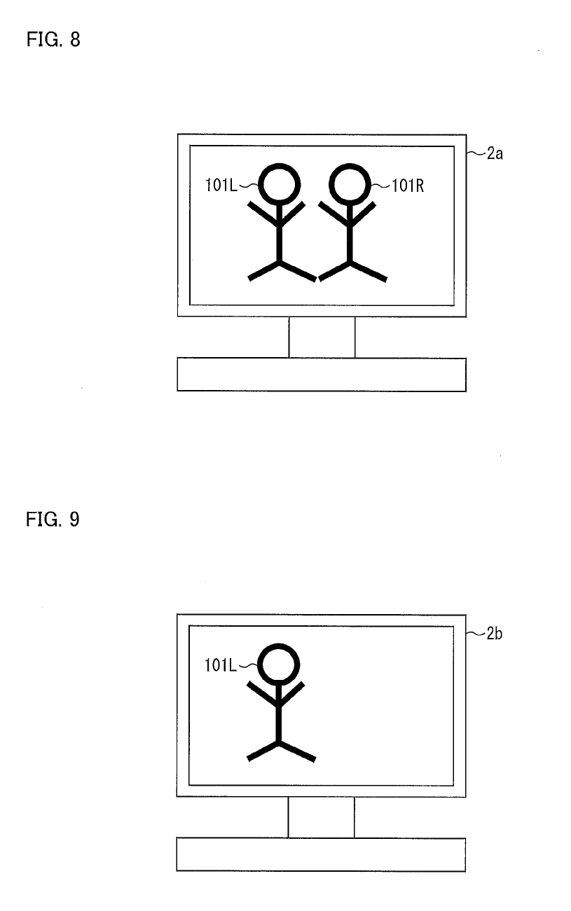

As described above, when the inclination determination section 121 of the liquid crystal shutter glasses 10a determines that the posture of the viewer is not appropriate, the image changing control section 54 of the display control device 50 changes the display mode of the display 2 from the stereoscopic image display mode to the second image display mode. FIGS. 9-15 are schematic views for explaining the second image display mode to which the display mode of the display 2 is changed from the stereoscopic image display mode. FIG. 8 is a schematic view showing the stereoscopic image display mode in which a left-eye image 101L and a right-eye image 101R are displayed alternately by a display 2a.

In FIG. 9, only the left-eye image 101L is displayed by a display 2b. That is, the display mode in FIG. 9 is a second image display mode in which only the left-eye image 101L out of the left-eye image 101L and the right-eye image 101R is displayed. Needless to say, the display mode may be a second image display mode in which only the right-eye image 101R is displayed.

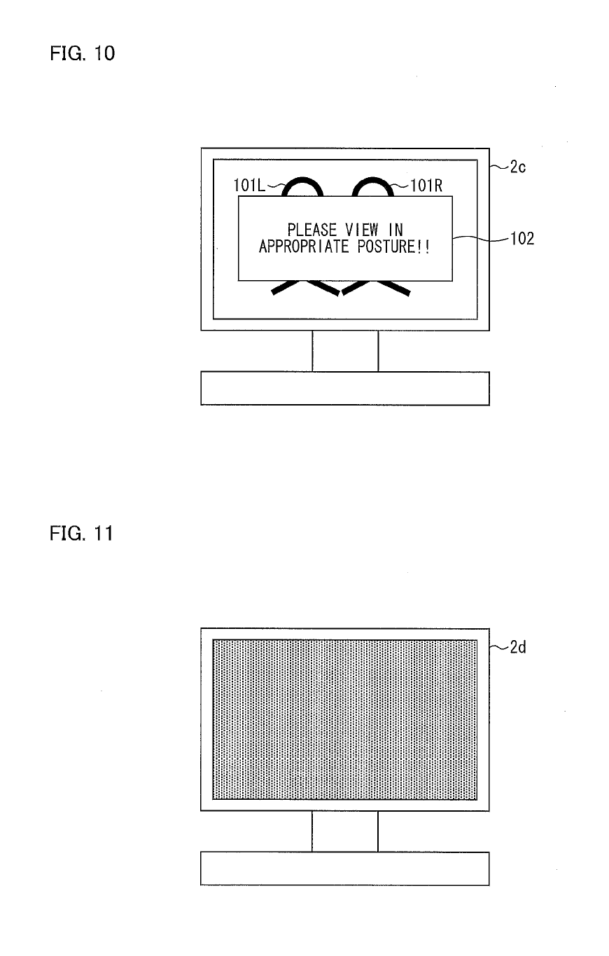

In FIG. 10, the left-eye image 101L and the right-eye image 101R are displayed alternately by a display 2c, and besides a warning message 102 is displayed by the display 2c. That is, the display mode in FIG. 10 is a display mode of displaying a message for notifying a viewer that the inclination determination section 121 has determined that the posture of the viewer is not appropriate.

In FIG. 11, neither of the left-eye image 101L and the right-eye image 101R is displayed by a display 2d. That is, the display mode in FIG. 11 is a display mode in which an image is not displayed by the display 2d.

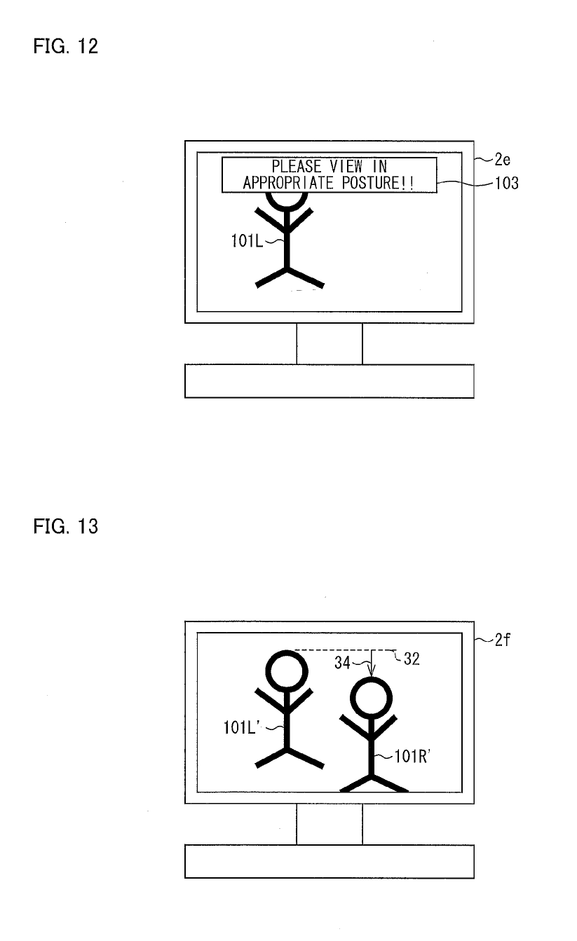

In FIG. 12, only the left-eye image 101L is displayed by a display 2e, and besides a warning message 103 is displayed by the display 2e. That is, the display mode in FIG. 12 is a display mode (notification image display mode) of displaying a message for notifying the viewer that the inclination determination section 121 has determined that the posture of the viewer is not appropriate, as well as displaying 2D images. It should be noted that the warning message may be replaced with a warning mark, flickering on a screen etc. as long as it can notify the viewer that the posture of the viewer is not appropriate.

In FIG. 13, the left-eye image 101L and the right-eye image 101R are displayed alternately by a display 2f. At that time, positions of the left-eye image 101L and the right-eye image 101R on the display 2f are changed using the amount of inclination indicated by the inclination amount signal. The changed images are a left-eye image 101L′ and a right-eye image 101R′.

That is, the display mode in FIG. 13 is a display mode in which the right-eye image 101R and the left-eye image 101L are moved in a direction 34 and in the opposite direction, respectively, along a vertical direction so that a line joining corresponding points on the right-eye image 101R and the left-eye image 101L is inclined with respect to a horizontal direction 32 in the same amount as the amount of inclination detected by the inclination sensor 15.

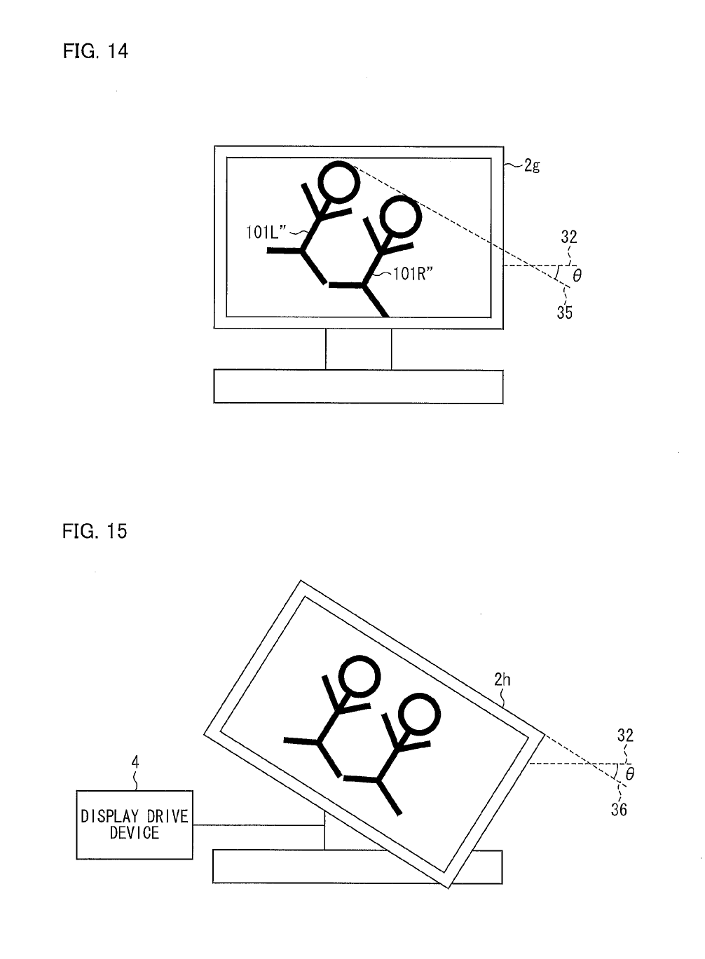

Also in FIG. 14, the left-eye image 101L and the right-eye image 101R are displayed alternately on a display 2g. In FIG. 14, the positions of the left-eye image 101L and the right-eye image 101R on the display 2g are changed according to the amount of inclination indicated by the inclination amount signal. The changed images are a left-eye image 101L″ and a right-eye image 101R″. The amount of inclination indicated by the inclination amount signal is the amount of how a direction aligning the eyes of a viewer is inclined with respect to a horizontal direction.

That is, the display mode in FIG. 14 is a display mode in which the left-eye image 101L and the right-eye image 101R are rotated around the center of the display 2g while maintaining the relative positional relationship between the left-eye image 101L and the right-eye image 101R so that a line 35 joining corresponding points on the left-eye image 101L and the right-eye image 101R is inclined with respect to a horizontal direction 32 in the same amount as the amount of inclination detected by the inclination sensor 15.

Further, the display mode in FIG. 14 is a display mode in which the left-eye image 101L and the right-eye image 101R are rotationally moved to the left-eye image 101L″ and the right-eye image 101R″, respectively.

The display mode in FIG. 15 is different from the display mode in FIG. 14 in that a display 2h displaying the left-eye image 101L and the right-eye image 101R rotates itself.

(Effects Yielded by Display Control Device 50 and Liquid Crystal Shutter Glasses 10a)

As described above, the inclination determination section 121 determines whether posture of a viewer viewing stereoscopic images is appropriate or not in accordance with the amount of inclination of the liquid crystal shutter glasses 10 which is detected by the inclination sensor 15. The determination result enables the viewer, for example, to know whether the posture of the viewer is appropriate or not for viewing stereoscopic images.

Further, in a case where it is determined that the posture of the viewer is not appropriate, the image changing control section 54 changes the display mode of the display 2 from the stereoscopic image display mode to the second image display mode different from the stereoscopic image display mode.

The great change in the display mode enables the viewer to surely know that the posture of the viewer is determined as not appropriate.

Further, in a case where a plurality of viewers view stereoscopic images simultaneously, viewers other than the viewer whose posture is determined as not appropriate can know who is the viewer, and warn the viewer.

Consequently, it is possible to surely reduce health damage deriving from the posture of a viewer viewing stereoscopic images.

### [Method for Detecting Amount of Inclination]

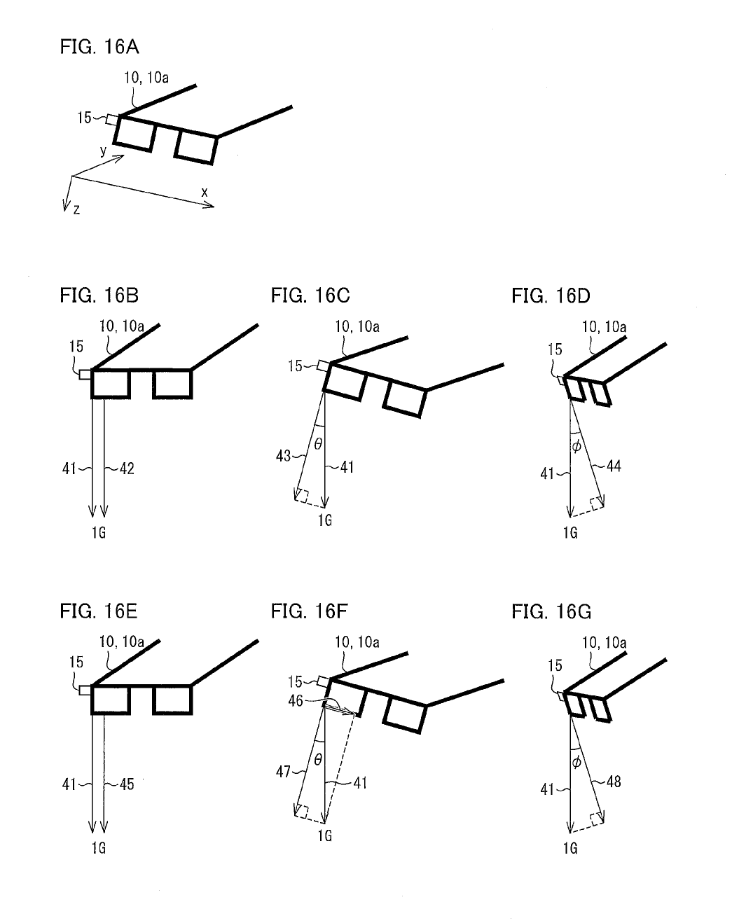

As described above, the inclination sensor 15 may use an acceleration sensor. The following explains a method for detecting the amount of inclination in a case of using the acceleration sensor. FIGS. 16A, 16B, 16C, 16D, 16E, 16F, and 16G are schematic views for explaining how to detect the amount of inclination by using the acceleration sensor. FIG. 16A shows a coordinate system. FIGS. 16B, 16C, and 16D show a basic posture, rotation of a lens surface, and tilt of the lens surface, respectively, in a case of using a uniaxial acceleration sensor. FIGS. 16E, 16F, and 16G show a basic posture, rotation of a lens surface, and tilt of the lens surface, respectively, in a case of using a biaxial acceleration sensor.

As shown in FIG. 16A, the liquid crystal shutter glasses 10 are equipped with the inclination sensor 15 which is an acceleration sensor. For example, in a case of a uniaxial acceleration sensor, when a viewer is in the basic posture, a z-directed acceleration 42 is 1G 41 as shown in FIG. 16B. This shows that the viewer's face is not inclined.

As shown in FIG. 16C, in the case of rotation of the lens surface, a z-directed acceleration 43 is 1G×cos θ, and comparison of the z-directed acceleration 43 with 1G 41 shows that the viewer's face is inclined.

As shown in FIG. 16D, in the case of tilt of the lens surface, a z-directed acceleration 44 is 1G×cos φ, and comparison of the z-directed acceleration 44 with 1G 41 shows that the viewer's face is inclined.

In a case of a biaxial acceleration sensor, when a viewer is in the basic posture, an x-directed acceleration is 0G and a z-directed acceleration 45 is 1G 41 as shown in FIG. 16E. This shows that the viewer's face is not inclined.

As shown in FIG. 16F, in the case of rotation of the lens surface, an x-directed acceleration 46 is 1G×sin θ and a z-directed acceleration 47 is 1G×cos θ, and comparison of the absolute values of the x-directed acceleration 46 and the z-directed acceleration 47 with 1G 41 shows that the viewer's face is inclined.

As shown in FIG. 16G, in the case of tilt of the lens surface, an x-directed acceleration is 0G and a z-directed acceleration 48 is 1G×cos φ, and comparison of the absolute values of the x-directed acceleration and the z-directed acceleration 48 with 1G shows that the viewer's face is inclined.

### [Case of Tilt of Lens Surface]

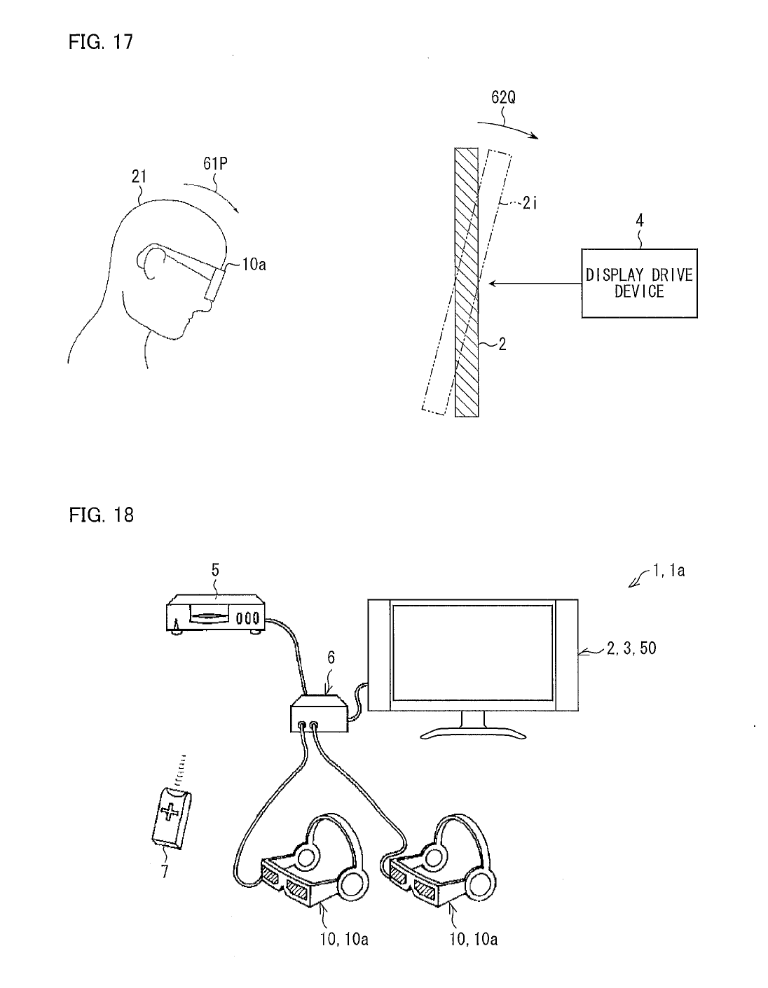

FIG. 17 is a schematic view showing an example of the second image display mode of the display 2 in a case of the tilt of the lens surface shown in FIGS. 16D and 16G.

As shown in FIG. 17, when a viewer 21's face is inclined in a direction of an arrow 61P, the image changing control section 54 causes the display drive control section 55 to control the display drive device 4. As a result of the control, the display 2 rotates in a direction of an arrow 62Q, so that the position of the display 2 is changed to the position of a display 2i.

### [Schematic Configuration of 3D Image Viewing System]

Lastly, with reference to FIG. 18, the following explains a 3D image viewing system 1 (or 1a) including the liquid crystal shutter glasses 10 (or 10a) and the display control device 3 (or 50). FIG. 18 is a view showing a schematic configuration of the 3D image viewing systems 1 and 1a.

The 3D image viewing system 1 (or 1a) enables a viewer wearing the liquid crystal shutter glasses 10 (or 10a) to view three-dimensional image (3D image, stereoscopic image) resulting from a parallax image displayed by the display 2 connected with the display control device 3 (or 50).

As shown in FIG. 18, the 3D image viewing system 1 (or 1a) mainly includes the display control device 3 (or 50), the display 2, the liquid crystal shutter glasses 10 (or 10a), a record reproducing device 5, a relay 6, and an operation section 7. In FIG. 18, the display control device 3 (or 50) is integrated with the display 2.

The display control device 3 (or 50) causes the display 2 to display an image reproduced by the record reproducing device 5 for example. The display 2 displays images outputted from the display control device 3 (or 50). Examples of the display 2 include LCD (Liquid Crystal Display), PDP (Plasma Display Panel), and CRT (Cathode-ray tube).

The liquid crystal shutter glasses 10 (or 10a) are used in combination with the display control device 3 (or 50), and has a three-layered structure consisting of a polarizing plate, a liquid crystal layer, and a polarizing plate. Alternating two polarized lights transmitted by the liquid crystal layer alternately enables the left eye and the right eye of a viewer to view. To be more specific, the liquid crystal shutter glasses 10 (or 10a) are designed such that a left-eye shutter and a right-eye shutter are opened and closed in response to a shutter drive signal for controlling transmission and shielding of light, the shutter drive signal is in sync with field frequency of a desired image signal outputted from the display device, and a signal width of the shutter drive signal corresponds to that of the image signal. Accordingly, opening and closing of the shutter in response to the shutter drive signal enables a viewer to view, through the opened shutter, an image indicated by a selected image signal out of a plurality of image signals, and disables the viewer to view other images by the closed shutter. Thus, the viewer can view only a desired image.

Eyeglasses worn by a viewer when viewing stereoscopic images are not limited to the liquid crystal shutter glasses 10 (or 10a), and may be ones capable of alternately being viewable and unviewable by use of other mechanism. For example, the eyeglasses may be designed such that a rotating plate is provided in front of each of the left eye glass and the right eye glass, and the plate covers one of the left eye glass and the right eye glass.

In FIG. 18, the liquid crystal shutter glasses 10 (or 10a) are wire-connected with the display control device 3 (or 50) via a cable. Alternatively, the liquid crystal shutter glasses 10 (or 10a) may be wirelessly connected with the relay 6 and/or the display control device 3 (or 50).

In FIG. 18, two liquid crystal shutter glasses 10 (or 10a) are connected with the relay 6. However, the number of the liquid crystal shutter glasses 10 (or 10a) is not limited to two, and may be one or three or more.

The operation section 7 is a section via which a viewer inputs instruction signals for operating the display control device 3 (or 50) and the record reproducing device 5. Examples of the operation section 7 include a remote controller for remotely controlling the display control device 3 (or 50), operation buttons provided on the display control device 3 (or 50) itself, and a mouse, keyboard etc. connected with the display control device 3 (or 50). The instruction signal inputted by the viewer via the operation section 7 is transmitted to the display control device 3 (or 50) and/or sections of the record reproducing device 5 via an input and output control section (not shown). Thus, the viewer can operate the display control device 3 (or 50) and the record reproducing device 5.

The record reproducing device 5 reproduces image information stored in an information storage medium such as BD (Blu-Ray© Disc), DVD (Digital Versatile Disc), and HDD (Hard Disc Drive), and may be a publicly known information reproducing device.

In FIG. 18, an image signal reproduced by the record reproducing device 5 is inputted to the display control device 3 (or 50). Alternatively, instead of an image signal reproduced by the record reproducing device 5, image data received via the IP (Internet Protocol) network from services for distributing contents such as real-time broadcastings and movies may be inputted to the display control device 3 (or 50) and an image indicated by the image data may be displayed by the display 2. For example, image data may be obtained from a linear TV which is a broadcasting service for distributing a program in real time according to a broadcasting schedule or from VoD (Video on Demand) which is a service for distributing contents in a unicast manner to a content processing device is inputted to the display control device 3 (or 50), and an image indicated by the image data may be displayed by the display 2. Alternatively, image data from terrestrial digital broadcasting or cable television may be inputted to the display control device 3 (or 50) and an image indicated by the image data may be displayed by the display 2.

The relay 6 is a device via which the display control device 3 (or 50), the liquid crystal shutter glasses 10 (or 10a), and the record reproducing device 5 are connected with one another. However, in a case where the liquid crystal shutter glasses 10 (or 10a) and the record reproducing device 5 are directly connected with the display control device 3 (or 50), in a case where the display control device 3 (or 50) is wirelessly connected with the liquid crystal shutter glasses 10 (or 10a), in a case where the record reproducing device 5 is included in the display control device 3 (or 50), or the like cases, the relay 6 is not particularly required.

### [Additional Note]

Lastly, each block of the shutter control section 12 of the liquid crystal shutter glasses 10 (or 10a) and each block of the display control device 3 and the control section 51 of the display control device 50 may be realized by hardware logic or may be realized by software by using CPUs as described below.

Namely, the shutter control section 12 and the control section 51 include: CPUs (central processing unit) for executing a program for realizing functions of each block; ROMs (read only memory) that store the program; RAMs (random access memory) that develop the program; a storage device (storage medium) such as a memory that stores the program and various data; and the like. The object of the present invention can be realized in such a manner that the liquid crystal shutter glasses 10 (or 10a) and the display control device 50 are provided with a computer-readable storage medium for storing program codes (such as executable program, intermediate code program, and source program) of programs of the shutter control section 12 and the control section 51 which programs serve as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a Floppy Disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the liquid crystal shutter glasses 10 (or 10a) and the display control device 50 may be arranged so as to be connectable to a communication network so that the program code is supplied to the liquid crystal shutter glasses 10 (or 10a) and the display control device 50 through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program codes in the form of a computer data signal embedded in a carrier wave, which is the program that is electrically transmitted.

The present invention is not limited to the description of the embodiments above, but may be altered by a skilled person within the scope of the claims. An embodiment based on a proper combination of technical means disclosed in different embodiments is encompassed in the technical scope of the present invention.

The present invention may be expressed also as follows. That is, a display control device of the present invention is a display control device capable of controlling display state changing means including a right-eye shutter and a left-eye shutter capable of switching an image displayed by an image display device between a viewable state and unviewable state with respect to a viewer, the display control device including: means for receiving a sync signal indicative of timing for causing the image display device to display the image; and posture detection means for detecting posture of the display control device, opening and closing of the right-eye shutter and the left-eye shutter being carried out in accordance with the sync signal, and the image viewed by the viewer being changed in accordance with the posture of the display control device detected by the posture detection means.

It is preferable to arrange the display control device of the present invention such that the display state changing means changes opening and closing of the right-eye shutter and the left-eye shutter in such a manner that the right-eye shutter and the left-eye shutter opens and closes simultaneously.

It is preferable to arrange the display control device of the present invention such that the display state changing means changes opening and closing of the right-eye shutter and the left-eye shutter in such a manner that both of the right-eye shutter and the left-eye shutter continue to be closed.

It is preferable to arrange the display control device of the present invention such that the display state changing means changes opening and closing of the right-eye shutter and the left-eye shutter in such a manner that both of the right-eye shutter and the left-eye shutter continue to be opened.

It is preferable to arrange the display control device of the present invention so as to further include means for transmitting a signal to a display device corresponding to the display control device and changing means for causing the display device to display an image changed in accordance with a signal indicative of posture of the display control device which signal is transmitted from the signal transmission means to the image display device.

A display device of the present invention is a stereoscopic image display device capable of corresponding to the above display control device, including means for changing, under control of the changing means, image display of the display device from 3D image display to 2D image display.

Preferably, the changing means causes the display device to display an image changed to include a warning message to the viewer on an image display screen.

Preferably, the changing means causes the display device to change an image in such a manner that an image desired by the viewer is not displayed.

Preferably, the changing means causes the display device to change an image in such a manner that a 3D image is changed to a 2D image including the warning message or that an image desired by the viewer is not displayed while the warning message is displayed.

Preferably, the changing means causes the display device to change an image in such a manner that positions of the right-eye image and the left-eye image are changed.

Preferably, the changing means causes the display device to change an image in such a manner that the right-eye image and the left-eye image are moved in parallel so that a line joining the right-eye image and the left-eye image is substantially parallel to a line joining the right eye and the left eye of the viewer.

Preferably, the changing means causes the display device to change an image in such a manner that the right-eye image and the left-eye image are rotated around the center of an image display section of the display device so that a line joining the right-eye image and the left-eye image is substantially parallel to a line joining the right eye and the left eye of the viewer.

Preferably, the changing means causes to display device to rotate the right-eye image and the left-eye image in such a manner that the images displayed by the display device are rotated without physically rotating the display device.

Preferably, the changing means causes to display device to rotate the right-eye image and the left-eye image in such a manner that the display device is physically rotated.

Preferably, the detected posture is obtained from acceleration applied to the display control device.

### Embodiment 3

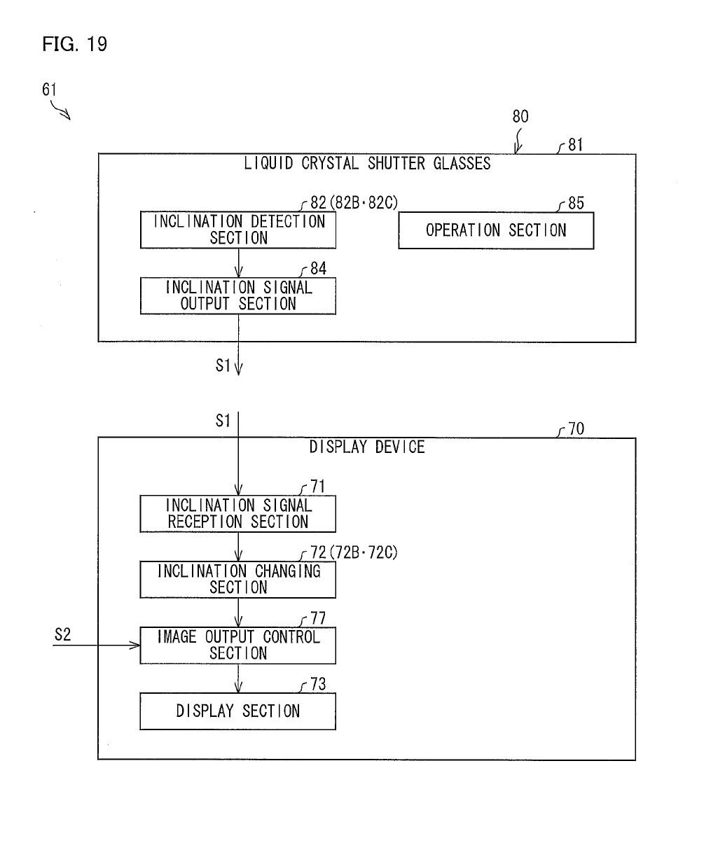

With reference to FIGS. 19-22, the following explains a display control system in accordance with Embodiment 3 of the present invention.

### (Configuration of Display Control System)

A display control system 61 in accordance with the present embodiment changes inclination of an image in accordance with inclination of a viewer's face. As shown in FIG. 19, the display control system 61 includes a display device 70 for displaying an image and liquid crystal shutter glasses (view-switching glasses) 80 which can be worn by the viewer's face.

The following explains a case where when a viewer's face is inclined around an axis extending in a front and back direction of the face, an image displayed by the display device 70 is inclined, in accordance with the inclination of the face, around an axis extending in a front and back direction of the image (i.e. axis normal to an image surface) toward the same rotational direction as the inclination of the viewer's face.

### (Configuration of Liquid Crystal Shutter Glasses 80)

The liquid crystal shutter glasses 80 have a function of detecting the inclination of a viewer's face wearing the liquid crystal shutter glasses 80. As shown in FIG. 19, the liquid crystal shutter glasses 80 include a liquid crystal shutter glasses main body 81, an inclination detection section (inclination detection means) 82, an inclination signal output section (first output means) 84, and an operation section 85.

The inclination detection section 82, the inclination signal output section 84, and the operation section 85 are provided on the liquid crystal shutter glasses main body 81 (to be more specific, a frame section 81a or temples 81bL and 81bR which will be mentioned later).

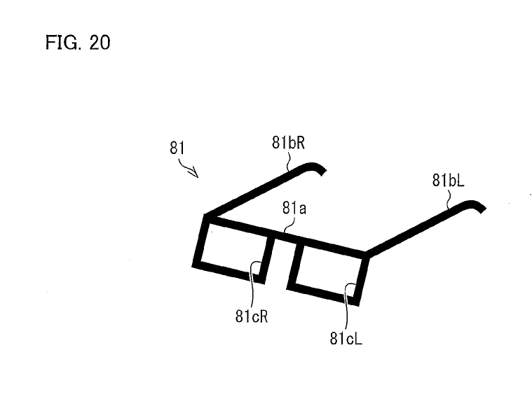

As shown in FIG. 20, the liquid crystal shutter glasses main body 81 includes the frame section 81a and the temples 81bL and 81bR connected with the ends of the frame section 81a, respectively. The left front and the right front of the frame section 81a are equipped with a left-eye opening 81cL and a right-eye opening 81cR, respectively, for securing viewing fields of the eyes of a viewer wearing the liquid crystal shutter glasses main body 81.

The inclination detection section 82 detects the inclination of the liquid crystal shutter glasses main body 81 (i.e. the inclination of the liquid crystal shutter glasses 80), thereby detecting the inclination of the viewer's face wearing the liquid crystal shutter glasses 80. Here, the inclination detection section 82 detects the inclination of the liquid crystal shutter glasses 80 around an axis extending in a front and back direction of the liquid crystal shutter glasses 80, thereby detecting the inclination of the viewer's face around an axis extending in a front and back direction of the face. The inclination detection section 82 includes an acceleration sensor, a gyro sensor or etc.

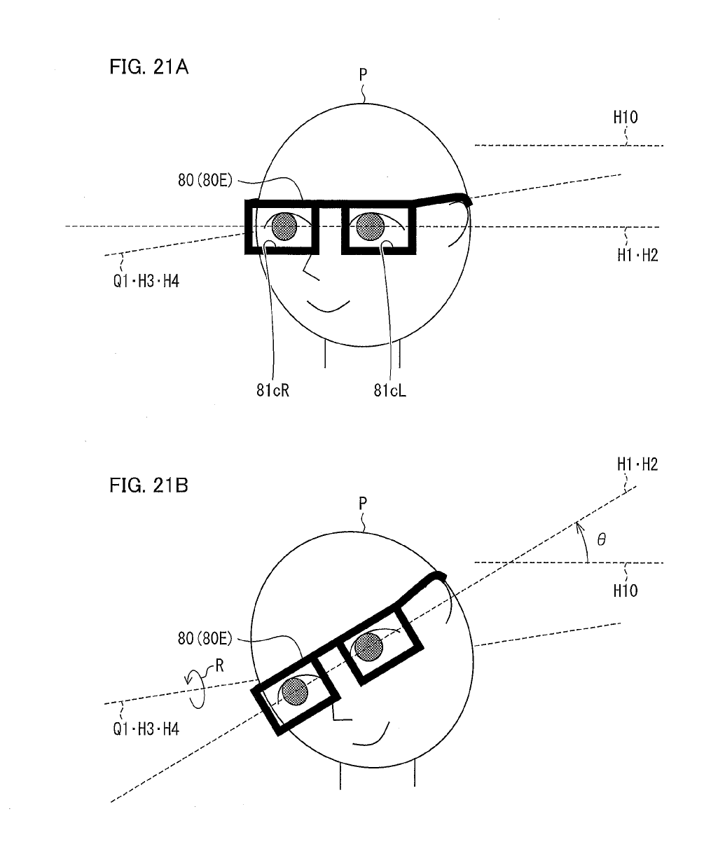

FIGS. 21A and 21B are views showing a relation between the inclination of the liquid crystal shutter glasses 80 and the inclination of a viewer's face P. FIG. 21A shows the relation between the inclination of the liquid crystal shutter glasses 80 and the inclination of a viewer's face P in a case where the viewer's face P is not inclined around an axis Q1 extending in a front and back direction of the face P. FIG. 21B shows the relation between the inclination of the liquid crystal shutter glasses 80 and the inclination of the viewer's face P in a case where the viewer's face P is inclined around an axis Q1 extending in a front and back direction of the face P.

In FIG. 21A, the viewer's face P is not inclined around the axis Q1 extending in a front and back direction H3 of the face P. That is, a left and right direction H1 of the face P (direction aligning the eyes of the viewer) is substantially equal to a horizontal direction H10. A left and right direction H2 of the liquid crystal shutter glasses 80 (direction aligning the openings 81cL and 81cR) and a front and back direction H4 of the liquid crystal shutter glasses 80 are equal to the left and right direction H1 of the viewer's face P and the front and back direction H3 of the viewer's face P. Accordingly, the liquid crystal shutter glasses 80 are not inclined around the axis Q1 extending in the front and back direction H4 of the liquid crystal shutter glasses 80, too. As described above, the inclination of the viewer's face P around the axis Q1 is equal to the inclination of the liquid crystal shutter glasses 80 around the axis Q1. In this state, the inclination detection section 82 detects that the inclination of the liquid crystal shutter glasses 80 around the axis Q1 (herein, the inclination with respect to a horizontal direction 80) is 0° (i.e. the liquid crystal shutter glasses 80 are not inclined around the axis Q1), thereby detecting that the inclination of the viewer's face P around the axis Q1 is 0° (i.e. the viewer's face P is not inclined around the axis Q1).

FIG. 21B shows a state where the viewer's face P is inclined by an angle θ around the axis Q1 from the state shown in FIG. 21A. That is, the left and right direction H1 of the viewer's face P is inclined by the angle θ with respect to the horizontal direction H10. Since the left and right direction H2 and the front and back direction H4 of the liquid crystal shutter glasses 80 are equal to the left and right direction H1 and the front and back direction H3 of the viewer's face P, the liquid crystal shutter glasses 80 are inclined by the angle θ around the axis Q1 toward the same rotational direction as the face P. In this state, the inclination detection section 82 detects that the inclination of the liquid crystal shutter glasses 80 around the axis Q1 is the angle θ, thereby detecting that the inclination of the viewer's face P around the axis Q1 is the angle θ.

As described above, when the inclination of the viewer's face P changes by the angle θ around the axis Q1, the inclination of the liquid crystal shutter glasses 80 changes by the angle θ around the axis Q1 toward the same rotational direction as the face P. Accordingly, the inclination of the viewer's face P around the axis Q1 can be detected by detecting the inclination of the liquid crystal shutter glasses 80 around the axis Q1.

The inclination signal output section 84 outputs, to a later-mentioned inclination signal reception section 71 of the display device 70, an inclination signal S1 which is the detection result from the inclination detection section 82. The inclination signal output section 84 includes, for example, an infrared emitting element capable of outputting infrared or a semiconductor element such as a light emitting diode and a semiconductor laser, and converts the inclination signal S1 into a wireless signal such as infrared and outputs the wireless signal.

In the present embodiment, the inclination signal output section 84 and the inclination signal reception section 71 are connected via wireless communications. Alternatively, the inclination signal output section 84 and the inclination signal reception section 71 may be connected via wiring.

The operation section 85 is a section via which a viewer inputs instructions such as switching between on and off of the power source of the liquid crystal shutter glasses 80.

### (Configuration of Display Device)

The display device 70 displays an image, and changes the inclination of the image in accordance with the inclination signal S1 outputted from the liquid crystal shutter glasses 80. As shown in FIG. 19, the display device 70 includes the inclination signal reception section 71 (first receiving means), an inclination changing section 72 (inclination changing means), a display section 73, and an image output control section 77.

The inclination signal reception section 71 receives the inclination signal S1 outputted from the liquid crystal shutter glasses 80. The inclination signal reception section includes, for example, an infrared receiving element capable of receiving infrared or a semiconductor element capable of receiving an optical signal (wireless signal) from a light emitting diode, a semiconductor laser or etc. The inclination signal reception section 71 converts the inclination signal S1 which is a wireless signal into a signal processable by the inclination changing section 72 (e.g. digital signal), and outputs the signal to the inclination changing section 72.

The image output control section 77 receives an image signal S2 from the outside, converts the image signal S2 into an image signal displayable by the display section 73, and outputs the signal to the display section 73. Further, as mentioned later, in accordance with the control by the inclination changing section 72, the image output control section 77 processes the image signal in such a manner that an image displayed by the display section 73 is inclined, and then outputs the processed image signal to the display section 73, or the image output control section 77 outputs the image signal without processing the image signal so that an image displayed by the display section 73 is not inclined.

The image signal S2 may be supplied via terrestrial broadcasting etc., or supplied from a record reproducing device provided outside, or supplied from services for distributing contents such as real-time broadcastings and movies via the IP (Internet Protocol) network.

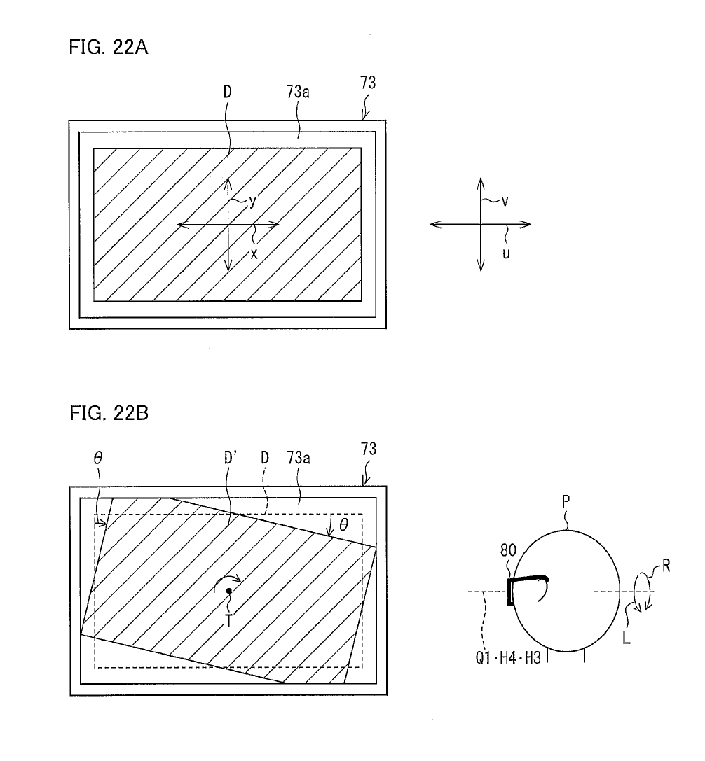

The display section 73 displays an image in accordance with the image signal outputted from the image output control section 77. The display section 73 includes, for example, LCD, PDP, CRT or etc., and includes, for example, a display screen 73a having an oblong rectangular shape as shown in FIG. 22A.

The inclination changing section 72 carries out an image process on the image displayed by the display section 73 in accordance with the inclination signal S1 received by the inclination signal reception section 71, so that the inclination of the image displayed by the display section 73 is changed. Here, the inclination changing section 72 controls the image output control section 77 in order to carry out the image process for changing the inclination of the image displayed by the display section 73.

To be more specific, the inclination changing section 72 detects, based on the inclination signal S1 from the inclination signal reception section 71, the inclination of the viewer's face P around the axis Q1 extending in the front and back direction H3 of the face P (see FIGS. 21A and 21B).

In a case where the result of the detection shows that the viewer's face P is not inclined around the axis Q1 as shown in FIG. 21A, the inclination changing section 72 controls the image output control section 77 to output the image signal to the display section 73 in such a manner that an image D displayed by the display section 73 is not inclined (i.e. the left and right direction x and the up and down direction y of an image surface are substantially equal to the left and right direction u and the up and down direction v of the display screen 73a, respectively) as shown in FIG. 22A.

On the other hand, in a case where the result of the detection shows that the viewer's face P is inclined around the axis Q1, for example, by the angle θ clockwise (in direction indicated by arrow R), the inclination changing section 72 controls the image output control section 77 to process the image signal in such a manner that the image displayed by the display section 73 is inclined by the angle θ around an axis T which is normal to, for example, the center of the image surface toward the same rotational direction (e.g. clockwise) as the inclination of the viewer's face P to be an image D′ as shown in FIG. 22B, and the image output control section 77 outputs the processed image signal to the display section 73.

As described above, the inclination changing section 72 inclines the image displayed by the display section 73 in such a manner that the image is inclined around the axis T normal to the image surface by the same angle θ and toward the same rotational direction as the inclination of the viewer's face P around the axis Q1 so as to be the image D′ shown in FIG. 22B. Consequently, the inclination of the image displayed by the display section 73 around the axis T is always equal to the inclination of the viewer's face P around the axis Q1. Accordingly, even when the viewer inclines the face P around the axis Q1, the viewer can view the image while the image is not inclined with respect to the viewer.

In the present embodiment, the image D′ is inclined by the same angle θ as the inclination of the liquid crystal shutter glasses 80 around the axis Q1. However, the image D′ is not necessarily required to be inclined by the same angle as the inclination of the liquid crystal shutter glasses 80.

As described above, in the present embodiment, the inclination of an image is changed depending on the inclination of a viewer's face. Accordingly, an image can be viewed differently depending on the inclination of the viewer's face. This allows more free expression of images.

The inclination detection section 82 detects the inclination of the liquid crystal shutter glasses 80 around the axis Q1 extending in a front and back direction of the liquid crystal shutter glasses 80, and the inclination changing section 72 inclines an image around the axis T normal to the image surface in accordance with the result of detection by the inclination detection section 82. Accordingly, it is possible to incline the image displayed by the display section 73 around the axis normal to the image surface in accordance with the inclination of the liquid crystal shutter glasses 80 around the axis Q1.

Since the image is inclined in the same rotational direction as the inclination of the liquid crystal shutter glasses 80, the image is inclined in accordance with the inclination of the viewer's face in such a manner that the image does not seem to be inclined with respect to the viewer. This enables the viewer to view the image with higher visibility.

In the present embodiment, the inclination changing section 72 indirectly changes the inclination of an image displayed by the display section 73, by controlling the image output control section 77. Alternatively, the inclination changing section 72 may change the inclination of an image displayed by the display section 73, by directly processing the image signal outputted from the image output control section 77 to the display section 73.

### Modification Example 1

The following explains Modification Example 1 which is a modification example of Embodiment 3.

In Embodiment 3, as shown in FIG. 22B, the image D′ is inclined around the axis T normal to the image surface, but the image D′ is not changed in size. Consequently, there is a case where a periphery of the image D′ is not displayed by a display screen 73a depending on the inclination of the image D′ around the axis T.

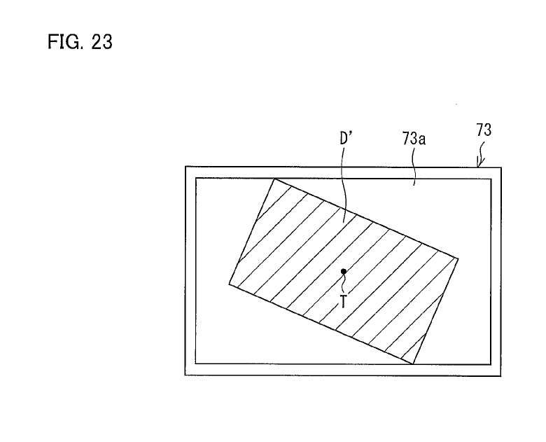

In order to deal with this problem, in the present modification example, as shown in FIG. 23, the image output control section 77, for example, downsizes the image D′ depending on the inclination of the image D′ around the axis T, thereby preventing the periphery of the image D′ from being not displayed by the display screen 73a when the image D′ is inclined around the axis T.

Since the periphery of the image D′ is prevented from being not displayed by the display screen 73a when the image D′ is inclined around the axis T, the viewer can view the image D′ with higher visibility.

In the present modification example, the image D′ is downsized by the image output control section 77. Alternatively, in a case where the inclination changing section 72 directly changes the inclination of an image displayed by the display section 73 through an image process, the image D′ may be downsized by the inclination changing section 72

### Modification Example 2

The following explains Modification Example 2 which is a modification example of Embodiment 3.

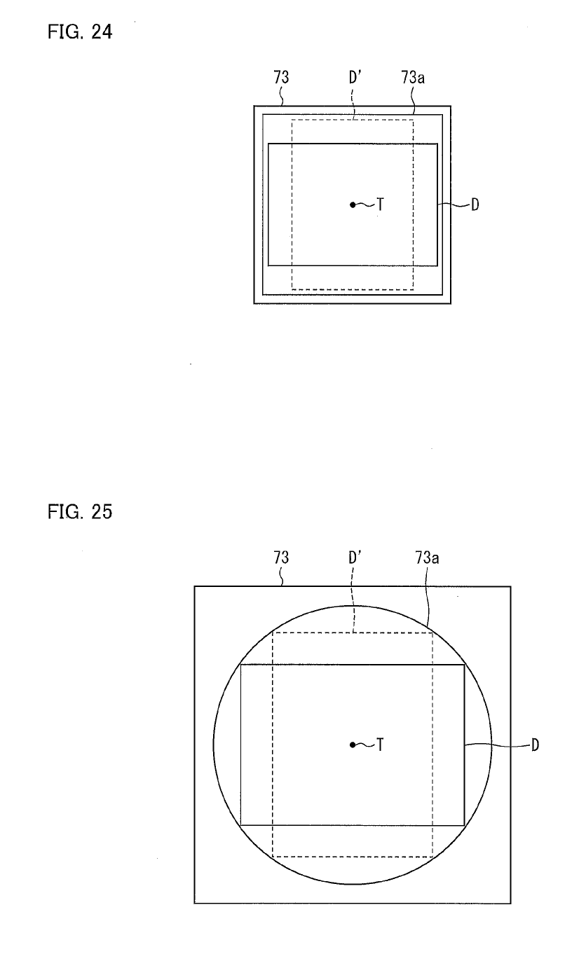

In Embodiment 3, the shape of the display screen 73a of the display section 73 is a rectangle as shown in FIG. 22A. However, the present invention is not limited to this. For example, the shape of the display screen 73a may be a square as shown in FIG. 24 or may be a circle as shown in FIG. 25.

In the case of a square, it is possible to reduce a part of an image D′ which part is not displayed by the display screen 73a when the image D′ is inclined around an axis T normal to the image surface as shown in FIG. 24. In particular, when the image D′ is inclined around by 90° around the axis T as shown in FIG. 24, it is possible to prevent a periphery of the image D′ from being not displayed by the display screen 73a. An image D in FIG. 24 is an image when not inclined around the axis T.

In the case of a circle, it is possible to prevent a periphery of an image D′ from being not displayed by the display screen 73a regardless of by what degrees the image D′ is inclined around an axis T normal to the image surface as shown in FIG. 25. That is, it is possible to prevent the periphery of the image D′ from being not displayed by the display screen 73a without depending on the inclination of the image D′ around the axis T. In FIG. 25, an image D is an image when not inclined around the axis T, and the image D′ is an image when inclined around the axis T by 90°.

### Modification example 3

The following explains Modification Example 3 which is a modification example of Embodiment 3.

In Embodiment 3, the inclination of the image D′ is changed depending on the inclination of the viewer's face P around the axis Q1, whereas in the present modification example, the inclination of an image is changed depending on the inclination of the face around an axis extending in a left and right direction of the viewer's face.

The present modification example is the same as Embodiment 3 except that the inclination detection section 82 and the inclination changing section 72 in Embodiment 3 are modified as follows. Accordingly, in the following description, with reference to FIG. 19, members which are the same as those in Embodiment 3 are given the same reference signs and explanations thereof are omitted, and only different members are explained.

An inclination detection section 82B in the present modification example detects the inclination of the liquid crystal shutter glasses 80 around an axis extending in a left and right direction of the liquid crystal shutter glasses 80 (i.e. left and right direction of a viewer's face), thereby detecting the inclination of the viewer's face around an axis extending in a left and right direction of the viewer's face.

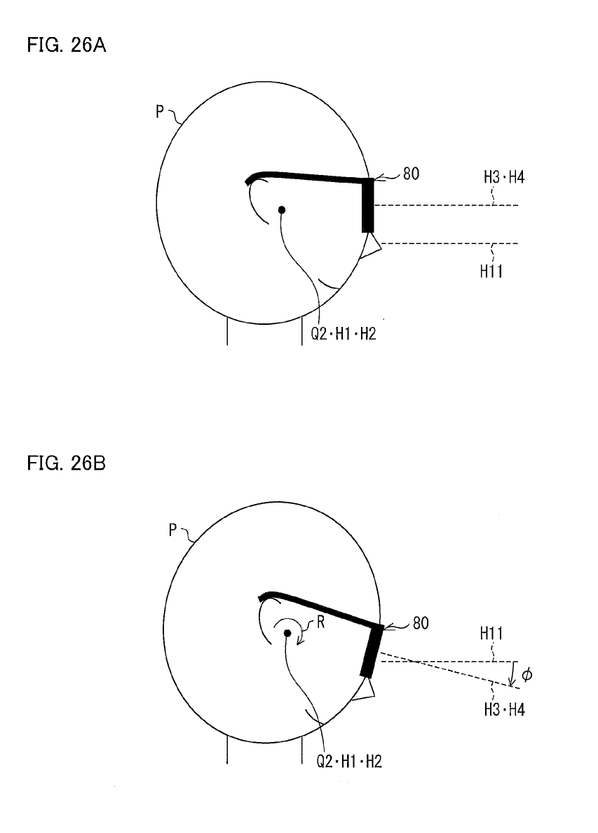

FIGS. 26A and 26B are views showing a relation between the inclination of the liquid crystal shutter glasses 80 and the inclination of a viewer's face P. FIG. 26A shows the relation between the inclination of the liquid crystal shutter glasses 80 and the inclination of a viewer's face P in a case where the viewer's face P is not inclined around an axis Q2 extending in a left and right direction of the face P (axis normal to the surface of the paper). FIG. 26B shows the relation between the inclination of the liquid crystal shutter glasses 80 and the inclination of a viewer's face P in a case where the viewer's face P is inclined around the axis Q2.

In FIG. 26A, the viewer's face P is not inclined around the axis Q2 extending in a left and right direction H1 of the face P. That is, a front and back direction H3 of the face P is substantially equal to a horizontal direction H11. A left and right direction H2 of the liquid crystal shutter glasses 80 (direction aligning the openings 81cL and 81cR) and a front and back direction H4 of the liquid crystal shutter glasses 80 are equal to the left and right direction H1 of the viewer's face P and the front and back direction H3 of the viewer's face P, respectively. Accordingly, the liquid crystal shutter glasses 80 are not inclined around the axis Q2 extending in the left and right direction H2 of the liquid crystal shutter glasses 80, too. As described above, the inclination of the viewer's face P around the axis Q2 is equal to the inclination of the liquid crystal shutter glasses 80 around the axis Q2. In this state, the inclination detection section 82B detects that the inclination of the liquid crystal shutter glasses 80 around the axis Q2 is 0° (i.e. the liquid crystal shutter glasses 80 are not inclined around the axis Q2), thereby detecting that the inclination of the viewer's face P around the axis Q2 is 0° (i.e. the viewer's face P is not inclined around the axis Q2).

FIG. 26B shows a state where the viewer's face P is inclined by an angle φ around the axis Q2 from the state shown in FIG. 26A. That is, the front and back direction H3 of the viewer's face P is inclined by the angle φ with respect to the horizontal direction H11. Since the left and right direction H2 and the front and back direction H4 of the liquid crystal shutter glasses 80 are equal to the left and right direction H1 and the front and back direction H3 of the viewer's face P, respectively, the liquid crystal shutter glasses 80 are inclined by the angle φ around the axis Q2 toward the same rotational direction as the face P. In this state, the inclination detection section 82B detects that the inclination of the liquid crystal shutter glasses 80 around the axis Q2 is the angle φ, thereby detecting that the inclination of the viewer's face P around the axis Q2 is the angle φ.

As described above, when the inclination of the viewer's face P changes by the angle φ around the axis Q2, the inclination of the liquid crystal shutter glasses 80 changes by the angle φ around the axis Q2 toward the same rotational direction as the face P. Accordingly, the inclination of the viewer's face P around the axis Q2 can be detected by detecting the inclination of the liquid crystal shutter glasses 80 around the axis Q2.

The inclination changing section 72B carries out an image process on the image displayed by the display section 73 in accordance with the inclination signal S1 received by the inclination signal reception section 71, so that the inclination of the image displayed by the display section 73 is changed as mentioned later. Here, the inclination changing section 72B controls the image output control section 77 in accordance with the inclination signal S1 in order to carry out the image process for changing the inclination of the image displayed by the display section 73.

To be more specific, the inclination changing section 72B detects, based on the inclination signal S1 from the inclination signal reception section 71, the inclination of the viewer's face P around the axis Q2 extending in the left and right direction H1 of the face P (see FIGS. 26A and 26B).

In a case where the result of the detection shows that the viewer's face P is not inclined around the axis Q2 as shown in FIG. 26A, the inclination changing section 72B controls the image output control section 77 to output the image signal to the display section 73 for display in such a manner that an image D displayed by the display section 73 is not inclined (i.e. the left and right direction x and the up and down direction y of an image surface are substantially equal to the left and right direction u and the up and down direction v of the display screen 73a, respectively) as shown in FIG. 22A.

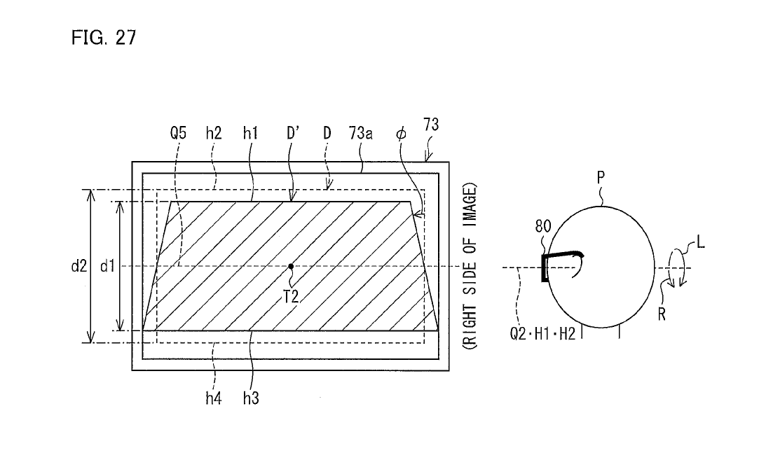

On the other hand, in a case where the result of the detection shows that the viewer's face P is inclined around the axis Q2 by the angle φ clockwise for example (in direction indicated by arrow R), the inclination changing section 72 controls the image output control section 77 to process the image signal in such a manner that the image displayed by the display section 73 is inclined by the angle φ around an axis Q5 which passes through, for example, a center T2 of the image surface and which extends in a left and right direction of the image D′ toward the same rotational direction as the inclination of the viewer's face P (i.e. clockwise when seen from the right side of the image D′ to be an image D′ as shown in FIG. 27, and the image output control section 77 outputs the processed image signal to the display section 73.

In FIG. 27, since an upper side h1 of the image D′ is processed to be seen as if it were positioned farer from the viewer than an upper side h2 of the image D is from the viewer, the upper side h1 is shorter than the upper side h2. Further, since a lower side h3 of the image D′ is processed to be seen as if it were positioned closer to the viewer than a lower side h4 of the image D is to the viewer, the lower side h3 is longer than the lower side h4. Further, since a height d1 of the image D′ is processed to be seen as if it were rotated around the axis Q5, the height d1 is shorter than a height d2 of the image D. Consequently, the image D′ seems to have a trapezoidal outline.

As described above, the inclination changing section 72B carries out an image process on the image displayed by the display section 73 in such a manner that the image is inclined around the axis Q5 extending in a left and right direction of the image surface by the same angle φ and toward the same rotational direction as the inclination of the viewer's face P around the axis Q2 so as to be the image D′ shown in FIG. 27. Consequently, the inclination of the image displayed by the display section 73 around the axis Q5 is virtually equal to the inclination of the viewer's face P around the axis Q2. Accordingly, even when the viewer inclines the face P around the axis Q2, the viewer can view the image while the image is not inclined virtually with respect to the viewer.

As described above, with the present modification example, the inclination detection section 82B detects the inclination of the liquid crystal shutter glasses 80 around the axis Q2 extending in a left and right direction of the liquid crystal shutter glasses 80, and the inclination changing section 72B processes, in accordance with the result of detection by the inclination detection section 82B, the image in such a manner that the image seems to be inclined around the axis Q5 extending in a left and right direction of the image surface. Accordingly, it is possible to virtually incline the image displayed by the display section around the axis Q5 extending in the left and right direction of the image surface, in accordance with the inclination of the liquid crystal shutter glasses 80 around the axis Q2.

Since the image is inclined in the same rotational direction as the liquid crystal shutter glasses 80, the inclination of the image is changed in accordance with the inclination of the viewer's face so that the image virtually seems as it were not inclined with respect to the viewer. This enables the viewer to view the image with higher visibility.

### Modification Example 4

The following explains Modification Example 4 which is a modification example of Embodiment 3.

In Embodiment 3, the inclination of the image is changed depending on the inclination of the viewer's face P around the axis Q1, whereas in the present modification example, the inclination of an image is changed depending on the waggle of the viewer's face P around an axis extending in an up and down direction of the viewer's face P.

The present modification example is the same as Embodiment 3 shown in FIG. 19 except that the inclination detection section 82 and the inclination changing section 72 in Embodiment 3 are modified as follows. Accordingly, in the following description, with reference to FIG. 19, members which are the same as those in Embodiment 3 are given the same reference signs and explanations thereof are omitted, and only different members are explained.

An inclination detection section 82C detects the inclination of the liquid crystal shutter glasses 80 around an axis extending in an up and down direction of the liquid crystal shutter glasses 80 (i.e. up and down direction of a viewer's face), thereby detecting the inclination of the viewer's face around an axis extending in an up and down direction of the viewer's face.

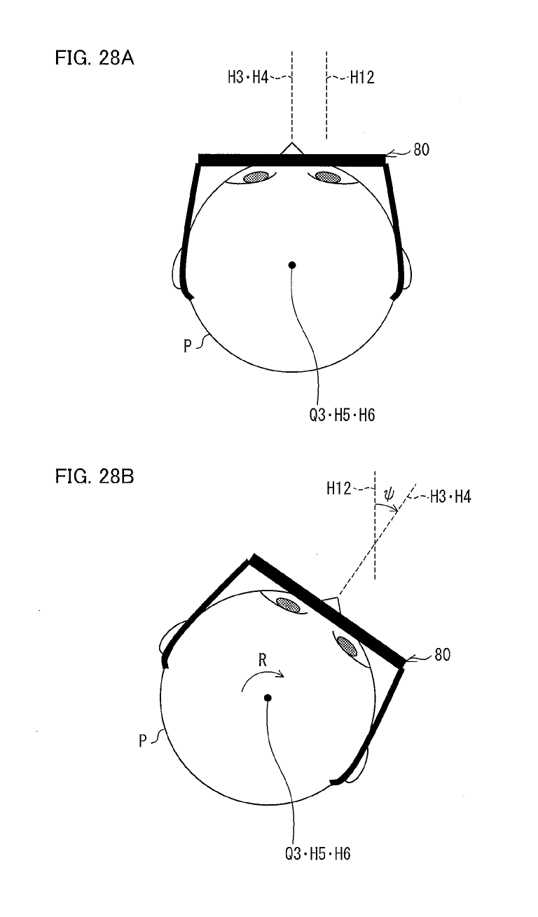

FIGS. 28A and 28B are views showing a relation between the inclination of the liquid crystal shutter glasses 80 and the inclination of a viewer's face P. FIG. 28A shows the relation between the inclination of the liquid crystal shutter glasses 80 and the inclination of a viewer's face P in a case where the viewer's face P does not waggle around an axis Q3 extending in an up and down direction of the face P (axis normal to the surface of the paper). FIG. 28B shows the relation between the inclination of the liquid crystal shutter glasses 80 and the inclination of the viewer's face P in a case where the viewer's face P waggles around the axis Q3. FIGS. 28A and 28B are views showing the viewer's face P seen from the above.

In FIG. 26A, the viewer's face P faces in a certain reference direction H12. That is, a front and back direction H3 of the face P is substantially equal to the reference direction H12. An up and down direction H6 and a front and back direction H4 of the liquid crystal shutter glasses 80 are substantially equal to an up and down direction H5 and a front and back direction H3 of the viewer's face P, respectively. Accordingly, a front and back direction H4 of the liquid crystal shutter glasses 80 is substantially equal to the reference direction H12, too. As described above, the inclination of the viewer's face P around the axis Q3 is equal to the inclination of the liquid crystal shutter glasses 80 around the axis Q3.

In this state, the inclination detection section 82C detects that the angle formed by the front and back direction H4 of the liquid crystal shutter glasses 80 and the reference direction H12 is 0° (i.e. the liquid crystal shutter glasses 80 do not waggle around the axis Q3 from the reference direction H12), thereby detecting that the viewer's face P does not waggle around the axis Q3 from the reference direction H12.

FIG. 28B shows a state where the viewer's face P waggles around the axis Q3, for example, by an angle ψ clockwise. That is, the front and back direction H3 of the viewer's face P waggles from the reference direction H12, for example, by the angle ψ clockwise. Since the up and down direction H6 and the front and back direction H4 of the liquid crystal shutter glasses 80 are equal to the up and down direction H5 and the front and back direction H3 of the viewer's face P, the liquid crystal shutter glasses 80 waggle around the axis Q3 by the angle ψ toward the same rotational direction as the face P.

In this state, the inclination detection section 82C detects that the liquid crystal shutter glasses 80 waggle around the axis Q3 from the reference direction H12, for example, by the angle ψ clockwise, thereby detecting that the viewer's face P waggles around the axis Q3 from the reference direction H12, for example, by the angle ψ clockwise.

As described above, when the viewer's face P is inclined around the axis Q3 from the reference direction H12 by the angle ψ, the liquid crystal shutter glasses 80 are inclined around the axis Q3 from the reference direction H12 by the angle ψ in the same rotational direction. Accordingly, it is possible to detect the inclination of the viewer's face P around the axis Q3 by detecting the inclination of the liquid crystal shutter glasses 80 around the axis Q3.

The reference direction H12 is set, for example, in such a manner that a viewer wearing the liquid crystal shutter glasses 80 operates the operation section 85 of the liquid crystal shutter glasses 80 while facing in a desired direction so as to reset a detection value detected by the inclination detection section 82C. This enables the inclination detection section 32C to detect waggle of the viewer's face P around the axis Q3 from the desired direction. That is, the desired direction is set to the reference direction H12.

In the present modification example, the reference direction H12 is set to a direction toward the display section 73. However, the present invention is not limited to this case.

The inclination changing section 72C in the present modification example carries out an image process on the image displayed by the display section 73 in accordance with the inclination signal S1 received by the inclination signal reception section 71, so that the inclination of the image displayed by the display section 73 is changed. Here, the inclination changing section 72C controls the image output control section 77 in accordance with the inclination signal S1 in order to carry out the image process for changing the inclination of the image displayed by the display section 73.

To be more specific, the inclination changing section 72C detects, based on the inclination signal S1 from the inclination signal reception section 71, the waggle of the viewer's face P around the axis Q3 from the reference direction H12.

In a case where the result of the detection shows that the viewer's face P does not waggle around the axis Q3 from the reference direction H12 as shown in FIG. 28A, the inclination changing section 72C controls the image output control section 77 to output the image signal to the display section 73 in such a manner that an image D displayed by the display section 73 is not inclined (i.e. the up and down direction y and the left and right direction x of the image D are substantially equal to the up and down direction v and the left and right direction u of the display screen 73a, respectively) as shown in FIG. 22A.

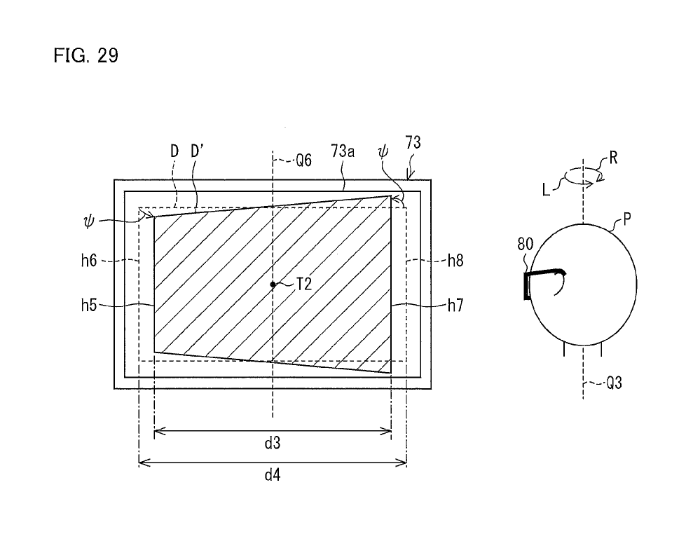

On the other hand, in a case where the result of the detection shows that the viewer's face P is inclined around the axis Q3, for example, by the angle ψ clockwise (in direction indicated by arrow R) when seem from the above, the inclination changing section 72C controls the image output control section 77 to process the image signal in such a manner that the image displayed by the display section 73 seems to waggle around the axis Q6 which passes through, for example, a center T2 of the image surface and which extends in an up and down direction of the image D′ by the same angle ψ and in the same rotational direction (e.g. clockwise) as the waggle of the viewer's face P so as to be the image D′ as shown in FIG. 29, and the image output control section 77 outputs the processed image signal to the display section 73.

In FIG. 29, since a left side h5 of the image D′ is processed to be seen as if it were positioned farer from the viewer than a left side h6 of the image D is from the viewer, the left side h5 is shorter than the left side h6. Further, since a right side h7 of the image D′ is processed to be seen as if it were positioned closer to the viewer than a right side h8 of the image D is to the viewer, the right side h7 is longer than the right side h8. Further, since a width d3 of the image D′ is processed to be seen as if it were rotated around the axis Q6, the width d3 is shorter than a width d4 of the image D. Consequently, the image D′ in FIG. 29 seems to have a trapezoidal outline whose upper base is the left side h5 and whose lower base is the right side h7.

As described above, the inclination changing section 72C processes the image displayed by the display section 73 in such a manner that the image seems to waggle around the axis Q6 extending in an up and down direction of the image surface by the same angle ψ and in the same rotational direction as the waggle of the viewer's face P so as to be an image D′ as shown in FIG. 29. Consequently, the inclination of the image displayed by the display section 73 around the axis Q6 is virtually equal to the inclination of the viewer's face P around the axis Q3. Accordingly, even when the viewer inclines the face P around the axis Q3 from the reference direction H12, the viewer can view the image while the image is not inclined virtually with respect to the viewer.

Since the image is inclined in the same rotational direction as the liquid crystal shutter glasses 80, the inclination of the image is changed in accordance with the inclination of the viewer's face so that the image virtually seems as if it faced the viewer squarely. This enables the viewer to view the image with higher visibility.

### Modification Example 5

The following explains a modification example which is a modification example of Embodiment 3.

In Embodiment 3, the image D is inclined around the axis T thereof by the same angle θ as the inclination of the viewer's face P around the axis Q1 to be the image D′, whereas in the present modification example, the image D is inclined around the axis T greater as the viewer's face P is inclined around the axis Q1 faster.

The present modification example is the same as the Modification Example 3 except that the inclination changing section 72 is modified as follows. The present modification example is explained below with reference to FIGS. 19 and 22B.

In accordance with the inclination signal S1 received by the inclination signal reception section 71, the inclination changing section 72 in the present modification example calculates a rate of change in the inclination of the liquid crystal shutter glasses 80 around the axis Q1 extending in a front and back direction of the liquid crystal shutter glasses 80, and changes the inclination of the image D′ displayed by the display section 73 around the axis T more greatly as the rate of change is larger.

Here, the inclination changing section 72 controls the image output section 77 to change the inclination of the image D′ displayed by the display section 73 around the axis T more greatly as the rate of change is larger.

Consequently, with respect to a certain amount of change in inclination of the liquid crystal shutter glasses 80 around the axis Q1, a larger rate in change in inclination of the liquid crystal shutter glasses 80 around the axis Q1 results in a greater amount of change in inclination of the image D′ around the axis T.

As described above, the inclination of the image D′ around the axis T is greater as the viewer's face P is inclined around the axis Q1 faster. This enables a viewer to view the image D′ with higher realistic sensation.

In the present modification example, the image D′ is not necessarily inclined around the axis T by the same angle as the viewer's face P is inclined around the axis Q1.

The present modification example is applied to Embodiment 3. Alternatively, the present modification example may be applied to other modification examples mentioned above (e.g. Modification Examples 3 and 4).

### Embodiment 4

In Embodiment 3, the inclination of the image displayed by the display section 73 is changed by processing the image, whereas in the present embodiment, the inclination of the image displayed by the display section 73 is changed by changing the inclination of the display section 73.

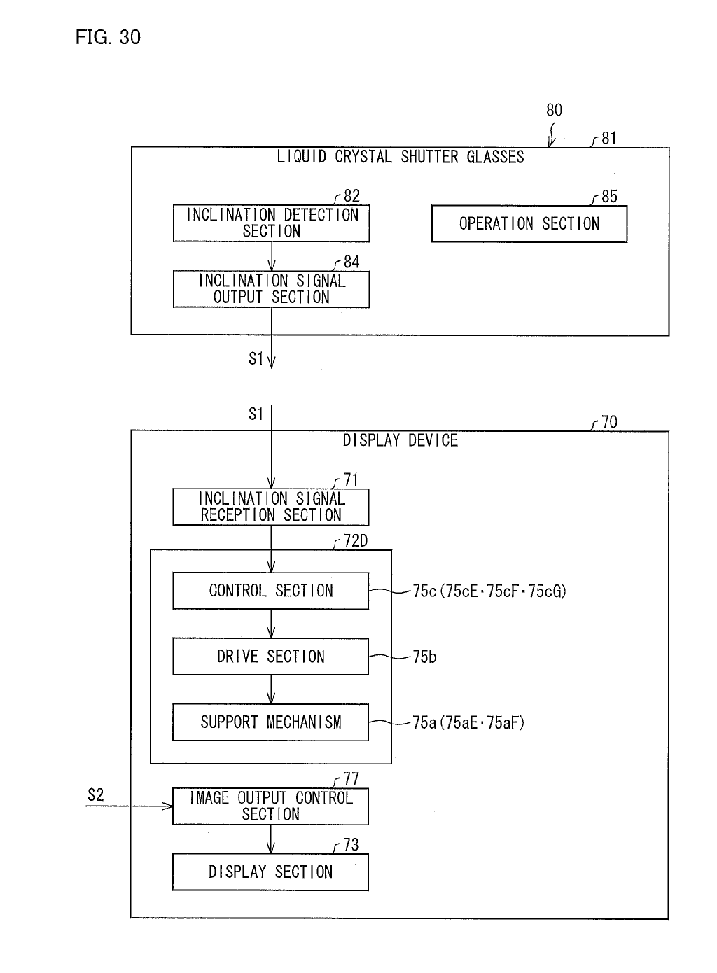

The present embodiment is the same as Embodiment 3 except that the inclination changing section 72 of the display device 70 is modified as follows. Accordingly, in the following descriptions, with reference to FIG. 30, members which are the same as those in Embodiment 3 are given the same reference signs and explanations thereof are omitted here, and only different members are explained.

In the present embodiment, an image displayed by the display section 73 is never inclined with respect to the display screen 73a like the image D in FIG. 22A.

As shown in FIG. 30, an inclination changing section 72D in accordance with the present embodiment includes a support mechanism 75a, a driving section 75b (driving means), and a control section 75c (first control means).

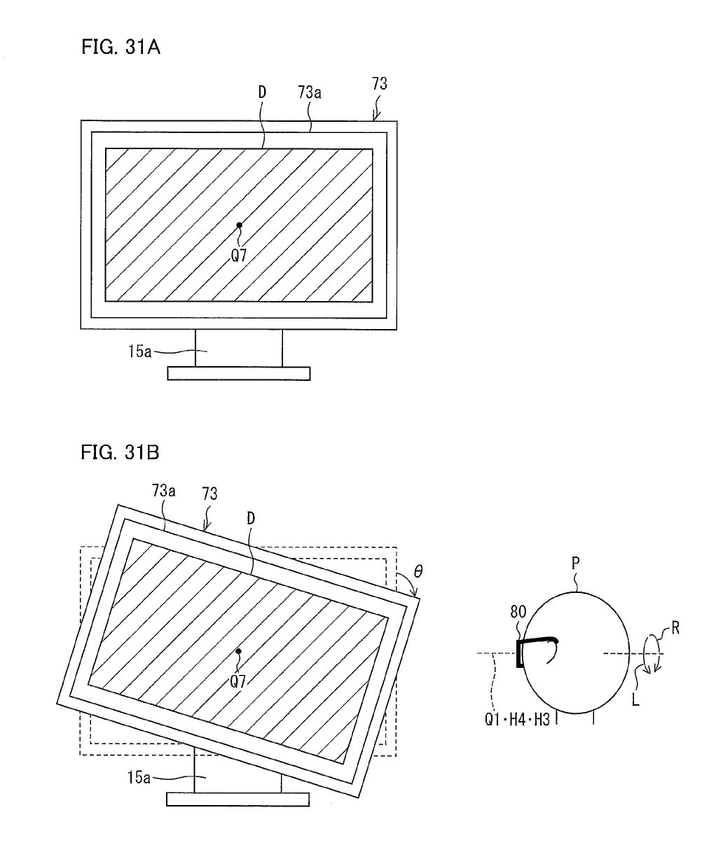

The support mechanism 75a supports the display section 73 in such a manner that the display section 73 can be inclined freely. Here, as shown in FIG. 31B, the support mechanism 75a supports the display section 73 in such a manner that the display section 73 is rotatable around an axis Q7 which is normal to, for example, the center of the display screen 73a. Further, the support mechanism 75a supports the display section 73 in such a manner that the display screen 73a of the display section 73 is substantially vertical.

Under control of the control section 75c, the driving section 75b drives the support mechanism 75a in such a manner that the display section 73 rotates around the axis Q7.

The control section 75c controls the driving section 75b in accordance with the inclination signal S1 received by the inclination signal reception section 71, thereby inclining the display section 73 around the axis Q7. Thus, an image displayed by the display section 73 is inclined around the axis Q7.

To be more specific, the control section 75c detects, in accordance with the inclination signal S1, the inclination of the viewer's face P around the axis Q1 extending in the front and back direction H3 of the viewer's face P (see FIGS. 21A and 21B).

In a case where the result of the detection shows that the viewer's face P is not inclined around the axis Q1 as shown in FIG. 21A, the control section 75c controls the driving section 75b in such a manner that the display section 73 is not inclined around the axis Q7 (i.e. a left and right direction of the display section 73 is substantially equal to a horizontal direction) as shown in FIG. 31A.

On the other hand, in a case where the result of the detection shows that the viewer's face P is inclined around the axis Q1, for example, by an angle θ clockwise (in direction indicated by arrow R), the control section 75c controls the driving section 75b in such a manner that the display section 73 is inclined around the axis Q7 by the angle θ in the same direction as the inclination of the viewer's face P (e.g. clockwise).

As described above, the control section 75c controls the driving section 75b so as to incline the display section 73 around the axis Q7 by the same angle and in the same direction as the inclination of the viewer's face P around the axis Q1. Accordingly, the inclination of the image displayed by the display section 73 around the axis Q7 is always equal to the inclination of the viewer's face around the axis Q1. This enables the viewer to view the image in such a manner that the image is not inclined with respect to the viewer even when the viewer's face is inclined around the axis Q1.

Further, since the inclination of the image is changed by changing the inclination of the display section 73, the inclination of the image is changed in a real space. This enables the viewer to view the image whose inclination has been changed with higher visibility.

Also in the present embodiment, the inclination of an image is changed depending on the inclination of the viewer's face. This enables a viewer to view an image differently depending on the inclination of the viewer's face.

That is, it is possible to express the image more freely.

### Modification Example 1

The following explains Modification Example 1 which is a modification example of Embodiment 4.

Embodiment 4 is obtained by applying the technique of inclining the display section 73 to Embodiment 3 (i.e. inclination of the display section 73 is changed in accordance with inclination of the viewer's face around the axis Q1 extending in a front and back direction of the viewer's face), whereas the present modification example is obtained by applying Embodiment 4 to the Modification Example 3 of Embodiment 3 (i.e. inclination of the display section 73 is changed in accordance with inclination of the viewer's face around the axis Q2 extending in a left and right direction of the viewer's face).

In the following, with reference to FIG. 30, members which are the same as those in Embodiment 4 are given the same reference signs and explanations thereof are omitted here, and only different members are explained.

The liquid crystal shutter glasses 80 in the present modification example are the same as the liquid crystal shutter glasses 80 in the Modification Example 3 of Embodiment 3, and detects the inclination of the liquid crystal shutter glasses 80 around the axis Q2 extending in a left and right direction of the liquid crystal shutter glasses 80, thereby detecting the inclination of the viewer's face P around the axis Q2 as shown in FIGS. 26A and 26B.

The display device 70 in the present modification example is the same as the display device 70 in Embodiment 4 except that the support mechanism 75a and the control section 75c are modified as follows.

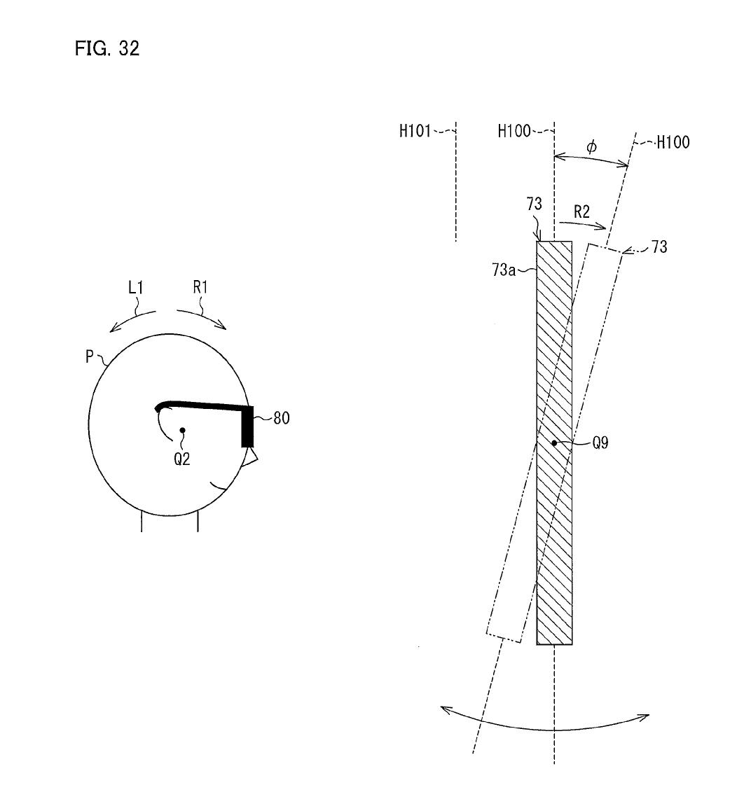

A support mechanism 75aE in the present modification example supports the display section 73 in such a manner that the display section 73 is rotatable around an axis Q9 which passes through, for example, the center of the display section 73 in the up and down direction thereof and which extends in the left and right direction of the display section 73 (see FIG. 32). FIG. 32 is a view showing the right side of the display section 73.

In accordance with an inclination signal S1 received by the inclination signal reception section 71, the control section 75cE in the present modification example detects the inclination of the viewer's face P around the axis Q2 extending in the left and right direction H1 of the viewer's face P (see FIGS. 26A and 26B).

In a case where the result of the detection shows that the viewer's face P is not inclined around the axis Q2 as shown in FIG. 26A, the control section 75cE controls the driving section 75b in such a manner that the display section 73 is not inclined around the axis Q9 (e.g. an up and down direction H100 of the display section 73 is substantially equal to a normal direction H101 thereof) as shown in FIG. 32.

On the other hand, in a case where the result of the detection shows that the viewer's face P is inclined around the axis Q2, for example, by an angle θ clockwise on the paper as shown by an arrow R1 in FIG. 32, the control section 75cE controls the driving section 75b in such a manner that the display section 73 is inclined around the axis Q9 by the angle φ in the same direction (herein, clockwise) as the inclination of the viewer's face P around the axis Q2.

As described above, the control section 75cE controls the driving section 75b so as to incline the display section 73 around the axis Q9 by the same angle and in the same direction as the inclination of the viewer's face P around the axis Q2. Accordingly, the inclination of the image displayed by the display section 73 around the axis Q9 is always equal to the inclination of the viewer's face around the axis Q2. This enables the viewer to view the image in such a manner that the image is not inclined with respect to the viewer even when the viewer's face is inclined around the axis Q2.

### Modification Example 2

The following explains Modification Example 2 which is a modification example of Embodiment 4.

Embodiment 4 is obtained by applying the technique of inclining the display section 73 to Embodiment 3 (i.e. inclination of the display section 73 is changed in accordance with inclination of the viewer's face around the axis Q1 extending in a front and back direction of the viewer's face), whereas the present modification example is obtained by applying Embodiment 4 to the Modification Example 4 of Embodiment 3 (i.e. inclination of the display section 73 is changed in accordance with inclination of the viewer's face around the axis Q3 extending in an up and down direction of the viewer's face).

In the following, with reference to FIG. 30, members which are the same as those in Embodiment 4 are given the same reference signs and explanations thereof are omitted here, and only different members are explained.

The liquid crystal shutter glasses 80 in the present modification example are the same as the liquid crystal shutter glasses 80 in the Modification Example 4 of Embodiment 3, and detects the waggle ψ of the liquid crystal shutter glasses 80 around the axis Q3 of the liquid crystal shutter glasses 80 from the reference direction H12, thereby detecting the waggle ψ of the viewer's face P around the axis Q3 from the reference direction H12.

The display device 70 in the present modification example is the same as the display device 70 in Embodiment 4 except that the support mechanism 75a and the control section 75c are modified as follows.

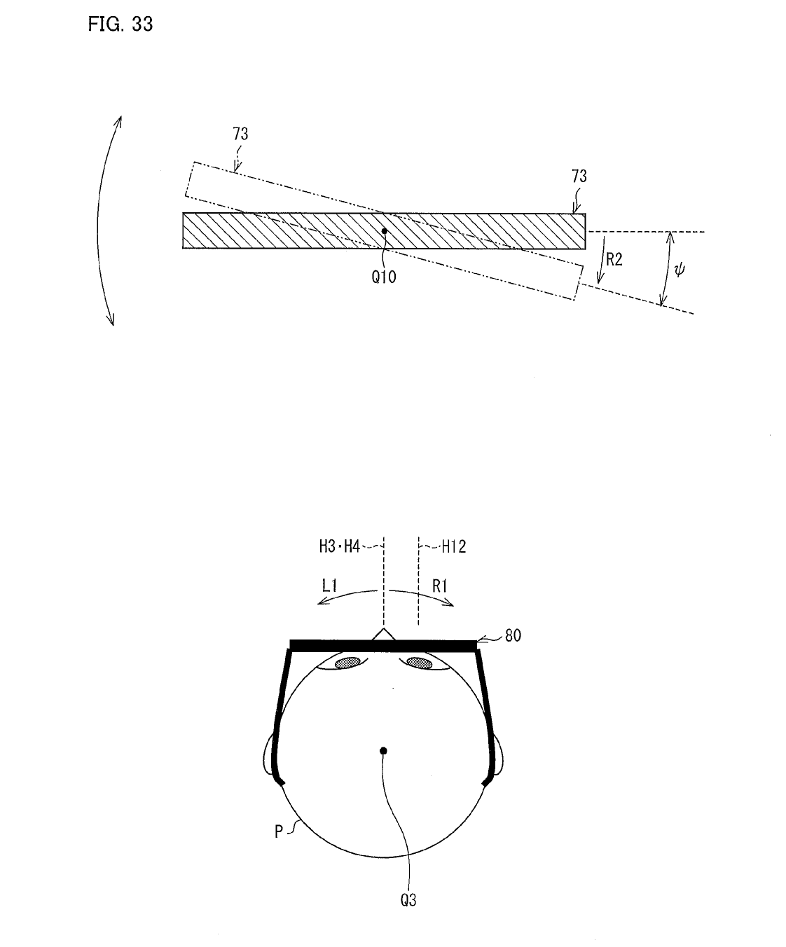

A support mechanism 75aF in the present modification example supports the display section 73 in such a manner that the display section 73 is rotatable around an axis Q10 which passes through, for example, the center of the display section 73 in the left and right direction thereof and which extends in the up and down direction of the display section 73 as shown in FIG. 33. FIG. 33 is a view showing the viewer's face P and the display section 73 from above.

In accordance with an inclination signal S1 received by the inclination signal reception section 71, the control section 75cF in the present modification example detects the waggle of the viewer's face P around the axis Q3 from the reference direction H12 as shown in FIGS. 28A and 28B

In a case where the result of the detection shows that the viewer's face P does not waggle around the axis Q3 from the reference direction H12, the control section 75cF controls the driving section 75b in such a manner that the inclination of the display section 73 around the axis Q10 is not changed as shown in FIG. 33. The display section 73 is initially inclined around the axis Q10 toward a direction of a viewer.

On the other hand, in a case where the result of the detection shows that the viewer's face P waggles around the axis Q3, for example, by the angle ψ clockwise from the reference direction H12 as shown by an arrow R1 in FIG. 33, the control section 75cF controls the driving section 75b in such a manner that the display section 73 waggles around the axis Q10 by the angle ψ in the same direction (herein, clockwise) as the waggle of the viewer's face P around the axis Q3.

As described above, the control section 75cF controls the driving section 75b so as to waggle the display section 73 around the axis Q10 (i.e. an image displayed by the display section 73 around the axis Q10) by the same angle and in the same direction as the waggle of the viewer's face P around the axis Q3. Accordingly, the inclination of the image displayed by the display section 73 around the axis Q10 is always equal to the inclination of the viewer's face P around the axis Q3. This enables the viewer to view the image in such a manner that the image is not waggled with respect to the viewer even when the viewer's face waggles around the axis Q3.

### Modification Example 3

The following explains Modification Example 3 which is a modification example of Embodiment 4.

In Embodiment 4, the display section 73 is inclined around the axis Q7 (see FIG. 31B) by the same angle and in the same direction as the inclination of the viewer's face P around the axis Q1, whereas in the present modification example, the display section 73 is inclined around the axis Q7 larger as the viewer's face P is inclined around the axis Q1 faster.

The present modification example is the same as Embodiment 4 except that the control section 75c is modified as follows. The present modification example is explained below with reference to FIG. 30.

In accordance with an inclination signal S1 received by the inclination signal reception section 71, a control section 75cG in the present modification example detects the rate of change in the inclination of the liquid crystal shutter glasses 80 around the axis Q1 extending in the front and back direction of the liquid crystal shutter glasses 80 (see FIGS. 21A and 21B), and as the rate of change is larger, the display section 73 is inclined around the axis Q7 (see FIG. 31B) larger.

As described above, as the viewer's face P is inclined around the axis Q1 faster, the display section 73 (i.e. image displayed by the display section 73) is inclined around the axis Q7 larger. This enables the viewer to view the image with greater realistic sensation.

In the present modification example, the display section 73 is not necessarily inclined around the axis Q7 by the same angle and in the same direction as the inclination of the viewer's face P around the axis Q1.

In the above description, the present modification example was applied to Embodiment 4. Alternatively, the present modification example may be applied to other modification examples (e.g. Modification Examples 1 and 2) of Embodiment 4.

### Embodiment 5

In Embodiment 3, there is provided only a pair of liquid crystal shutter glasses 80, whereas in the present embodiment, there are provided plural pairs of liquid crystal shutter glasses.

That is, in the present embodiment, a plurality of viewers wearing liquid crystal shutter glasses view simultaneously an image displayed by a display section. At that time, when a viewer wearing liquid crystal shutter glasses selected by a manual operation inclines his/her face, the image displayed by the display section is inclined accordingly.

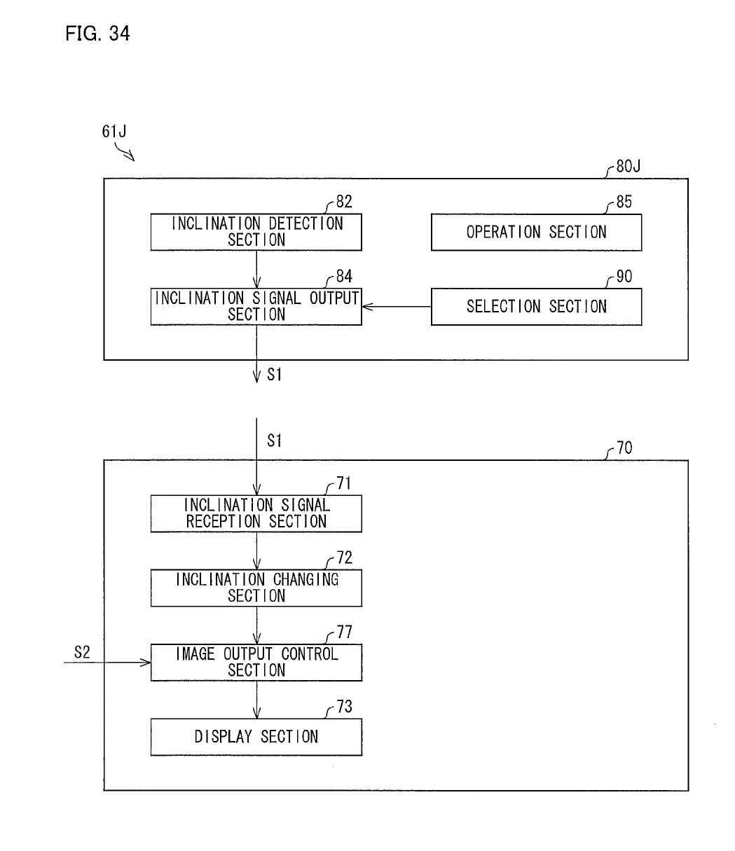

In the following, with reference to FIG. 34, members which are the same as those in Embodiment 3 are given the same reference signs and explanations thereof are omitted, and only different members are explained.

As shown in FIG. 34, a display control system 61J in accordance with the present embodiment includes a display device 70 for displaying an image and plural pairs of liquid crystal shutter glasses 80J wearable by viewers. For convenience of explanation, the following explains a case where there are provided three pairs of liquid crystal shutter glasses 80J. However, the number of pairs of liquid crystal shutter glasses 80J in the present embodiment is not limited to three.

### (Configuration of Liquid Crystal Shutter Glasses)

The liquid crystal shutter glasses 80J are obtained by modifying the liquid crystal shutter glasses 80 in accordance with Embodiment 3 (see FIG. 19) to further include a selection section 90 (selection means). The selection section 90 has a function of selecting liquid crystal shutter glasses for which an image displayed by the display section 73 of the display device 70 is to be inclined. It is desirable that the selection section 90 is included as a part of an operation section 85 in the liquid crystal shutter glasses 80J so as to serve as a switch by which, for example, a viewer can switch the liquid crystal shutter glasses 80 between an on-state and an off-state.

When the viewer wants to cause the display 73 to display an image whose inclination corresponds to the inclination of the viewer, the viewer puts the selection section 90 in the on-state. The liquid crystal shutter glasses 80J whose selection section 90 is in the on-state detects the inclination thereof by using an inclination detection section 82, and transmits an inclination signal S1 to the display device 70 via an inclination signal output section 84. In accordance with the received inclination signal S1, the display device 70 changes the inclination of the image by the process described in Embodiment 3 and modification examples 1 to 5 thereof or Embodiment 4 and modification examples 1 to 3 thereof.

The number of liquid crystal shutter glasses selected as glasses for which the inclination of an image is to be changed (hereinafter merely referred to as “selected” in Embodiment 5) is 1 or 0. In a case of 0, the inclination of an image displayed by the display section 73 is not changed.

In order to prevent selection sections 90 of two or more pairs of the liquid crystal shutter glasses 80J from being put in the on-state, plural pairs of the liquid crystal shutter glasses 80J may always monitor the states of the selection sections 90 of other liquid crystal shutter glasses 80J so as to control the selection sections 90 in such a manner that the selection sections 90 of the liquid crystal shutter glasses 80 other than the one whose selection section 90 is put in the on-state lastly are put in the off-state.

In this case, each pair of the liquid crystal shutter glasses 80J includes a transmission/reception section for transmitting/receiving, to/from other pairs of the liquid crystal shutter glasses 80J, a signal indicative of whether the selection section 90 of the liquid crystal shutter glasses 80J is in the on-state or the off-state. In accordance with the signal received by the transmission/reception section, each pair of the liquid crystal shutter glasses 80J monitors whether the selection sections 90 of other liquid crystal shutter glasses 80J are in the on-state or the off-state, and controls the selection section 90 as above based on the result of the monitoring.

Alternatively, out of inclination signals S1 received by the inclination signal reception section 71 from plural pairs of the liquid crystal shutter glasses 80J, only an inclination signal S1 received lastly may be transmitted to the inclination changing section 72.

### Modification Example 1

The following explains Modification Example 1 which is a modification example of Embodiment 5.

In Embodiment 5, the selection section 90 is included in the liquid crystal shutter glasses 80, whereas in the present modification example, a selection section is included in a display device, and selection of an image is made inside the display device.

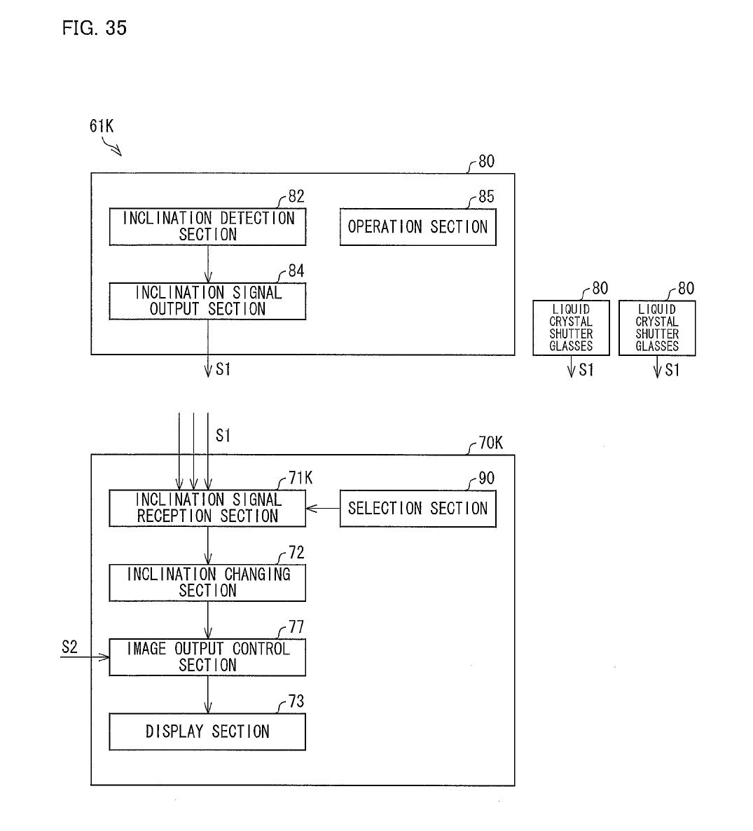

With reference to FIG. 35, the following explains a display control system 61K in the present modification example. In the following, members which are the same as those in Embodiments 3 to 5 are given the same reference signs and explanations thereof are omitted, and only members different from those in Embodiments 3 to 5 are explained.

### (Configuration of Liquid Crystal Shutter Glasses)

In the present modification example, as shown in FIG. 35, each pair of liquid crystal shutter glasses 80 is the same as the liquid crystal shutter glasses 80 in accordance with Embodiment 3.

### (Configuration of Display Device)

In the present modification example, as shown in FIG. 35, a display device 70K is obtained by modifying the display device 70 in Embodiment 5 to further include a selection section 90 (selection means). For example, a viewer selects a pair of liquid crystal shutter glasses for which an image displayed by the display device 70K is to be inclined out of plural pairs of liquid crystal shutter glasses 80, and inputs selection information via the selection section 90. The selection section 90 transmits the selection information to the inclination signal reception section 71K.

In the present modification example, the inclination signal reception section 71K transmits, out of inclination signals S1 from the plural pairs of liquid crystal shutter glasses 80, only an inclination signal S1 of the liquid crystal shutter glasses indicated by the selection information to the inclination changing section 72. The inclination changing section 72 changes the inclination of an image.

### Embodiment 6

In Embodiment 3, there is provided only a pair of liquid crystal shutter glasses 80, whereas in the present embodiment, there are provided plural pairs of liquid crystal shutter glasses.

That is, in the present embodiment, a plurality of viewers wearing liquid crystal shutter glasses view simultaneously an image displayed by a display section. At that time, when a viewer wearing liquid crystal shutter glasses inclines his/her face, only an image viewed by the viewer is inclined accordingly.

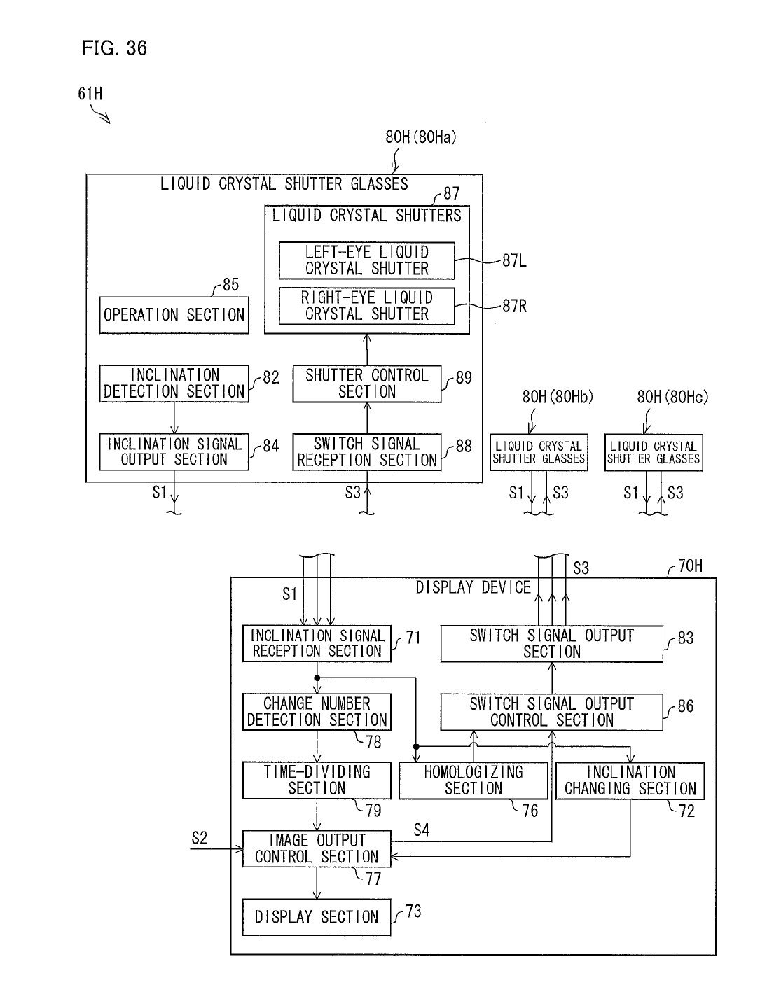

In the following, with reference to FIG. 36, members which are the same as those in Embodiment 3 are given the same reference signs and explanations thereof are omitted, and only different members are explained.

As shown in FIG. 36, a display control system 61H in accordance with the present embodiment includes a display device 70H for displaying an image and plural pairs of liquid crystal shutter glasses 80H wearable by viewers. For convenience of explanation, the following explains a case where there are provided three pairs of liquid crystal shutter glasses 80H. However, the number of pairs of liquid crystal shutter glasses 80H in the present embodiment is not limited to three.

### (Configuration of Liquid Crystal Shutter Glasses)

The liquid crystal shutter glasses 80H are obtained by modifying the liquid crystal shutter glasses 80 in Embodiment 3 (see FIG. 19) to further include liquid crystal shutters 87 (opening and closing means), a switch signal reception section 88 (second reception means), and a shutter control section 89 (second control means).

The liquid crystal shutters 87 are for opening and closing the liquid crystal shutter glasses 80H, and include a left-eye liquid crystal shutter 87L and a right-eye liquid crystal shutter 87R.

The left-eye liquid crystal shutter 87L is provided at a left-eye opening section 81cL (see FIG. 20) of a frame section 81a of the liquid crystal shutter glasses 80H, and opens and closes the view of the left-eye opening section 81cL in accordance with whether the left-eye liquid crystal shutter 87L is in a transparent state or a light-shielding state. The right-eye liquid crystal shutter 87R is provided at a right-eye opening section 81cR (see FIG. 20) of the frame section 81a of the liquid crystal shutter glasses 80H, and opens and closes the view of the right-eye opening section 81cR in accordance with whether the right-eye liquid crystal shutter 87R is in a transparent state or a light-shielding state.

A switch signal reception section 88 receives a switch signal S3 outputted from a switch signal output section 83 (mentioned later) of the display device 70H.

The switch signal reception section 88 is connected with the switch signal output section 83 of the display device 70H via a wire, and receives, via the wire, the switch signal S3 outputted from the switch signal output section 83.

In the present embodiment, the switch signal output section 83 of the display device 70H and the switch signal reception section 88 of each pair of liquid crystal shutter glasses 80H are connected by a wire. Alternatively, the switch signal output section 83 of the display device 70H and the switch signal reception section 88 of each pair of liquid crystal shutter glasses 80H may be connected via wireless communications using an optical signal, an infrared signal or etc.

In accordance with the switch signal S3 received by the switch signal reception section 88, the shutter control section 89 switches the liquid crystal shutters 87 between a transparent state and a light-shielding state.

To be more specific, when switching the liquid crystal shutters 87 to the transparent state, the shutter control section 89 switches both of the left-eye liquid crystal shutter 87L and the right-eye liquid crystal shutter 87R to the transparent state. When switching the liquid crystal shutters 87 to the light-shielding state, the shutter control section 89 switches both of the left-eye liquid crystal shutter 87L and the right-eye liquid crystal shutter 87R to the light-shielding state.

This enables a viewer to view an image displayed by the display section 73 in a time-dividing manner depending on switching of the liquid crystal shutters 87 between the transparent state and the light-shielding state.

### (Configuration of Display Device)

The display device 70H is obtained by modifying the display device 70 in Embodiment 3 (see FIG. 19) to further include a change number detection section 78 (change number detection means), a time-dividing section 79 (time-dividing means), a homologizing section 76 (homologizing means), a switch signal output section 83 (second output means), and a switch signal output control section 86 (switch signal generating means).

The inclination signal reception section 71 is connected with the inclination signal output section 84 of each pair of liquid crystal shutter glasses 80H via a wire, and receives, via the wire, the inclination signal S1 outputted from the inclination signal output section 84 of each pair of liquid crystal shutter glasses 80H.

In the present embodiment, the inclination signal reception section 71 and the inclination signal output section 84 of each pair of liquid crystal shutter glasses 80H are connected by a wire. Alternatively, the inclination signal reception section 71 and the inclination signal output section 84 of each pair of liquid crystal shutter glasses 80H may be connected via wireless communications using an optical signal, an infrared signal or etc.

In accordance with inclination signals S1 received by the inclination signal reception section 71 from the inclination signal output sections 84 of plural pairs of liquid crystal shutter glasses 80H, the change number detection section 78 detects the number of the liquid crystal shutter glasses 80H whose inclination has changed out of all the plural pairs of liquid crystal shutter glasses 80H. Here, the liquid crystal shutter glasses 80H whose inclination has changed are the liquid crystal shutter glasses 80H having been inclined around the axis Q1 as shown in FIG. 21B.

When the result of detection by the change number detecting section 78 shows that the number of liquid crystal shutter glasses 80H whose inclination has changed is one or more, the time-dividing section 79 controls the image output control section 77 to time-divide each frame of an image displayed by the display section 73 into a plurality of sub-frames. Further, in accordance with the inclination signal S1 received by the inclination signal reception section 71 from each pair of liquid crystal shutter glasses 80H, the homologizing section 76 specifies one or plural pairs of liquid crystal shutter glasses 80H whose inclination has changed, and homologizes all the pairs of the liquid crystal shutter glasses 80H with the plurality of sub-frames so that the one or plural pairs of liquid crystal shutter glasses 80H whose inclination has changed are homologized with different sub-frames of the plurality of sub-frames.

To be more specific, when the result of detection by the change number detecting section 78 indicates a number (first number) which is larger than one and smaller than the total number of the liquid crystal shutter glasses 80H (i.e. three), the time-dividing section 79 divides each frame of an image displayed by the display section 73 into sub-frames in the number (second number) larger by one than the number indicated by the detection result (first number). At that time, the homologizing section 76 homologizes the liquid crystal shutter glasses 80H whose inclination has not changed with a common sub-frame and homologizes the liquid crystal shutter glasses 80H whose inclination has changed with remaining sub-frames of the sub-frames in the second number, respectively.

Further, when the result of detection by the change number detecting section 78 indicates a number equal to the total number of liquid crystal shutter glasses 80H (i.e. three), the time-dividing section 79 time-divides each frame of an image displayed by the display section 73 into sub-frames in a number (three) equal to the total number (three) of liquid crystal shutter glasses 80H. At that time, the homologizing section 76 homologizes the three liquid crystal shutter glasses 80H whose inclination has changed with the three sub-frames, respectively.

Further, when the result of detection by the change number detecting section 78 indicates zero, the time-dividing section 79 does not divide each frame of an image displayed by the display section 73 into sub-frames. At that time, the homologizing section 76 homologizes all the pairs of liquid crystal shutter glasses 80H with each frame.

The inclination changing section 72 controls the image output control section 77 to change the inclination of an image to be displayed in a sub-frame homologized with liquid crystal shutter glasses 80H whose inclination has changed, in accordance with an inclination signal received by the inclination signal reception section 71 from the liquid crystal shutter glasses 80H, as in Embodiment 3. Consequently, the image displayed in the sub-frame homologized with the liquid crystal shutter glasses 80H whose inclination has changed is inclined around the center T as shown by the image D′ in FIG. 22B. The inclination changing section 72 does not change the inclination of an image in a sub-frame homologized with liquid crystal shutter glasses 80H whose inclination has not changed as shown by the image D in FIG. 22A.

The image output control section 77 receives an image signal S2 from the outside and causes the display section 73 to sequentially display individual frames indicated by the image signal S2, and outputs a sync signal S4 indicative of timing for displaying these frames to the switch signal output control section 86.

When the time-dividing section 79 time-divides each frame into a plurality of sub-frames, the image output control section 77 causes the display section 73 to sequentially display the plurality of sub-frames, and outputs a sync signal S4 indicative of timing for displaying these sub-frames to the switch signal output control section 86.

Further, as described above, the image output control section 77 carries out, under the control of the inclination changing section 72, an image process in which an image in a sub-frame is inclined around the axis T in accordance with the inclination of the liquid crystal shutter glasses 80H homologized with the sub-frame around the axis Q1.

In accordance with homologizing by the homologizing section 76 and the sync signal S4 from the image output control section 77, the switch signal output control section 86 generates switch signals S3 for individual pairs of liquid crystal shutter glasses 80H so that only the liquid crystal shutter glasses 80H homologized with the sub-frame to be displayed by the display section 73 open their views.

The switch signal output section 83 outputs the switch signals S3 generated by the switch signal output control section 86 for individual pairs of liquid crystal shutter glasses 80H to the switch signal reception sections 88 of individual pairs of liquid crystal shutter glasses 80H, respectively.

### (Explanation on Operation)

With reference to FIGS. 32, 36, and 37, the following explains an operation of a main part of the display device 70H. In the following, for convenience of explanation, the three pairs of liquid crystal shutter glasses 80H are referred to as 80Ha, 80Hb, and 80Hc, respectively, in order to distinguish them from one another.

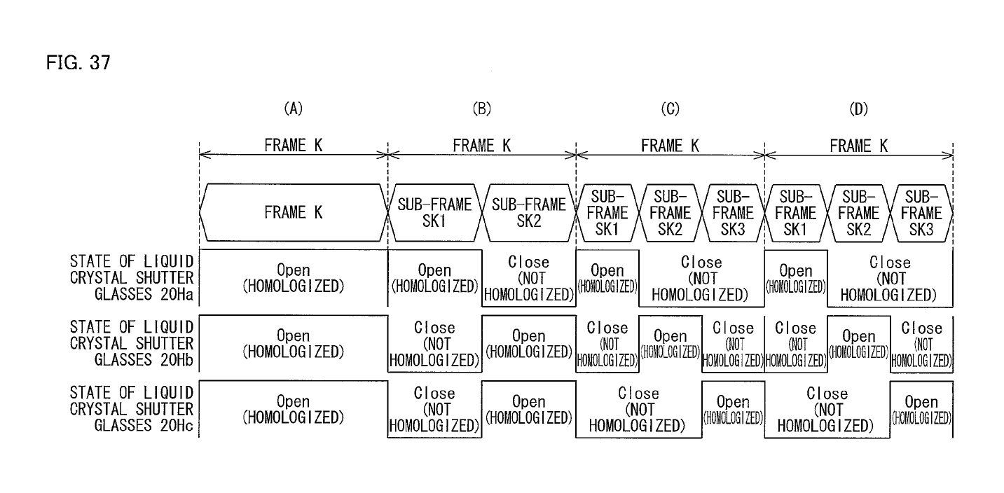

FIG. 37 is a view for explaining homologizing relationships between the liquid crystal shutter glasses 80Ha, 80Hb, and 80Hc and sub-frames SK1, SK2, and SK3, respectively, and open/close states of the liquid crystal shutter glasses 80Ha, 80Hb, and 80Hc while the sub-frames SK1, SK2, and SK3 are displayed.

“Open” in FIG. 37 indicates that the view of the liquid crystal shutter glasses is open, and “Close” indicates that the view of the liquid crystal shutter glasses is closed. Further, “homologizing” in FIG. 37 indicates that the liquid crystal shutter glasses (80Ha, 80Hb, or 80Hc) described at the uppermost left of the row including the “homologizing” are homologized with a frame K or a sub-frame (SK1, SK2, or SK3) at the uppermost of the column including the “homologizing”, and “non-homologizing” indicates otherwise.

In a case where the result of detection by the change number detecting section 78 is zero (i.e. the liquid crystal shutter glasses 80Ha, 80Hb, and 80Hc are not inclined around the axis Q1), the time-dividing section 79 does not time-divide each frame K of an image as shown in (A) of FIG. 37, the image output control section 77 causes the display section 73 to sequentially display each frame K one by one, the homologizing section 76 homologizes all of the liquid crystal shutter glasses 80Ha, 80Hb, and 80Hc with each frame K, and the switch signal output control section 86 generates switch signals S3 for the liquid crystal shutter glasses 80Ha, 80Hb, and 80Hc, respectively, so that the liquid crystal shutter glasses 80Ha, 80Hb, and 80Hc are in open states while displaying the frame K, and causes the switch signal output section 83 to output the generated switch signals S3.

Consequently, the image in the frame K displayed by the display section 73 is viewed by all viewers wearing the liquid crystal shutter glasses 80Ha, 80Hb, and 80Hc, respectively. In this case, since none of the liquid crystal shutter glasses 80Ha, 80Hb, and 80Hc are inclined (i.e. none of the viewers' faces is inclined), the inclination of the image in the frame K displayed by the display section 73 is not changed by the inclination changing section 72 (accordingly, the image viewed by the viewers is not inclined). That is, in a case where none of the viewers' faces is inclined, all the viewers view the image in the same frame K displayed by the display section 73.

In a case where the result of detection by the change number detecting section 78 is one (e.g. only the liquid crystal shutter glasses 80Ha are inclined around the axis Q1 and other liquid crystal shutter glasses 80Hb and 80Hc are not inclined around the axis Q1), the time-dividing section 79 time-divides an image in each frame K into sub-frames SK1 and SK2 in the number of two larger by one than the detection result of one as shown in (B) of FIG. 37. Further, the homologizing section 76 homologizes the liquid crystal shutter glasses 80Hb and 80Hc having been not inclined with a common sub-frame (e.g. SK2) and homologizes the liquid crystal shutter glasses 80Ha having been inclined with the sub-frame SK1.

In this case, the inclination changing section 72 changes, in accordance with the inclination of the inclined liquid crystal shutter glasses 80Ha around the axis Q1, how the image in the sub-frame SK1 homologized with the liquid crystal shutter glasses 80Ha is to be inclined around the axis T, and does not change the inclination of the image in the sub-frame SK2 homologized with the liquid crystal shutter glasses 80Hb and 80Hc having not been inclined. Further, when causing the display section 73 to display the frame K, the image output control section 77 causes the display section 73 to display the sub-frames SK1 and SK2 of the frame K one by one in this order (the inclination of the image in the sub-frame SK1 is changed by the inclination changing section 72 as described above, and the inclination of the image in the sub-frame SK2 is not changed). Consequently, when the sub-frame SK1 is displayed, the image is inclined around the axis T in accordance with the inclination of the liquid crystal shutter glasses 80Ha around the axis Q1, and when the sub-frame SK2 is displayed, the image is not inclined.

Further, in this case, the switch signal output control section 86 generates switch signals S3 for the liquid crystal shutter glasses 80Ha, 80Hb, and 80Hc, respectively, so that as shown in (B) of FIG. 37, while displaying the sub-frame SK1, only the liquid crystal shutter glasses 80Ha homologized with the sub-frame SK1 are in the open state, and the liquid crystal shutter glasses 80Hb and 80Hc not homologized with the sub-frame SK1 are in the closed state, and while displaying the sub-frame SK2, the liquid crystal shutter glasses 80Ha not homologized with the sub-frame SK2 are in the closed state, and only the liquid crystal shutter glasses 80Hb and 80Hc homologized with the sub-frame SK2 are in the open state, and the switch signal output control section 86 causes the switch signal output section 83 to output the switch signals S3.

Consequently, the image displayed by the display section 73 viewed by the viewer wearing the liquid crystal shutter glasses 80Ha (i.e. viewer whose face is inclined around the axis Q1) is inclined around the axis T in accordance with the inclination of the viewer's face around the axis Q1 (i.e. the inclination of the liquid crystal shutter glasses 80Ha around the axis Q1) as shown in FIG. 22B, whereas the image displayed by the display section 73 viewed by the viewers wearing the liquid crystal shutter glasses 80Hb and 80Hc (i.e. viewers whose faces are not inclined around the axis Q1) is not inclined as shown in FIG. 22B.

In a case where the result of detection by the change number detecting section 78 is two (e.g. only the liquid crystal shutter glasses 80Ha and 80Hb are inclined around the axis Q1 and the liquid crystal shutter glasses 80Hc are not inclined around the axis Q1), the time-dividing section 79 time-divides each frame K of an image into sub-frames SK1, SK2, and SK3 in the number of three larger by one than the detection result of two as shown in (C) of FIG. 37. Further, the homologizing section 76 homologizes the liquid crystal shutter glasses 80Hc having been not inclined with a sub-frame (e.g. SK3) and homologizes the liquid crystal shutter glasses 80Ha and 80Hb having been inclined with the sub-frames SK1 and SK2, respectively. Further, the inclination changing section 72 changes how the image in the sub-frame SK1 homologized with the inclined liquid crystal shutter glasses 80Ha is inclined around the axis T, in accordance with the inclination of the liquid crystal shutter glasses 80Ha around the axis Q1. The inclination changing section 72 changes how the image in the sub-frame SK2 homologized with the inclined liquid crystal shutter glasses 80Hb is inclined around the axis T, in accordance with the inclination of the liquid crystal shutter glasses 80Hb around the axis Q1. The inclination changing section 72 does not change the inclination of the image in the sub-frame SK3 homologized with the liquid crystal shutter glasses 80Hc which have not been inclined.

Further, when causing the display section 73 to display the frame K, the image output control section 77 causes the display section 73 to display the sub-frames SK1, SK2, and SK3 of the frame K one by one in this order (the inclination of the images in the sub-frames SK1 and SK2 is changed by the inclination changing section 72 as described above, and the inclination of the image in the sub-frame SK3 is not changed). Consequently, when the sub-frame SK1 is displayed, the image is inclined around the axis T in accordance with the inclination of the liquid crystal shutter glasses 80Ha around the axis Q1, when the sub-frame SK2 is displayed, the image is inclined around the axis T in accordance with the inclination of the liquid crystal shutter glasses 80Hb around the axis Q1, and when the sub-frame SK3 is displayed, the image is not inclined.

Further, in this case, the switch signal output control section 86 generates switch signals S3 for the liquid crystal shutter glasses 80Ha, 80Hb, and 80Hc, respectively, so that as shown in (C) of FIG. 37, while displaying the sub-frame SK1, only the liquid crystal shutter glasses 80Ha homologized with the sub-frame SK1 are in the open state and the liquid crystal shutter glasses 80Hb and 80Hc not homologized with the sub-frame SK1 are in the closed state, while displaying the sub-frame SK2, the liquid crystal shutter glasses 80Hb homologized with the sub-frame SK2 are in the open state and the liquid crystal shutter glasses 80Ha and 80Hc not homologized with the sub-frame SK2 are in the closed state, and while displaying the sub-frame SK3, only the liquid crystal shutter glasses 80Hc homologized with the sub-frame SK3 are in the open state and the liquid crystal shutter glasses 80Ha and 80Hb not homologized with the sub-frame SK3 are in the closed state, and the switch signal output control section 86 causes the switch signal output section 83 to output the switch signals S3.

Consequently, the image displayed by the display section 73 viewed by the viewer wearing the liquid crystal shutter glasses 80Ha (i.e. viewer whose face is inclined around the axis Q1) is inclined around the axis T in accordance with the inclination of the viewer's face around the axis Q1 (i.e. the inclination of the liquid crystal shutter glasses 80Ha around the axis Q1), the image displayed by the display section 73 viewed by the viewer wearing the liquid crystal shutter glasses 80Hb (i.e. viewer whose face is inclined around the axis Q1) is inclined around the axis T in accordance with the inclination of the viewer's face around the axis Q1 (i.e. the inclination of the liquid crystal shutter glasses 80Hb around the axis Q1), and the image displayed by the display section 73 viewed by the viewer wearing the liquid crystal shutter glasses 80Hc (i.e. viewer whose face is not inclined around the axis Q1) is not inclined.

In a case where the result of detection by the change number detecting section 78 is three (e.g. all of the liquid crystal shutter glasses 80Ha, 80Hb, and 80Hc are inclined around the axis Q1), the time-dividing section 79 time-divides each frame K of an image into three sub-frames SK1, SK2, and SK3 as shown in (D) of FIG. 37. Further, the homologizing section 76 homologizes the liquid crystal shutter glasses 80Ha, 80Hb, and 80Hc with the sub-frames SK1, SK2, and SK3, respectively. Further, the inclination changing section 72 changes how the images in the sub-frames SK1, SK2, and SK3 homologized with the liquid crystal shutter glasses 80Ha, 80Hb, and 80Hc respectively are inclined around the axis T in accordance with the inclination of the liquid crystal shutter glasses 80Ha, 80Hb, and 80Hc around the axis Q1, respectively.

Further, when causing the display section 73 to display the frame K, the image output control section 77 causes the display section 73 to display the sub-frames SK1, SK2, and SK3 of the frame K one by one in this order (the inclination of the images in the sub-frames SK1, SK2, and SK3 is changed by the inclination changing section 72 as described above). Consequently, when the sub-frame SK1 is displayed, the image is inclined around the axis T in accordance with the inclination of the liquid crystal shutter glasses 80Ha around the axis Q1, when the sub-frame SK2 is displayed, the image is inclined around the axis T in accordance with the inclination of the liquid crystal shutter glasses 80Hb around the axis Q1, and when the sub-frame SK3 is displayed, the image is inclined around the axis T in accordance with the inclination of the liquid crystal shutter glasses 80Hc around the axis Q1.

Further, in this case, the switch signal output control section 86 generates switch signals S3 for the liquid crystal shutter glasses 80Ha, 80Hb, and 80Hc, respectively, so that as shown in (D) of FIG. 37, while displaying the sub-frame SK1, only the liquid crystal shutter glasses 80Ha homologized with the sub-frame SK1 are in the open state and the liquid crystal shutter glasses 80Hb and 80Hc not homologized with the sub-frame SK1 are in the closed state, while displaying the sub-frame SK2, the liquid crystal shutter glasses 80Hb homologized with the sub-frame SK2 are in the open state and the liquid crystal shutter glasses 80Ha and 80Hc not homologized with the sub-frame SK2 are in the closed state, and while displaying the sub-frame SK3, only the liquid crystal shutter glasses 80Hc homologized with the sub-frame SK3 are in the open state and the liquid crystal shutter glasses 80Ha and 80Hb not homologized with the sub-frame SK3 are in the closed state, and the switch signal output control section 86 causes the switch signal output section 83 to output the switch signals S3.

Consequently, the image displayed by the display section 73 viewed by the viewer wearing the liquid crystal shutter glasses 80Ha (i.e. viewer whose face is inclined around the axis Q1) is inclined around the axis T in accordance with the inclination of the viewer's face around the axis Q1 (i.e. the inclination of the liquid crystal shutter glasses 80Ha around the axis Q1), the image displayed by the display section 73 viewed by the viewer wearing the liquid crystal shutter glasses 80Hb (i.e. viewer whose face is inclined around the axis Q1) is inclined around the axis T in accordance with the inclination of the viewer's face around the axis Q1 (i.e. the inclination of the liquid crystal shutter glasses 80Hb around the axis Q1), and the image displayed by the display section 73 viewed by the viewer wearing the liquid crystal shutter glasses 80Hc (i.e. viewer whose face is inclined around the axis Q1) is inclined around the axis T in accordance with the inclination of the viewer's face around the axis Q1 (i.e. the inclination of the liquid crystal shutter glasses 80Hc around the axis Q1).

As described above, in the present embodiment, there are provided plural pairs of liquid crystal shutter glasses 80H, the change number detecting section 78 detects the number of the liquid crystal shutter glasses 80H having been inclined, the time-dividing section 79 time-divides each frame K of an image displayed by the display section 73 into a plurality of sub-frames, the homologizing section 76 homologizes the liquid crystal shutter glasses 80H with the plurality of sub-frames so that one pair or more of the liquid crystal shutter glasses 80H having been inclined are homologized with different sub-frames, the switch signal output control section 86 generates switch signals S3 for the plural pairs of liquid crystal shutter glasses 80H respectively so that only the liquid crystal shutter glasses 80H homologized with the sub-frame displayed by the display section 73 open views, and the switch signals S3 enable the liquid crystal shutter glasses 80H to alternately open and close their views.

Consequently, the viewer wearing the liquid crystal shutter glasses 80H views, out of images displayed by the display section 73, only an image in the sub-frame homologized with the liquid crystal shutter glasses 80H worn by the viewer. Further, as with Embodiment 3, the inclination of the image in the sub-frame viewed by the viewer is changed depending on the inclination of the liquid crystal shutter glasses 80H worn by the viewer (i.e. the inclination of the viewer's face).

Consequently, for example, when one of viewers wearing the liquid crystal shutter glasses 80H inclines his/her face, only the image viewed by the viewer can be changed accordingly.

In the present embodiment, an explanation was made as to a case where the time-dividing section 79 indirectly time-divides each frame of an image into a plurality of sub-frames via the image output control section 77. Alternatively, the time-dividing section 79 may directly carry out a time-dividing process on an image signal outputted from the image output control section 77 to the display section 73, thereby time-dividing each frame of an image into a plurality of sub-frames. In this case, the sync signal S4 indicative of timing for displaying the sub-frame may be generated by the time-dividing section 79 instead of the image output control section 77 and then outputted to the switch signal output control section 86.

Further, in the present embodiment, an explanation was made as to a case where the inclination changing section 72 indirectly carries out an image process to change the inclination of an image by controlling the image output control section 77. Alternatively, the inclination changing section 72 may directly carry out an image process on an image signal outputted from the image output control section 77 to the display section 73, thereby changing the inclination of the image. Further, in the case where the time-dividing section 79 directly time-divides each frame of an image into a plurality of sub-frames as above, the time-dividing section 79 may directly carry out an image process on the sub-frames so as to change the inclination of the image.

### Modification Example 1

The above method is only an example of the method for switching the liquid crystal shutters 87 in Embodiment 6. The switching may be made by other method. Examples of the other method are as follows.

The following explains, as an example, a case where when each frame of an image is time-divided into a plurality of sub-frames in the display device 70H in accordance with Embodiment 6, an image in a sub-frame viewable via liquid crystal shutter glasses worn by a viewer can be freely selected by a manual operation of the viewer. An explanation will be made below with reference to FIG. 36.

In Embodiment 6, the switch signal output control section 86 generates switch signals S3 for individual pairs of liquid crystal shutter glasses 80H, respectively, whereas in the present modification example, the switch signal output control section 86 (switch signal generating means) generates, as a switch signal S3, a sync signal common among individual pairs of liquid crystal shutter glasses 80H (i.e. a sync signal indicative of timing with which individual sub-frames are displayed by the display section 73). That is, one sync signal indicates timing with which all sub-frames are displayed. The sync signal is outputted as a switch signal S3 from the switch signal output section 83 (second output means) to individual pairs of liquid crystal shutter glasses 80H. Such switch signal S3 may be hereinafter referred to as a sync signal S3.

In the present modification example, each pair of liquid crystal shutter glasses 80H is equipped with sync selecting means capable of selecting which sub-frame the pair of liquid crystal shutter glasses 80H is to be in sync with out of a plurality of sub-frames (in other words, switch selecting means for selecting which sub-frame the pair of liquid crystal shutter glasses 80H is to switch to) (not shown) serving as a part of the operation section 85. By operating the sync selecting means, a viewer can select a sub-frame to view.

Specifically, in the display device 70H, when a frame of an image at a rate of 60 Hz is time-divided into three sub-frames as in Embodiment 6, timing for displaying each sub-frame is 180 Hz, and when time-divided into four sub-frames, timing for displaying each sub-frame is 240 Hz. Even if individual pairs of liquid crystal shutter glasses 80H do not recognize what selection is made in other pairs of liquid crystal shutter glasses 80H, the shutter control section 89 (second control means) for example can obtain, from the frequency of the above sync signal S3, information on the number of sub-frames resulting from time-division. When a frame is time-divided into three sub-frames, a viewer selects which sub-frame out of the three sub-frames the liquid crystal shutter glasses 80H are to be in sync with via the sync selecting means, and the shutter control section 89 controls opening and closing of the liquid crystal shutters 87 so that the viewer can view only an image in the selected sub-frame via the liquid crystal shutter glasses 80H, thereby enabling the viewer to view an image in the desired frame. In this case, the viewer himself/herself carries out the operation of the homologizing section 76.

The switch control as above requires only one switch signal S3 to be transmitted from the display device 70H to individual pairs of liquid crystal shutter glasses 80H. This simplifies the configuration of the switch signal output control section 86.

### Modification Example 2

Modification Example 2 is a modification example of Embodiment 6. In Embodiment 6, liquid crystal shutter glasses 80H for which the inclination of an image is to be changed are automatically selected when the liquid crystal shutter glasses 80H are inclined, whereas in the present modification example, liquid crystal shutter glasses 80H for which the inclination of an image is to be changed are selected by a manual operation of a viewer.

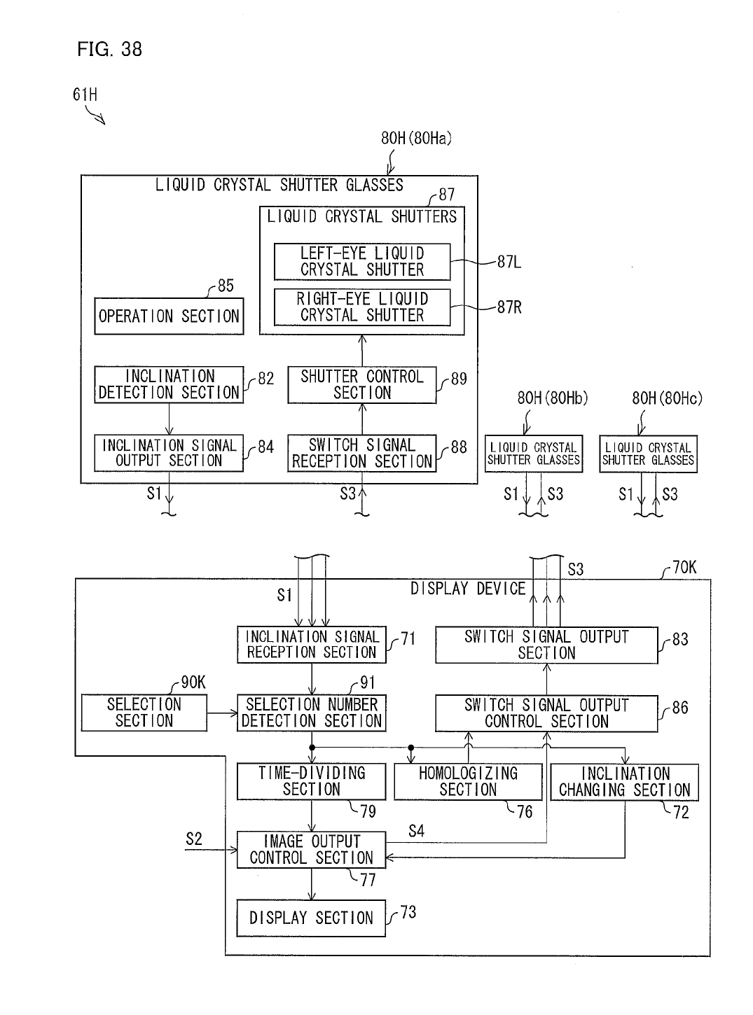

In the following, with reference to FIG. 38, members which are the same as those in Embodiment 6 are given the same reference signs and explanations thereof are omitted, and only members different from those in Embodiment 6 are explained.

A display device 70K in the present modification example includes a selection number detecting section 91 (selection number detecting means) instead of the change number detecting section 78 of the display device 70H in accordance with Embodiment 6. Further, one of the liquid crystal shutter glasses 80H or the display device 70K includes a selection section 90K. FIG. 38 shows a case where the display device 70K includes the selection section 90K.

In Embodiment 6, the number of sub-frames into which the time-dividing section 79 time-divides a frame is determined by the change number detecting section 78 counting the number of liquid crystal shutter glasses 80H whose inclination has been changed, whereas in the present modification example, the number of sub-frames into which the time-dividing section 79 (time-dividing means) time-divides a frame is determined by the number of liquid crystal shutter glasses 80H selected via the selection section 90K.

The selection section 90K is used for selecting liquid crystal shutter glasses 80H for which the inclination of an image is to be changed. The selection section 90K may be included as a part of the operation section 85 in the liquid crystal shutter glasses 80H and serve as a switch via which a viewer can switch between a selected state and a non-selected state of the liquid crystal shutter glasses 80H just like the selection section 90 in Embodiment 5, or may be included in a display device just like the selection section 90 in the modification example 1 of Embodiment 5.

In the present modification example, the number of selected pair of liquid crystal shutter glasses 80H may be two or more. The number of selected pair of liquid crystal shutter glasses 80H is counted by the selection number detecting section 91, and the number is transmitted to the time-dividing section 79. In a case where the selection section 90K is included in the liquid crystal shutter glasses 80H, a signal indicative of whether the liquid crystal shutter glasses 80H are selected or not (selection signal) may be transmitted and received as a part of an inclination signal S1.

In a case where the number of selected pair of liquid crystal shutter glasses (hereinafter, selection number) which is detected by the selection number detecting section 91 is smaller than the total number of the liquid crystal shutter glasses, the time-dividing section 79 time-divides each frame of an image into (selection number+1) sub-frames. That is, each frame is time-divided into one or more (selection number) sub-frames which is homologized with the selected liquid crystal shutter glasses 80H and for which the inclination of an image is changed and one sub-frame for which the inclination of an image is not changed. The homologizing section 76 homologizes the selected liquid crystal shutter glasses 80H with corresponding sub-frames, and homologizes the unselected liquid crystal shutter glasses 80H with the sub-frame for which the inclination of an image is not changed.

In a case where the selection number is equal to the total number of liquid crystal shutter glasses 80H, the time-dividing section 79 time-divides each frame of an image into sub-frames in the same number as the selection number. The homologizing section 76 homologizes the sub-frames with the liquid crystal shutter glasses 80H, respectively.

As described above, the liquid crystal shutter glasses 80H for which the inclination of an image is to be changed are selected by the viewer's manual operation via the operation section 90K. Only for the viewer wearing the selected liquid crystal shutter glassed 80H, an image is inclined in accordance with inclination of the liquid crystal shutter glasses 80H worn by the viewer. This technique may be combined with the Modification Example 1 of Embodiment 6 so that an image in a sub-frame viewable by the liquid crystal shutter glasses worn by the viewer may be freely selected.

### Modification Example 3

Embodiment 6 is based on Embodiment 3. Alternatively, a modification example of Embodiment 6 may be based on any of Modification Examples 1-5 of Embodiment 3 or any combinations of the Modification Examples 1-5.

All of Embodiments 3-6 and modification examples thereof refer to the changes in images when a viewer's face rotates around one axis. Alternatively, by using an inclination detecting section capable of detecting rotations around a plurality of axes out of axes Q1, Q2, and Q3 orthogonal to one another (e.g. three-axial acceleration sensor), it is possible to combine any changes in images displayed by the display section 73 which were described in Embodiments 3-6 and modification examples thereof. For example, in a case where liquid crystal shutter glasses are inclined around the axis Q1 by 30°, around the axis Q2 by 20°, and around the axis Q3 by 10°, there may be displayed an image which is inclined by 30° in a θ direction shown in FIG. 22 corresponding to Embodiment 3, by 20° in a φ direction shown in FIG. 27 corresponding to the Modification Example 4, and by 10° in a ψ direction shown in FIG. 29 corresponding to the Modification Example 6.

### [Method for Detecting Inclination Amount]

As described above, the inclination detection section 82 may include an acceleration sensor or a gyro sensor. Here, an explanation is made to a method for detecting the inclination (inclination amount) of the liquid crystal shutter glasses 80 by using the acceleration sensor.

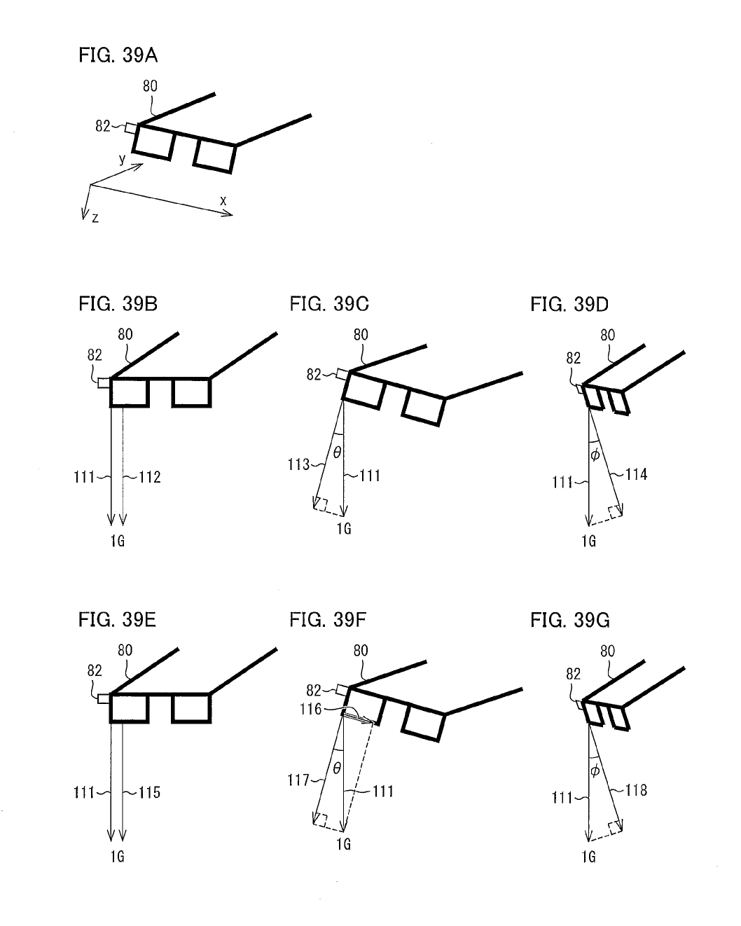

FIGS. 39A, 39B, 39C, 39D, 39E, 39E, 39F, and 39G are schematic views for explaining the method for detecting the inclination amount by using the acceleration sensor. FIG. 39A shows a coordinate system. FIGS. 39B, 39C, and 39D show a basic inclination, rotation around y-axis (rotation around axis Q1), and rotation around x-axis (rotation around axis Q2), respectively, in a case of using a uniaxial acceleration sensor. FIGS. 39E, 39F, and 39G show a basic inclination, rotation around y-axis (rotation around axis Q1), and rotation around x-axis (rotation around axis Q2), respectively, in a case of using a biaxial acceleration sensor

As shown in FIG. 39A, the liquid crystal shutter glasses 80 are equipped with an inclination detecting section 82 which is an acceleration sensor. For example, in the case where the inclination detecting section 82 is a uniaxial acceleration sensor, when a viewer is in a state of the basic inclination as shown in FIG. 39B, acceleration 112 in the z-direction is 1G111. This indicates that the viewer's face is not inclined.

As shown in FIG. 39C, when the viewer's face is inclined around the y-axis (around the axis Q1), acceleration 113 in the z-direction is 1G×cos θ, and comparison of 1G×cos θ with 1G111 shows that the viewer's face is inclined.

As shown in FIG. 39D, when the viewer's face is inclined around the x-axis (around the axis Q2), acceleration 114 in the z-direction is 1G×cos φ, and comparison of 1G×cos φ with 1G111 shows that the viewer's face is inclined.

In the case where the inclination detecting section 82 is a biaxial acceleration sensor, when a viewer is in a state of the basic inclination as shown in FIG. 39E, acceleration in the x-direction is 0G and acceleration 115 in the z-direction is 1G111. This indicates that the viewer's face is not inclined.

As shown in FIG. 39F, when the viewer's face is inclined around the y-axis, acceleration 116 in the x-direction is 1G×sin θ and acceleration 117 in the z-direction is 1G×cos θ, and comparison of the absolute values of the acceleration 116 in the x-direction and the acceleration 117 in the z-direction with 1G111 shows that the viewer's face is inclined.

As shown in FIG. 39G, when the viewer's face is inclined around the x-axis, acceleration in the x-direction is 0G and acceleration 98 in the z-direction is 1G×cos φ, and comparison of the absolute values of the acceleration in the x-direction and the acceleration 98 in the z-direction with 1G shows that the viewer's face is inclined.

In the case where the inclination detecting section 82 is a triaxial acceleration sensor, accelerations in the x-direction, the y-direction, and the z-direction, respectively, are outputted, and so comparison of the accelerations with gravitational acceleration direction shows that the viewer's face is inclined.

### [Additional Note]

The present invention may be expressed also as follows. That is, view-switching glasses of the present invention are liquid crystal shutter glasses for switching how a viewer views through a left eye and a right eye, including inclination detection means for detecting an amount of inclination of the liquid crystal shutter glasses, and an output section for outputting an inclination amount signal based on a result of detection by the inclination detection means.

A display control device of the present invention is a display control device, including input means for receiving the inclination amount signal from the liquid crystal shutter glasses, the display control device changes, in accordance with the inclination amount signal from the input means, a display mode of an image viewed by a viewer into a display mode in which a relative position of the image with respect to the viewer is changed.

The amount of inclination detected by the inclination sensor is an amount of how a direction aligning the left eye and the right eye of the viewer is inclined with respect to a horizontal direction, and the display mode into which the display mode of an image viewed by the viewer is changed is a display mode in which when seen from the viewer, the image is rotated around the center of the display device so that an amount of rotation of the image corresponds to the amount of inclination detected by the inclination sensor.

The rotation of the image is made by rotating the image displayed by the display device.

The display device is capable of rotating its screen around the center of the screen, and the rotation of the image is made by rotating the screen displaying the left-eye image and the right-eye image.

Lastly, each block of the liquid crystal shutter glasses 80 and 80H and the display device 70 and 70H may be realized by hardware logic or may be realized by software by using CPUs.

Namely, each block of the liquid crystal shutter glasses 80 and 80H and the display device 70 and 70H includes: CPUs (central processing unit) for executing a program for realizing functions of each block; ROMs (read only memory) that store the program; RAMs (random access memory) that develop the program; storage devices (storage mediums) such as a memory that store the program and various data; and the like. The object of the present invention can be realized in such a manner that the liquid crystal shutter glasses 80 and 80H and the display device 70 and 70H are provided with a computer-readable storage medium for storing program codes (such as executable program, intermediate code program, and source program) of programs of the liquid crystal shutter glasses 80 and 80H and the display device 70 and 70H which programs serve as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a Floppy Disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the liquid crystal shutter glasses 80 and 80H and the display device 70 and 70H may be arranged so as to be connectable to a communication network so that the program code is supplied to the liquid crystal shutter glasses 80 and 80H and the display device 70 and 70H through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program codes in the form of a computer data signal embedded in a carrier wave, which is the program that is electrically transmitted.

The present invention is not limited to the description of the embodiments above, but may be altered by a skilled person within the scope of the claims. An embodiment based on a proper combination of technical means disclosed in different embodiments is encompassed in the technical scope of the present invention.

It is preferable to arrange the view-switching glasses of the present invention so as to further include determination means for determining, based on a result of detection by the inclination detection means, whether to stop an initial image viewing mode in which the left-eye of the viewer perceives only a left-eye image and the right-eye of the viewer perceives only a right-eye image.

The “3DC Safety Guidelines for Dissemination of Human-friendly 3D (revised on Apr. 20, 2010)” made by 3D Consortium (3DC) Safety/Guidelines Section read “(c)oncerning images based on binocular disparity, it is advisable to view them in a posture where the surface of the display and both eyes are on the same level”

With the arrangement, the view-switching glasses are worn by the viewer's face, and when the viewer's face is inclined with respect to a horizontal direction or relatively inclined with respect to a display device, the view-switching glasses are inclined accordingly. The inclination detection means detects the amount of inclination of the view-switching glasses. The amount is an index indicative of the posture of the viewer.

When the viewer views a stereoscopic image, the view-switching glasses carry out an initial image viewing mode in which the left eye of the viewer perceives only a left-eye image and the right eye of the viewer perceives only a right-eye image.

With the arrangement, the determination means determines, in accordance with the amount of inclination of the view-switching glasses which is detected by the inclination detection means, whether to stop the initial image viewing mode in which the left eye of the viewer perceives only a left-eye image and the right eye of the viewer perceives only a right-eye image. In other words, the determination means determines whether the posture of the viewer viewing a stereoscopic image is appropriate or not.

Use of the result of the determination enables a viewer to know, for example, whether the posture of the viewer is appropriate for viewing a stereoscopic image.

Accordingly, it is possible to subdue health damage derived from the posture of a viewer viewing a stereoscopic image.

It is preferable to arrange the view-switching glasses of the present invention so as to further include switch means for switching, when the determination means determines that the initial image viewing mode is to be stopped, how the viewer views through the left eye and the right eye, so that a predetermined second image viewing mode different from the initial image viewing mode is carried out.

With the arrangement, when the determination means determines that the initial image viewing mode is to be stopped, in other words, the posture of a viewer is not appropriate, the changing means changes the display mode from the initial image viewing mode to a second image viewing mode which is different from the initial image viewing mode. Carrying out the second image viewing mode indicates that images perceived by the left eye and the right eye of the viewer change upon carrying out the second image viewing mode.

This change enables the viewer to surely know that his/her posture when viewing a stereoscopic image is determined as not appropriate.

Accordingly, it is possible to surely subdue health damage derived from the posture of the viewer while viewing a stereoscopic image.

It is preferable to arrange the view-switching glasses of the present invention such that the second image viewing mode is a mode in which one of the left-eye image and the right-eye image is perceived by both of the left eye and the right eye of the viewer.

With the arrangement, upon the start of the second image viewing mode, the viewer experiences a change from the stereoscopic image viewed so far to a flat image. Such a change from the stereoscopic image to the flat image is very uncomfortable to the viewer.

Such uncomfortableness enables the viewer to surely know that his/her posture when viewing a stereoscopic image is determined as not appropriate.

It is preferable to arrange the view-switching glasses of the present invention such that the second image viewing mode is a mode in which both of the left-eye image and the right-eye image are perceived by both of the left eye and the right eye of the viewer.

With the arrangement, upon the start of the second image viewing mode, the viewer experiences a change from the stereoscopic image viewed so far to simply doubled flat images (i.e. the stereoscopic image cannot be viewed any more), which is uncomfortable to the viewer and surely arrests the viewer's attention.

Consequently, the viewer can surely know that his/her posture when viewing a stereoscopic image is determined as not appropriate.

It is preferable to arrange the view-switching glasses of the present invention such that the second image viewing mode is a mode in which neither of the left-eye image and the right-eye image is perceived by both of the left eye and the right eye of the viewer.

With the arrangement, when the second image viewing mode is carried out, the viewer cannot view the stereoscopic image viewed so far, which is uncomfortable to the viewer and surely arrests the viewer's attention. Further, it is possible to surely remove a burden on the eyes of the viewer.

Consequently, the viewer can surely know that his/her posture when viewing a stereoscopic image is determined as not appropriate. Further, it is possible to reduce a burden on the eyes of the viewer.

It is preferable to arrange the view-switching glasses of the present invention such that the determination means determines whether to stop the initial image viewing mode in accordance with whether the amount of inclination detected by the inclination detection means is larger than a predetermined threshold.

With the arrangement, the determination means can determine whether to stop the initial image viewing mode by a simple process of comparing the amount of inclination detected by the inclination detection means with the threshold.

Consequently, the determination means can determine efficiently.

It is preferable to arrange the view-switching glasses of the present invention such that the inclination detection means is an acceleration sensor, and the determination means includes judging means for judging, in accordance with a temporal change in acceleration detected by the acceleration sensor, whether the acceleration detected by the acceleration sensor is to be used as the amount of inclination.

A viewer's habit varies with respect to each viewer. For example, some viewers make sudden facial motions (e.g. nod), and some viewers constantly move their faces when viewing stereoscopic images. In such cases, if the determination means determines whether to stop the initial image viewing mode, the second image viewing mode is carried out unnecessarily. This is very troublesome for the viewer.

With the arrangement, the inclination detection means includes an acceleration sensor. The judging means judges, in accordance with a temporal change in acceleration detected by the acceleration sensor, whether the acceleration detected by the acceleration sensor is to be used as the amount of inclination of the view-switching glasses. The sudden motion and constant motion as above can be identified by observing a temporal change in acceleration.

The judging means judges that the amount of inclination of the view-switching glasses derived from such sudden motion and constant motion should not be used in determination by the determination means.

Consequently, the second image viewing mode is less likely to be carried out unnecessary, which is more convenient for the viewer.

It is preferable to arrange the view-switching glasses of the present invention such that the inclination detection means is a gyro sensor.

The gyro sensor detects inclination of an object by measuring accelerations of the object.

Accordingly, use of the gyro sensor enables the inclination detection means to speedily detect the amount of inclination.

It is preferable to arrange the view-switching glasses of the present invention so as to further include a notification section for notifying, when the determination means determines that the initial image viewing mode is to be stopped, the viewer of a result of the determination by the determination means.

With the arrangement, based on notification by the notification section, the viewer can surely know that his/her posture when viewing a stereoscopic image is determined as not appropriate.

It is preferable to arrange the view-switching glasses of the present invention so as to further include an output section for outputting, when the determination means determines that the initial image viewing mode is to be stopped, a determination signal indicative of a result of the determination by the determination means, the output section outputting the determination signal to a display device which displays a parallax image using a parallax between a left eye and a right eye of a viewer so that a viewer wearing the view-switching glasses views a stereoscopic image.

With the arrangement, the view-switching glasses cause the output section to output the result of determination by the determination means to the display control device. The display control device receives the result of determination from the view-switching glasses and can recognize whether the viewer's posture when viewing a stereoscopic image is appropriate or not.

Consequently, the display control device can control a parallax image displayed by the display device, in accordance with whether the viewer's posture when viewing a stereoscopic image is appropriate or not.

In order to solve the foregoing problem, a display control device of the present invention is a display control device for causing a display device to display a parallax image using a parallax between a left eye and a right eye of a viewer so that a viewer wearing the view-switching glasses views a stereoscopic image, including changing means for, upon reception of the determination signal, changing a display mode of the display device from a stereoscopic image display mode to a predetermined second image display mode, the stereoscopic image display mode being a display mode in which the left-eye image and the right-eye image are displayed alternately in accordance with timing for switching how the view-switching glasses enable the viewer to view.

With the arrangement, when it is determined that the posture of the viewer viewing a stereoscopic image is not appropriate, the changing means changes the display mode of the display device from the stereoscopic image display mode to the second image display mode different from the stereoscopic image display mode. Such a change from the stereoscopic image display mode to the second image display mode indicates that images perceived by the eyes of the viewer are greatly changed on and after the change.

The great change enables the viewer to surely know that the posture of the viewer is determined as not appropriate.

Further, in a case where a plurality of viewers view stereoscopic images simultaneously, viewers other than the viewer whose posture is determined as not appropriate can know who is the viewer, and warn the viewer.

Consequently, it is possible to surely reduce health damage deriving from the posture of a viewer viewing stereoscopic images.

It is preferable to arrange the display control device of the present invention such that the second image display mode is a display mode in which one of the left-eye image and the right-eye image is displayed.

With the arrangement, when the display mode is changed from the stereoscopic image display mode to the second image viewing mode, the viewer experiences a change from the stereoscopic image viewed so far to a flat image. Such a change from the stereoscopic image to the flat image is very uncomfortable to the viewer.

Such uncomfortableness enables the viewer to surely know that his/her posture when viewing a stereoscopic image is determined as not appropriate.

It is preferable to arrange the display control device of the present invention such that the second image display mode is a notification image display mode in which the viewer is notified of a result of the determination by the determination means.

With the arrangement, the viewer can surely know that the posture of the viewer is determined as not appropriate by viewing a displayed message indicative of the result of the determination.

It is preferable to arrange the display control device of the present invention such that the second image display mode is a display mode in which the display device displays no image.

With the arrangement, when the display mode is changed from the stereoscopic image display mode to the second image display mode, the viewer experiences sudden disappearance of the stereoscopic image viewed so far. The viewer is surely aware of such disappearance.

Consequently, the change in the display mode and the disappearance of the stereoscopic image enables the viewer to surely know that the posture of the viewer is determined as not appropriate.

It is preferable to arrange the display control device of the present invention such that the determination signal includes an inclination amount signal indicative of an amount of inclination detected by the inclination detection means, and the second image display mode is obtained by modifying the stereoscopic image display mode in such a manner that positions of the left-eye image and the right-eye image displayed by the display device are changed in accordance with the amount of inclination indicated by the inclination amount signal.

With the arrangement, the display control device can obtain the amount of inclination of the view-switching glasses from the inclination amount signal included in the determination signal received from the view-switching glasses. The amount of inclination is an index indicative of the posture of the viewer wearing the view-switching glasses.

In accordance with the amount of inclination, the display control device changes an image displayed by the display device or changes the position of the display device. Specifically, the display control device changes the positions of a left-eye image and a right-eye image displayed by the display device, or changes inclination of the display device itself.

Thus, for example, when the viewer continues to view a left-eye image and a right-eye image displayed by the display device while maintaining his/her posture, the positions of the left-eye image and the right-eye image are changed in such a manner that the viewer's current posture is most appropriate for viewing the images.

That is, instead of the viewer changing his/her posture, the positions of the left-eye image and the right-eye image are changed, so that the viewer's current posture is most appropriate for viewing the images.

Consequently, without the necessity for the viewer to change his/her posture, it is possible to subdue health damage derived from the viewer's posture when viewing a stereoscopic image, and at the same time enhance the viewer's convenience.

It is preferable to arrange the display control device of the present invention such that the amount of inclination detected by the inclination detection means is an amount of how a direction aligning the left eye and the right eye of the viewer is inclined with respect to a horizontal direction, and the second image display mode is a display mode in which the left-eye image and the right-eye image are moved in opposite directions along a vertical direction in such a manner that a line joining corresponding points on the left-eye image and the right-eye image is inclined with respect to the horizontal direction in an amount equal to the amount of inclination detected by the inclination detection means.

The “3DC Safety Guidelines for Dissemination of Human-friendly 3D (revised on Apr. 20, 2010)” reads “(i)f both eyes are on a slant to the surface of the display, differences in upper and lower images recognized by the left eye and the right eye become larger which makes fusion of images difficult and causes eye strain”.

With the arrangement, a direction aligning the left eye and the right eye of the viewer is equal to a direction of a line joining corresponding points on the left-eye image and the right-eye image. That is, the viewer can view an image displayed by the display device while the direction aligning the eyes of the viewer is parallel to an image surface of an image displayed by the display device.

Consequently, the viewer can view a stereoscopic image while maintaining his/her posture.

It is preferable to arrange the display control device of the present invention such that the amount of inclination detected by the inclination detection means is an amount of how a direction aligning the left eye and the right eye of the viewer is inclined with respect to a horizontal direction, and the second image display mode is a display mode in which when seen from the viewer, the left-eye image and the right-eye image are rotated around a center of the display device while maintaining a relative positional relationship between the left-eye image and the right-eye image in such a manner that a line joining corresponding points on the left-eye image and the right-eye image is inclined with respect to the horizontal direction in an amount equal to the amount of inclination detected by the inclination detection means.

With the arrangement, a direction aligning the left eye and the right eye of the viewer is equal to a direction of a line joining corresponding points on the left-eye image and the right-eye image. That is, the viewer can view an image displayed by the display device while the direction aligning the eyes of the viewer is parallel to an image surface of an image displayed by the display device.

Consequently, the viewer can view a stereoscopic image while maintaining his/her posture.

It is preferable to arrange the display control device of the present invention such that the left-eye image and the right-eye image are rotated by rotating images displayed by the display device.

With the arrangement, the left-eye image and the right-eye image themselves displayed by the display device are rotated. That is, the changing means changes relative positions of the left-eye image and the right-eye image displayed by the display device from a state before the change in the display mode of the display device to a state after the change.

Consequently, it is possible to rotate a left-eye image and a right-eye image only by an image process using software for rotating a left-eye image and a right-eye image, without separately providing a special mechanism for rotating a display device itself.

It is preferable to arrange the display control device of the present invention such that the display device is rotatable around a center thereof, and the left-eye image and the right-eye image are rotated by rotating the display device when the display device displays the left-eye image and the right-eye image.

With the arrangement, instead of rotation of the left-eye image and the right-eye image themselves displayed by the display device, the display device itself is rotated. That is, when changing the display mode of the display device, the changing means rotates the display device itself.

In a case where the left-eye image and the right-eye image themselves displayed by the display device are rotated, there is a possibility that a part of the image displayed at the periphery of the display device is cut. Such a case requires a process for interpolating the cut part of the image and a process for downsizing the image in order to avoid a part of the image from being cut. Such a process may require a large time depending on the computing power of a processor carrying out the image process.

With the arrangement, since the display device itself is rotated, it is unnecessary to carry out the special image process as above. Accordingly, it is possible to rotate a left-eye image and a right-eye image as above without a special image process using software for rotating a left-eye image and a right-eye image.

Further, the technical scope of the present invention encompasses a computer-readable storage medium in which a control program for operating the above view-switching glasses is stored, the control program causing a computer to function as the means of the view-switching glasses. Further, the technical scope of the present invention encompasses a computer-readable storage medium in which a control program for operating the above display control device is stored, the control program causing a computer to function as the means of the display control device.

The above control program enables a computer to realize the means of the view-switching glasses or the display control device, so that the computer serves as the view-switching glasses or the display control device. Further, the above storage medium enables the control program to be realized on a general-purpose computer.

The view-switching glasses of the present invention may be arranged to be view-switching glasses wearable by a user's face, including: inclination detection means for detecting inclination of the view-switching glasses; and output means for outputting, as an inclination signal, a result of detection by the inclination detection means to an outside.

With the arrangement, the view-switching glasses include the inclination detection means for detecting inclination of the view-switching glasses, and the output means for outputting, as an inclination signal, a result of detection by the inclination detection means to an outside. Accordingly, the view-switching glasses can be used in the above display control system.

It is preferable to arrange the display control system of the present invention such that the inclination detection means detects inclination of the view-switching glasses around an axis extending in a front and back direction of the view-switching glasses, and the inclination changing means changes inclination of the image by rotating the image around an axis normal to an image surface of the image in accordance with the inclination signal.

With the arrangement, the inclination detection means detects inclination of the view-switching glasses around an axis extending in a front and back direction of the view-switching glasses. Accordingly, the inclination signal outputted from the inclination detection means includes information on the inclination of the view-switching glasses around an axis extending in a front and back direction of the view-switching glasses. On the other hand, the inclination changing means rotates (i.e. inclines) the image around an axis normal to an image surface of the image in accordance with the inclination signal. Accordingly, it is possible to incline the image displayed by the display section around an axis normal to the image surface, in accordance with inclination of the view-switching glasses around an axis extending in a front and back direction of the view-switching glasses.

It is preferable to arrange the display control system of the present invention such that the inclination detection means detects inclination of the view-switching glasses around an axis extending in a left and right direction of the view-switching glasses, and the inclination changing means changes inclination of the image by rotating the image around an axis extending in a left and right direction of an image surface of the image in accordance with the inclination signal.

With the arrangement, the inclination detection means detects inclination of the view-switching glasses around an axis extending in a left and right direction of the view-switching glasses. Accordingly, the inclination signal outputted from the inclination detection means includes information on the inclination of the view-switching glasses around an axis extending in a left and right direction of the view-switching glasses. On the other hand, the inclination changing means rotates (i.e. inclines) the image around an axis extending in a left and right direction of an image surface of the image in accordance with the inclination signal. Accordingly, it is possible to incline the image displayed by the display section around an axis extending in a left and right direction of the image surface, in accordance with inclination of the view-switching glasses around an axis extending in a left and right direction of the view-switching glasses.

It is preferable to arrange the display control system of the present invention such that the inclination detection means detects inclination of the view-switching glasses around an axis extending in an up and down direction of the view-switching glasses, and the inclination changing means changes inclination of the image by rotating the image around an axis extending in an up and down direction of an image surface of the image in accordance with the inclination signal.

With the arrangement, the inclination detection means detects inclination (i.e. waggle) of the view-switching glasses around an axis extending in an up and down direction of the view-switching glasses. Accordingly, the inclination signal outputted from the inclination detection means includes information on the waggle of the view-switching glasses around an axis extending in an up and down direction of the view-switching glasses. On the other hand, the inclination changing means rotates (i.e. waggles) the image around an axis extending in an up and down direction of an image surface of the image in accordance with the inclination signal. Accordingly, it is possible to waggle the image displayed by the display section around an axis extending in an up and down direction of the image surface, in accordance with waggle of the view-switching glasses around an axis extending in an up and down direction of the view-switching glasses.

It is preferable to arrange the display control system of the present invention such that the inclination changing means rotates the image in a same direction as a direction in which the view-switching glasses are rotated.

With the arrangement, the image is rotated in the same direction as the direction in which the view-switching glasses are rotated. Specifically, when the view-switching glasses are rotated clockwise, the image is rotated clockwise, and when the view-switching glasses are rotated counterclockwise, the image is rotated counterclockwise.

Consequently, when a viewer wearing the view-switching glasses turns to the left, the image is changed to seem as if it turned to the right side of the viewer. When the viewer looks down, the image is changed to seem as if it looked up. When the viewer inclines his/her face to the left side, the image is inclined counterclockwise around an axis normal to the image surface.

As described above, in accordance with inclination of the face of the viewer wearing the view-switching glasses, the image is changed to seem as if it were not inclined with respect to the viewer, enabling the viewer to view the image with higher visibility.

It is preferable to arrange the display control system of the present invention such that the inclination changing means rotates the image at an angle substantially equal to an angle at which the view-switching glasses are rotated.

Consequently, even when inclination of the viewer's face is changed, a change in inclination of the image seen from the viewer can be as small as possible, enabling the viewer to view the image with higher visibility.

It is preferable to arrange the display control system of the present invention such that the inclination changing means rotates the image in such a manner that an axis extending in a front and back direction of the view-switching glasses is substantially parallel to an axis extending in a front and back direction of the image, an axis extending in a left and right direction of the view-switching glasses is substantially parallel to an axis extending in a horizontal direction of the image, and an axis extending in an up and down direction of the view-switching glasses is substantially parallel to an axis extending in an up and down direction of the image.

Consequently, the surface of the viewer's face and the front surface of the image are substantially parallel to each other, and a line joining the eyes of the viewer and a horizontal direction of the image are substantially parallel to each other, enabling the viewer to view the image with higher visibility.

It is preferable to arrange the display control system of the present invention such that the inclination changing means obtains a rate of change in inclination of the view-switching glasses in accordance with the inclination signal, and changes inclination of the image greater as the rate of change is larger.

With the arrangement, as the rate of change in inclination of the view-switching glasses is larger, inclination of the image is changed greater. Accordingly, as the viewer's face is inclined faster, the image is inclined greater. This enables the viewer to view the image with higher realistic sensation.

It is preferable to arrange the display control system of the present invention such that the inclination changing means changes inclination of the image through an image process.

With the arrangement, inclination of the image is changed through an image process. Accordingly, inclination of the image is made with a low cost.

It is preferable to arrange the display control system of the present invention such that the inclination changing means includes support mechanism for supporting the display section in such a manner that inclination of the display section is changeable, driving means for driving the support mechanism, and first control means for causing the driving means to drive the support mechanism to change inclination of the display section so that inclination of the image is changed.

With the arrangement, inclination of the image is changed by changing the posture of the display section displaying the image. That is, inclination of the image is changed in the real world. This enables the viewer to view the image whose inclination is changed with higher visibility.

It is preferable to arrange the display control system of the present invention such that the display device or each of the plural pairs of view-switching glasses further includes selection means for selecting, out of the plural pairs of view-switching glasses, a pair of view-switching glasses for which inclination of an image is to be changed, and the inclination changing means changes inclination of the image in accordance with the inclination signal which is received by the first reception means and which is outputted from the pair of view-switching glasses selected by the selection means.

With the arrangement, the display device or each of the plural pairs of view-switching glasses further includes selection means for selecting, out of the plural pairs of view-switching glasses, a pair of view-switching glasses for which inclination of an image is to be changed, and the inclination changing means changes inclination of the image in accordance with the inclination signal which is received by the first reception means and which is outputted from the pair of view-switching glasses selected by the selection means.

Consequently, when there are a plurality of viewers, it is possible to select a viewer for whom inclination of an image is to be changed. Accordingly, when the face of the viewer selected out of a plurality of viewers wearing the view-switching glasses inclined, it is possible to change inclination of the image viewed by the viewer in accordance with inclination of the face of the selected viewer.

It is preferable to arrange the display control system of the present invention such that each of the plural pairs of view-switching glasses further includes opening and closing means for opening and closing views of said each pair of view-switching glasses, second reception means for receiving a switch signal from the display device, and second control means for controlling an opening and closing operation of the opening and closing means in accordance with the switch signal, the display device or said each of the plural pairs of view-switching glasses further includes selection means for selecting, out of the plural pairs of view-switching glasses, one or more pairs of view-switching glasses for which inclination of an image displayed by the display section is to be changed, the display device further includes selection number detection means for detecting a selection number which is the number of said one or more pairs of view-switching glasses selected by the selection means, time-dividing means for time-dividing each frame of the image into a plurality of sub-frames in accordance with the selection number detected by the selection number detection means, and homologizing means for homologizing the plural pairs of view-switching glasses with the plurality of sub-frames in such a manner that said one or more pairs of view-switching glasses selected by the selection means are homologized with different one or different ones of the plurality of sub-frames, and the inclination changing means changes, in accordance with inclination of said one or more pairs of view-switching glasses selected by the selection means, inclination of an image in the different one or images in the different ones of the plurality of sub-frames homologized with said one or more pairs of view-switching glasses.

With the arrangement, when there are a plurality of viewers, it is possible to select, by means of the selection means, a viewer for whom inclination of an image is to be changed.

It is preferable to arrange the display control system of the present invention such that in a case where a result of detection by the selection number detection means is equal to the total number of the plural pairs of view-switching glasses, the time-dividing means time-divides each frame of the image into sub-frames in the number equal to the total number of the plural pairs of view-switching glasses, and the homologizing means homologizes the plural pairs of view-switching glasses with the equal number of sub-frames, respectively, when inclination of the plural pairs of view-switching glasses has been changed, in a case where the result of detection by the selection number detection means is a first number which is more than one and less than the total number of the plural pairs of view-switching glasses, the time-dividing means time-divides each frame of the image into sub-frames in a second number which is larger by one than the first number, and the homologizing means homologizes, with a common sub-frame of the second number of sub-frames, one or more of the plural pairs of view-switching glasses which are not selected as view-switching glasses for which inclination of an image is to be changed, and the homologizing means homologizes, respectively with remaining ones of the second number of sub-frames, ones of the plural pairs of view-switching glasses which are selected as view-switching glasses for which inclination of an image is to be changed, and in a case where the result of detection by the selection number detection means is zero, the time-dividing means does not time-divide each frame of the image.

With the arrangement, in a case where the result of detection by the selection number detection means is equal to the total number of the plural pairs of view-switching glasses, the time-dividing means time-divides each frame of the image into sub-frames in the number equal to the total number of the plural pairs of view-switching glasses, and the homologizing means homologizes the plural pairs of view-switching glasses with the equal number of sub-frames, respectively, when inclination of the plural pairs of view-switching glasses has been changed. Consequently, in the case where the result of detection by the selection number detection means is equal to the total number of the plural pairs of view-switching glasses, it is possible to homologize, with different sub-frames, view-switching glasses which have been selected as view-switching glasses for which inclination of the image is to be changed.

In a case where the result of detection by the selection number detection means is a first number which is more than one and less than the total number of the plural pairs of view-switching glasses, the time-dividing means time-divides each frame of the image into sub-frames in a second number which is larger by one than the first number, and the homologizing means homologizes, with a common sub-frame of the second number of sub-frames, one or more of the plural pairs of view-switching glasses which are not selected as view-switching glasses for which inclination of an image is to be changed, and the homologizing means homologizes, respectively with remaining ones of the second number of sub-frames, ones of the plural pairs of view-switching glasses which are selected as view-switching glasses for which inclination of an image is to be changed

Consequently, in the case where the result of detection by the selection number detection means is the first number, it is possible to homologize, with different sub-frames, the view-switching glasses selected as view-switching glasses for which inclination of an image is to be changed. In particular, since view-switching glasses which are not selected as view-switching glasses for which inclination of an image is to be changed are homologized with a common sub-frame, it is possible to reduce as small as possible the number of sub-frames into which each frame is to be time-divided.

In the case where the result of detection by the selection number detection means is zero, the time-dividing means does not time-divide each frame of the image. That is, only in the case where the result of detection by the selection number detection means is not zero (i.e. in the case where there is at least one pair of view-switching glasses for which inclination of an image is to be changed), each frame of the image is time-divided. That is, each frame is time-divided only when time-division is required. In general, as the number of time-division is larger, a viewer is more likely to sense flickers (blinking of images), and accordingly it is desirable that the number of time-division is as small as possible. With the present arrangement, since each frame is time-divided only when time-division is required, it is possible to prevent visibility of an image from being lowered.

It is preferable to arrange the display control system of the present invention such that each of the plural pairs of view-switching glasses further includes opening and closing means for opening and closing views of said each pair of view-switching glasses, second reception means for receiving a switch signal from the display device, and second control means for controlling an opening and closing operation of the opening and closing means in accordance with the switch signal, the display device further includes change number detection means for detecting, in accordance with the inclination signal received by the first reception means, the number of one or more pairs of view-switching glasses whose inclination has been changed, time-dividing means for time-dividing, when the number detected by the change number detection means is one or more, each frame of the image into a plurality of sub-frames, and homologizing means for homologizing the plural pairs of view-switching glasses with the plurality of sub-frames in such a manner that said one or more pairs of view-switching glasses whose inclination has been changed are homologized with different one or different ones of the plurality of sub-frames, the inclination changing means changes, in accordance with inclination of said one or more pairs of view-switching glasses whose inclination has been changed, inclination of an image in the different one or images in the different ones of the plurality of sub-frames homologized with said one or more pairs of view-switching glasses, and the display device further includes switch signal generating means for generating the switch signal for the view-switching glasses in such a manner that only the view-switching glasses homologized with an image in a sub-frame displayed by the display section opens views, and second output means for outputting the switch signal to the second reception means of the view-switching glasses.

With the arrangement, each of the plural pairs of view-switching glasses further includes opening and closing means for opening and closing views of said each pair of view-switching glasses, second reception means for receiving a switch signal from the display device, and second control means for controlling an opening and closing operation of the opening and closing means in accordance with the switch signal. Accordingly, each of the plural pairs of view-switching glasses can switch between opening and closing of said each of the plural pairs of view-switching glasses, in accordance with the inclination signal from the display device.

On the other hand, the display device further includes change number detection means for detecting, in accordance with the inclination signal received by the first reception means, the number of one or more pairs of view-switching glasses whose inclination has been changed, and time-dividing means for time-dividing, when the number detected by the change number detection means is one or more, each frame of the image into a plurality of sub-frames. Therefore, when inclination of at least one pair of view-switching glasses is changed, the display device time-divides each frame of the image into a plurality of sub-frames.

Subsequently, the homologizing means homologizes the plural pairs of view-switching glasses with the plurality of sub-frames in such a manner that said one or more pairs of view-switching glasses whose inclination has been changed are homologized with different one or different ones of the plurality of sub-frames, and in consideration of the homologizing, the inclination changing means changes, in accordance with inclination of said one or more pairs of view-switching glasses whose inclination has been changed, inclination of an image in the different one or images in the different ones of the plurality of sub-frames homologized with said one or more pairs of view-switching glasses. Thus, the plurality of sub-frames into which each frame is time-divided includes a sub-frame in which inclination of an image is changed in accordance with inclination of the view-switching glasses homologized with the sub-frame.

With the arrangement, for example, when one of a plurality of viewers wearing the view-switching glasses inclines his/her face, inclination of only an image viewed by the viewer can be changed in accordance with inclination of the viewer's face.

It is preferable to arrange the display control system of the present invention such that in a case where a result of detection by the change number detection means is equal to the total number of the plural pairs of view-switching glasses, the time-dividing means time-divides each frame of the image into sub-frames in the number equal to the total number of the plural pairs of view-switching glasses, and the homologizing means homologizes the plural pairs of view-switching glasses whose inclination has been changed with the equal number of sub-frames, respectively, in a case where the result of detection by the selection number detection means is a first number which is more than one and less than the total number of the plural pairs of view-switching glasses, the time-dividing means time-divides each frame of the image into sub-frames in a second number which is larger by one than the first number, and the homologizing means homologizes, with a common sub-frame of the second number of sub-frames, one or more of the plural pairs of view-switching glasses whose inclination has not been changed, and the homologizing means homologizes, respectively with remaining ones of the second number of sub-frames, ones of the plural pairs of view-switching glasses whose inclination has been changed, and in a case where the result of detection by the selection number detection means is zero, the time-dividing means does not time-divide each frame of the image, and in the case where the result of detection by the selection number detection means is zero, the switch signal generating means generates the switch signal in such a manner that all of the plural pairs of view-switching glasses open views.

With the arrangement, in a case where the result of detection by the change number detection means is equal to the total number of the plural pairs of view-switching glasses, the time-dividing means time-divides each frame of the image into sub-frames in the number equal to the total number of the plural pairs of view-switching glasses, and the homologizing means homologizes the plural pairs of view-switching glasses whose inclination has been changed with the equal number of sub-frames, respectively. Consequently, in the case where the result of detection by the change number detection means is equal to the total number of the plural pairs of view-switching glasses, it is possible to homologize the plural pairs of view-switching glasses whose inclination has been changed with different sub-frames.

In the case where the result of detection by the selection number detection means is a first number which is more than one and less than the total number of the plural pairs of view-switching glasses, the time-dividing means time-divides each frame of the image into sub-frames in a second number which is larger by one than the first number, and the homologizing means homologizes, with a common sub-frame of the second number of sub-frames, one or more of the plural pairs of view-switching glasses whose inclination has not been changed, and the homologizing means homologizes, respectively with remaining ones of the second number of sub-frames, ones of the plural pairs of view-switching glasses whose inclination has been changed.

Consequently, in the case where the result of detection by the change number detection means is the first number, it is possible to homologize the plural pairs of view-switching glasses with the plurality of sub-frames in such a manner that said one or more pairs of view-switching glasses whose inclination has been changed are homologized with different one or different ones of the plurality of sub-frames. In particular, since one or more of the plural pairs of view-switching glasses whose inclination has not been changed are homologized with the common sub-frame, it is possible to reduce as small as possible the number of sub-frames into which each frame is time-divided.

In the case where the result of detection by the change number detection means is zero, the time-dividing means does not time-divide each frame of the image. That is, only in the case where the result of detection by the change number detection means is not zero (i.e. in the case where there is at least one pair of view-switching glasses whose inclination has been changed), each frame of the image is time-divided. That is, each frame is time-divided only when time-division is required. In general, as the number of time-division is larger, a viewer is more likely to sense flickers (blinking of images), and accordingly it is desirable that the number of time-division is as small as possible. With the present arrangement, since each frame is time-divided only when time-division is required, it is possible to prevent visibility of an image from being lowered.

It is preferable to arrange the display control system of the present invention such that the display device further includes switch signal generating means for generating switch signals for the plural pairs of view-switching glasses, respectively, in such a manner that only one of the plural pairs of view-switching glasses which is homologized with a sub-frame displayed by the display section opens views, and second output means for outputting the switch signals to the second reception means of the plural pairs of view-switching glasses, and when each frame of the image is not time-divided, the switch signal generating means generates the switch signals in such a manner that all of the plural pairs of view-switching glasses open views.

With the arrangement, a viewer can change inclination of an image viewed by the viewer in accordance with a change in inclination of the viewer's face.

It is preferable to arrange the display control system of the present invention such that the display device includes switch signal generating means for generating a switch signal which is common among the plural pairs of view-switching glasses and which indicates timing for causing the display section to display the plural pairs of view-switching glasses, and second output means for outputting the switch signal to the second reception means of the plural pairs of view-switching glasses, each of the plural pairs of view-switching glasses further includes switch selection means for selecting which sub-frame of the plurality of sub-frames said each of the plural pairs of view-switching glasses switch to, the second control means controls, in accordance with the switch signal, the opening and closing means in such a manner that said each of the plural pairs of view-switching glasses opens views only when an image in the sub-frame selected by the switch selection means is displayed, and when each frame of the image is not time-divided, the switch signal generating means generates the switch signal in such a manner that all of the plural pairs of view-switching glasses open views.

With the arrangement, the display device is required to only one switch signal, so that the configuration of the display device can be simplified. Further, a sub-frame viewable by each pair of view-switching glasses can be selected via selection means of each pair of view-switching glasses. Accordingly, each viewer can select and view an image whose inclination corresponds to inclination of the viewer's face or can select and view an image whose inclination corresponds to inclination of other viewer's face.

It is preferable to arrange the view-switching glasses of the present invention so as to further include opening and closing means for opening views of the view-switching glasses, reception means for receiving a switch signal from an outside, and control means for controlling an opening and closing operation of the opening and closing means in accordance with the switch signal received by the reception means.

With the arrangement, the view-switching glasses of the present invention further include opening and closing means for opening views of the view-switching glasses, reception means for receiving a switch signal from an outside, and control means for controlling an opening and closing operation of the opening and closing means in accordance with the switch signal received by the reception means. Accordingly, the view-switching glasses of the present invention can be used in the above display control system.

The technical scope of the present invention encompasses a control program for operating the above display control system is stored, the control program causing a computer to function as the means of the display control system. The technical scope of the present invention also encompasses a computer-readable storage medium in which the control program is stored. Further, the technical scope of the present invention encompasses a control program for operating the view-switching glasses is stored, the control program causing a computer to function as the means of the view-switching glasses. The technical scope of the present invention also encompasses a computer-readable storage medium in which the control program is stored.

The above control program enables a computer to realize the means of the display control system or the view-switching glasses, so that the computer serves as the display control system or the view-switching glasses. Further, the above storage medium enables the control program to be realized on a general-purpose computer.

### INDUSTRIAL APPLICABILITY

The display control device of the present invention and the display control system of the present invention can subdue health damage caused when a viewer views stereoscopic images, and are preferably applicable to a liquid crystal display device or a self-luminous display device such as plasma display, each capable of displaying stereoscopic images.

### REFERENCE SIGNS LIST

2. Display (Display device)
3, 50. Display control device
10, 10a. Liquid crystal shutter glasses (view-switching glasses)
14. Notification section
15. Inclination sensor (inclination detection means)
54. Image changing control section (changing means)
121. Inclination determination section (determination means)
121a. Inclination amount judging section (judging means)
61, 61H, 61J. Display control system
71. Inclination signal reception section (first reception means)
72, 72B, 72C. Inclination changing section (inclination changing means)
73. Display section
75a, 75aE, 75aF. Support mechanism
75b. Driving section (driving means)
75c, 75cE, 75cF, 75cG. Control section (first control means)
76. Homologizing section (homologizing means)
77. Image output control section
78. Change number detection section (change number detection means)
79. Time-dividing section (time-dividing means)
80. Liquid crystal shutter glasses (view-switching glasses)
82. Inclination detection section (inclination detection means)
83. Switch signal output section (second output means)
84. Inclination signal output section (first output means, output means)
85. Operation section (switch selection means)
86. Switch signal output control section (switch signal generating means)
87. Liquid crystal shutters (opening and closing means)
88. Switch signal reception section (second reception means)
89. Shutter control section (second control means, control means)
90. Selection section (selection means)
91. Selection number detection section (selection number detection means)

1. View-switching glasses for switching how a viewer views through a left eye and a right eye, comprising inclination detection means for detecting an amount of inclination of the view-switching glasses when a face of a viewer wearing the view-switching glasses is inclined.

2. The view-switching glasses as set forth in claim 1, further comprising determination means for determining, based on a result of detection by the inclination detection means, whether to stop an initial image viewing mode in which the left-eye of the viewer perceives only a left-eye image and the right-eye of the viewer perceives only a right-eye image.

3. The view-switching glasses as set forth in claim 2, further comprising switch means for switching, when the determination means determines that the initial image viewing mode is to be stopped, how the viewer views through the left eye and the right eye, so that a predetermined second image viewing mode different from the initial image viewing mode is carried out.

4. The view-switching glasses as set forth in claim 3, wherein the second image viewing mode is a mode in which one of the left-eye image and the right-eye image is perceived by both of the left eye and the right eye of the viewer.

5. The view-switching glasses as set forth in claim 3, wherein the second image viewing mode is a mode in which both of the left-eye image and the right-eye image are perceived by both of the left eye and the right eye of the viewer.

6. The view-switching glasses as set forth in claim 3, wherein the second image viewing mode is a mode in which neither of the left-eye image and the right-eye image is perceived by both of the left eye and the right eye of the viewer.

7. The view-switching glasses as set forth in claim 2, wherein the determination means determines whether to stop the initial image viewing mode in accordance with whether the amount of inclination detected by the inclination detection means is larger than a predetermined threshold.

8. The view-switching glasses as set forth in claim 2, wherein
the inclination detection means is an acceleration sensor, and
the determination means includes judging means for judging, in accordance with a temporal change in acceleration detected by the acceleration sensor, whether the acceleration detected by the acceleration sensor is to be used as the amount of inclination.

9. The view-switching glasses as set forth in claim 2, wherein the inclination detection means is a gyro sensor.

10. The view-switching glasses as set forth in claim 2, further comprising a notification section for notifying, when the determination means determines that the initial image viewing mode is to be stopped, the viewer of a result of the determination by the determination means.

11. The view-switching glasses as set forth in claim 2, further comprising an output section for outputting, when the determination means determines that the initial image viewing mode is to be stopped, a determination signal indicative of a result of the determination by the determination means,
the output section outputting the determination signal to a display device which displays a parallax image using a parallax between a left eye and a right eye of a viewer so that a viewer wearing the view-switching glasses views a stereoscopic image.

12. A display control device for causing a display device to display a parallax image using a parallax between a left eye and a right eye of a viewer so that a viewer wearing view-switching glasses as set forth in claim 11 views a stereoscopic image, comprising
changing means for, upon reception of the determination signal, changing a display mode of the display device from a stereoscopic image display mode to a predetermined second image display mode, the stereoscopic image display mode being a display mode in which the left-eye image and the right-eye image are displayed alternately in accordance with timing for switching how the view-switching glasses enable the viewer to view.

13. The display control device as set forth in claim 12, wherein the second image display mode is a display mode in which one of the left-eye image and the right-eye image is displayed.

14. The display control device as set forth in claim 12, wherein the second image display mode is a notification image display mode in which the viewer is notified of a result of the determination by the determination means.

15. The display control device as set forth in claim 12, wherein the second image display mode is a display mode in which the display device displays no image.

16. The display control device as set forth in claim 12, wherein
the determination signal includes an inclination amount signal indicative of an amount of inclination detected by the inclination detection means, and
the second image display mode is obtained by modifying the stereoscopic image display mode in such a manner that positions of the left-eye image and the right-eye image displayed by the display device are changed in accordance with the amount of inclination indicated by the inclination amount signal.

17. The display control device as set forth in claim 16, wherein
the amount of inclination detected by the inclination detection means is an amount of how a direction aligning the left eye and the right eye of the viewer is inclined with respect to a horizontal direction, and
the second image display mode is a display mode in which the left-eye image and the right-eye image are moved in opposite directions along a vertical direction in such a manner that a line joining corresponding points on the left-eye image and the right-eye image is inclined with respect to the horizontal direction in an amount equal to the amount of inclination detected by the inclination detection means.

18. The display control device as set forth in claim 16, wherein
the amount of inclination detected by the inclination detection means is an amount of how a direction aligning the left eye and the right eye of the viewer is inclined with respect to a horizontal direction, and
the second image display mode is a display mode in which when seen from the viewer, the left-eye image and the right-eye image are rotated around a center of the display device while maintaining a relative positional relationship between the left-eye image and the right-eye image in such a manner that a line joining corresponding points on the left-eye image and the right-eye image is inclined with respect to the horizontal direction in an amount equal to the amount of inclination detected by the inclination detection means.

19. The display control device as set forth in claim 18, wherein the left-eye image and the right-eye image are rotated by rotating images displayed by the display device.

20. The display control device as set forth in claim 18, wherein
the display device is rotatable around a center thereof, and
the left-eye image and the right-eye image are rotated by rotating the display device when the display device displays the left-eye image and the right-eye image.

21. A computer-readable storage medium in which a control program for operating view-switching glasses as set forth in claim 2 is stored, the control program causing a computer to function as the means of the view-switching glasses.

22. A computer-readable storage medium in which a control program for operating a display control device as set forth in claim 12 is stored, the control program causing a computer to function as the means of the display control device.

23. A display control system, comprising:
a pair of or plural pairs of view-switching glasses for switching how a viewer views through a left eye and a right eye, including inclination detection means for detecting an amount of inclination of the view-switching glasses when a face of a viewer wearing the view-switching glasses is inclined; and
a display device for displaying an image,
the view-switching glasses further including first output means for outputting, as an inclination signal, a result of detection by the inclination detection means to the display device,
the display device including:
a display section for displaying the image;
first reception means for receiving the inclination signal; and
inclination changing means for changing inclination of the image in accordance with the inclination signal received by the first reception means.

24. The display control system as set forth in claim 23, wherein
the inclination detection means detects inclination of the view-switching glasses around an axis extending in a front and back direction of the view-switching glasses, and
the inclination changing means changes inclination of the image by rotating the image around an axis normal to an image surface of the image in accordance with the inclination signal.

25. The display control system as set forth in claim 23, wherein
the inclination detection means detects inclination of the view-switching glasses around an axis extending in a left and right direction of the view-switching glasses, and
the inclination changing means changes inclination of the image by rotating the image around an axis extending in a left and right direction of an image surface of the image in accordance with the inclination signal.

26. The display control system as set forth in claim 23, wherein
the inclination detection means detects inclination of the view-switching glasses around an axis extending in an up and down direction of the view-switching glasses, and
the inclination changing means changes inclination of the image by rotating the image around an axis extending in an up and down direction of an image surface of the image in accordance with the inclination signal.

27. The display control system as set forth in claim 23, wherein the inclination changing means rotates the image in a same direction as a direction in which the view-switching glasses are rotated.

28. The display control system as set forth in claim 27, wherein the inclination changing means rotates the image at an angle substantially equal to an angle at which the view-switching glasses are rotated.

29. The display control system as set forth in claim 27, wherein the inclination changing means rotates the image in such a manner that an axis extending in a front and back direction of the view-switching glasses is substantially parallel to an axis extending in a front and back direction of the image, an axis extending in a left and right direction of the view-switching glasses is substantially parallel to an axis extending in a horizontal direction of the image, and an axis extending in an up and down direction of the view-switching glasses is substantially parallel to an axis extending in an up and down direction of the image.

30. The display control system as set forth in claim 27, wherein the inclination changing means obtains a rate of change in inclination of the view-switching glasses in accordance with the inclination signal, and changes inclination of the image greater as the rate of change is larger.

31. The display control system as set forth in claim 23, wherein the inclination changing means changes inclination of the image through an image process.

32. The display control system as set forth in claim 23, wherein
the inclination changing means includes
a support mechanism for supporting the display section in such a manner that inclination of the display section is changeable,
driving means for driving the support mechanism, and
first control means for causing the driving means to drive the support mechanism to change inclination of the display section so that inclination of the image is changed.

33. The display control system as set forth in claim 23, wherein
the display device or each of the plural pairs of view-switching glasses further includes selection means for selecting, out of the plural pairs of view-switching glasses, a pair of view-switching glasses for which inclination of an image is to be changed, and
the inclination changing means changes inclination of the image in accordance with the inclination signal which is received by the first reception means and which is outputted from the pair of view-switching glasses selected by the selection means.

34. The display control system as set forth in claim 23, wherein
each of the plural pairs of view-switching glasses further includes
opening and closing means for opening and closing views of said each pair of view-switching glasses,
second reception means for receiving a switch signal from the display device, and
second control means for controlling an opening and closing operation of the opening and closing means in accordance with the switch signal,
the display device or said each of the plural pairs of view-switching glasses further includes selection means for selecting, out of the plural pairs of view-switching glasses, one or more pairs of view-switching glasses for which inclination of an image displayed by the display section is to be changed,
the display device further includes
selection number detection means for detecting a selection number which is the number of said one or more pairs of view-switching glasses selected by the selection means,
time-dividing means for time-dividing each frame of the image into a plurality of sub-frames in accordance with the selection number detected by the selection number detection means, and
homologizing means for homologizing the plural pairs of view-switching glasses with the plurality of sub-frames in such a manner that said one or more pairs of view-switching glasses selected by the selection means are homologized with different one or different ones of the plurality of sub-frames, and
the inclination changing means changes, in accordance with inclination of said one or more pairs of view-switching glasses selected by the selection means, inclination of an image in the different one or images in the different ones of the plurality of sub-frames homologized with said one or more pairs of view-switching glasses.

35. The display control system as set forth in claim 34, wherein
in a case where a result of detection by the selection number detection means is equal to the total number of the plural pairs of view-switching glasses,
the time-dividing means time-divides each frame of the image into sub-frames in the number equal to the total number of the plural pairs of view-switching glasses, and
the homologizing means homologizes the plural pairs of view-switching glasses with the equal number of sub-frames, respectively, when posture of the plural pairs of view-switching glasses has been changed,
in a case where the result of detection by the selection number detection means is a first number which is more than one and less than the total number of the plural pairs of view-switching glasses,
the time-dividing means time-divides each frame of the image into sub-frames in a second number which is larger by one than the first number, and
the homologizing means homologizes, with a common sub-frame of the second number of sub-frames, one or more of the plural pairs of view-switching glasses which are not selected as view-switching glasses for which inclination of an image is to be changed, and the homologizing means homologizes, respectively with remaining ones of the second number of sub-frames, ones of the plural pairs of view-switching glasses which are selected as view-switching glasses for which inclination of an image is to be changed, and
in a case where the result of detection by the selection number detection means is zero, the time-dividing means does not time-divide each frame of the image.

36. The display control system as set forth in claim 23, wherein
each of the plural pairs of view-switching glasses further includes
opening and closing means for opening and closing views of said each pair of view-switching glasses,
second reception means for receiving a switch signal from the display device, and
second control means for controlling an opening and closing operation of the opening and closing means in accordance with the switch signal,
the display device further includes
change number detection means for detecting, in accordance with the inclination signal received by the first reception means, the number of one or more pairs of view-switching glasses whose inclination has been changed,
time-dividing means for time-dividing, when the number detected by the change number detection means is one or more, each frame of the image into a plurality of sub-frames, and
homologizing means for homologizing the plural pairs of view-switching glasses with the plurality of sub-frames in such a manner that said one or more pairs of view-switching glasses whose inclination has been changed are homologized with different one or different ones of the plurality of sub-frames, and
the inclination changing means changes, in accordance with inclination of said one or more pairs of view-switching glasses whose inclination has been changed, inclination of an image in the different one or images in the different ones of the plurality of sub-frames homologized with said one or more pairs of view-switching glasses.

37. The display control system as set forth in claim 36, wherein
in a case where a result of detection by the change number detection means is equal to the total number of the plural pairs of view-switching glasses,
the time-dividing means time-divides each frame of the image into sub-frames in the number equal to the total number of the plural pairs of view-switching glasses, and
the homologizing means homologizes the plural pairs of view-switching glasses whose inclination has been changed with the equal number of sub-frames, respectively,
in a case where the result of detection by the selection number detection means is a first number which is more than one and less than the total number of the plural pairs of view-switching glasses,
the time-dividing means time-divides each frame of the image into sub-frames in a second number which is larger by one than the first number, and
the homologizing means homologizes, with a common sub-frame of the second number of sub-frames, one or more of the plural pairs of view-switching glasses whose inclination has not been changed, and the homologizing means homologizes, respectively with remaining ones of the second number of sub-frames, ones of the plural pairs of view-switching glasses whose inclination has been changed, and
in a case where the result of detection by the selection number detection means is zero, the time-dividing means does not time-divide each frame of the image.

38. The display control system as set forth in claim 34, wherein
the display device further includes
switch signal generating means for generating switch signals for the plural pairs of view-switching glasses, respectively, in such a manner that only one of the plural pairs of view-switching glasses which is homologized with a sub-frame displayed by the display section opens views, and
second output means for outputting the switch signals to the second reception means of the plural pairs of view-switching glasses, and
when each frame of the image is not time-divided, the switch signal generating means generates the switch signals in such a manner that all of the plural pairs of view-switching glasses open views.

39. The display control system as set forth in claim 34, wherein
the display device includes
switch signal generating means for generating a switch signal which is common among the plural pairs of view-switching glasses and which indicates timing for causing the display section to display the plural pairs of view-switching glasses, and
second output means for outputting the switch signal to the second reception means of the plural pairs of view-switching glasses,
each of the plural pairs of view-switching glasses further includes switch selection means for selecting which sub-frame of the plurality of sub-frames said each of the plural pairs of view-switching glasses switch to,
the second control means controls, in accordance with the switch signal, the opening and closing means in such a manner that said each of the plural pairs of view-switching glasses opens views only when an image in the sub-frame selected by the switch selection means is displayed, and
when each frame of the image is not time-divided, the switch signal generating means generates the switch signal in such a manner that all of the plural pairs of view-switching glasses open views.

40. A computer-readable storage medium in which a control program for operating a display control system as set forth in claim 23 is stored, the control program causing a computer to function as the means of the display control system.
